(19) United States
(12) Patent Application Publication
(10) Pub. No.: US 2024/0127584 A1
(43) Pub. Date: Apr. 18, 2024

(54) METHODS AND APPARATUS FOR COMPUTER VISION BASED ON MULTI-STREAM FEATURE-DOMAIN FUSION

(71) Applicant: Torc Robotics, Inc., Blacksburg, VA (US)

(72) Inventors: Emmanuel Luc Julien Onzon, Munich (DE); Felix Heide, Palo Alto, CA (US); Maximilian Rufus Bömer, Munich (DE); Fahim Mannan, Montreal (CA)

(21) Appl. No.: 18/526,787

(22) Filed: Dec. 1, 2023

Related U.S. Application Data
(63) Continuation-in-part of application No. 17/722,261, filed on Apr. 15, 2022.
(60) Provisional application No. 63/434,776, filed on Dec. 22, 2022.

(51) Int. Cl. G06V 10/776; G06T 5/40; G06T 5/50; G06T 7/11; G06V 10/77; G06V 10/80; G06V 10/94; G06V 20/00

(52) U.S. Cl. CPC G06V 10/776; G06T 5/40; G06T 5/50; G06T 7/11; G06V 10/7715; G06V 10/806; G06V 10/955; G06V 20/38; G06T 2207/10144; G06T 2207/20161

(57) ABSTRACT

A computer-vision pipeline is organized as a closed loop of a sensor-processing phase, an image-processing phase, and an object-detection phase, each comprising a respective phase processor coupled to a master processor. The sensor-processing phase creates multiple exposure images, and derives multi-exposure multi-scale zonal illumination-distributions, to be processed independently in the image-processing phase. In a first implementation of the object-detection phase, extracted exposure-specific features are pooled prior to overall object detection. In a second implementation, exposure-specific objects, detected from the exposure-specific features, are fused to produce the sought objects of a scene under consideration. The two implementations enable detecting fine details of a scene under diverse illumination conditions. The master processor performs loss-function computations to derive updated training parameters of the processing phases. Several experiments applying a core method of operating the computer-vision pipelines, and variations thereof, ascertain performance gain under challenging illumination conditions.

### CROSS-REFERENCE TO RELATED APPLICATIONS

This application is a Continuation In Part of U.S. patent application Ser. No. 17/722,261 filed on Apr. 15, 2022, titled Method and System for Determining Auto-Exposure for High-Dynamic Range Object Detection Using Neural Network, and claims priority to U.S. Provisional Patent Application No. 63/434,776, titled Methods and Apparatus for Computer Vision Based on Multi-Stream Feature-Domain Fusion, filed Dec. 22, 2022, the entire contents of which are hereby incorporated herein by reference.

### TECHNICAL FIELD

The field of the disclosure relates generally to computer vision and, more specifically, object detection within images of scenes of high dynamic range of illumination.

### BACKGROUND OF THE INVENTION

Outdoor scenarios with diverse illumination conditions are challenging for computer vision systems as large dynamical ranges of luminance may be encountered. A conventional approach to tackle the challenge is to use a pipeline of an HDR (high dynamic range) image sensor coupled with a hardware image signal processor (ISP) and an auto-exposure control mechanism, each being configured independently. HDR exposure fusion is done at the sensor level, before ISP processing and object detection. Prior-art methods primarily treat exposure control and perception as independent tasks which can lead to failure to maintain features that are crucial for robust detection in high contrast scenes.

There is a need, therefore, to explore methods for reliable object detection in unconstrained outdoor scenarios.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, the disclosed neural exposure fusion approach that combines the information of different standard dynamic range (SDR) captures in the feature domain instead of the image domain. The feature-based fusion is embedded in an end-to-end trainable vision pipeline that jointly learns exposure control, image processing, feature extraction and detection driven by a downstream loss function. A disclosed core method enables accurate detection in circumstances where conventional high dynamic range (HDR) fusion methods lead to underexposed or overexposed image regions. Variants of the core method are also disclosed.

In another aspect, the disclosed method of detecting objects from camera-produced images. The method comprises generating multiple raw exposure-specific images for a scene and performing for each raw exposure-specific image respective processes of image enhancement to produce a respective processed exposure-specific image. A set of exposure-specific features is extracted from each processed exposure-specific image. The resulting multiple exposure-specific sets of features are fused to form a set of fused features. A set of candidate objects are then identified from the set of fused features. The set of candidate objects is pruned to produce a set of objects considered to be present within the scene.

In yet another aspect, the disclosed method is provided where, rather than fusing the multiple exposure-specific sets of features, a set of exposure-specific candidate objects is extracted from each processed exposure-specific image. The resulting exposure-specific candidate objects are then fused to form a fused set of candidate objects which are pruned to produce a set of objects considered to be present within the scene.

Each raw exposure-specific image is generated according to a respective exposure setting. The method comprises a process of deriving for each raw exposure-specific image a respective multi-level regional illumination distribution (histogram) for use in computing the respective exposure setting. To derive the multi-level regional illumination distributions, image regions are selected to minimize the computational effort. Preferably, the image regions, categorized in a predefined number of levels, are selected so that each region of a level, other than a last level of the predefined number of levels, encompasses an integer number of regions of each subsequent level.

The processes of image enhancement for each exposure-specific image comprise: (1) raw image contrast stretching, using lower and upper percentiles for pixel-wise affine mapping, (2) image demosaicing; (3) image resizing; (4) a pixel-wise power transformation; and (5) pixel-wise affine transformation with learned parameters. These processes may be performed sequentially, using a single ISP processor, or concurrently using multiple processing units which may be pipelined or operating independently each processing a respective raw exposure-specific image.

The method further comprises determining objectness of each detected object of the fused set of candidate objects and pruning the fused set of candidate objects according to a non-maximum-suppression criterion or a “keep-best-loss” principle.

The method further comprises establishing a loss function and backpropagating loss components for updating parameters of parameterized devices implementing the aforementioned processes. Updated parameters are disseminated to relevant hardware processors. A network of hardware processors coupled to a plurality of memory devices storing processor-executable instructions is used for disseminating the updated parameters.

In another aspect, the disclosed apparatus for detecting objects from camera-produced images of a time-varying scene. The apparatus comprises a hardware master processor coupled to a pool of hardware intermediate processors, and parameterized devices including a sensing-processing device, an image-processing device, a feature-extraction device, and an object-detection device.

The sensing-processing device comprises a neural auto-exposure controller, coupled to a light-collection component, configured to generate a specified number of time-multiplexed exposure-specific raw SDR images and derive for each exposure-specific raw SDR image respective multi-level luminance histograms.

The image-processing device is configured to perform predefined image-enhancing procedures for each the raw SDR image to produce a respective exposure-specific processed image.

The features-extraction device is configured to extract from the exposure-specific images respective sets of exposure-specific features collectively constituting a superset of features.

The objects-detection device is configured to identify a set of candidate objects using the superset of features. A pruning module filters the set of candidate objects to produce a set of pruned objects within the time-varying scene.

The master-processor is communicatively coupled to each hardware intermediate processor through either a dedicated path or a switched path. Each hardware intermediate processor is coupled to at least one of the parameterized devices to facilitate dissemination of control data through the apparatus.

The apparatus comprises an illumination-characterization module configured to select image-illumination regions for each level of a predefined number of levels, so that each region of a level, other than a last level of the predefined number of levels, encompasses an integer number of regions of each subsequent level.

In one implementation, the image-processing device is configured as a single image-signal-processor (ISP) sequentially performing the predefined image enhancing procedures for the specified number of time-multiplexed exposure-specific raw SDR images.

In an alternate implementation, the image-processing device is configured as a plurality of pipelined image-processing units operating cooperatively and concurrently to execute the image-enhancing procedure.

In another alternate implementation, the image-processing device is configured as a plurality of image-signal-processors, operating independently and concurrently, each processing a respective raw SDR image.

In a first implementation, the objects-detection device comprises:
a features-fusing module configured to fuse the respective sets of exposure-specific features of the superset of features to form a set of fused features; and
a detection module configured to identify a set of candidate objects from the set of fused features.

In a second implementation, the objects-detection device comprises:
a plurality of detection modules, each configured to identify, using the respective sets of exposure-specific features, exposure-specific sets of candidate objects; and
an objects-fusing module configured to fuse the exposure-specific sets of candidate objects to form a fused set of candidate objects.

A control module is configured to cause the master processor to derive updated device parameters, based on the set of pruned objects, for dissemination to the pool of devices through the pool of hardware intermediate processors. The control module determines derivatives of a loss function, based on the pruned set of objects, to produce the updated device parameters. Downstream control data (backpropagated data) is determined according to a method based on a principle of “keeping best loss” or a method based on “non-maximal suppression”.

The apparatus further comprises a module for tracking processing durations within each of the sensing-processing device, the image-processing device, the features-extraction device, and the objects-detection device, in order to determine a lower bound of a capturing time interval.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is an overview of a system for identifying objects within an image of a scene acquired from a camera;

FIG. 2 illustrates examples of scenes of high illumination contrast;

FIG. 3 illustrates a generic object-detection system implemented in three phases, referenced as a sensor-processing phase, an image-processing phase, and an object-detection phase;

FIG. 4 illustrates a distributed-control system for a generic computer-vision system, in accordance with an embodiment of the present disclosure;

FIG. 5 sets notations of components of a conventional configuration, labeled configuration-A, and three configurations, according to the present disclosure, labeled configuration-B, configuration-C, and configuration-D, for use in an embodiment of the present disclosure;

FIG. 6 illustrates methods of object detection, including a conventional method and methods according to the present disclosure, for handling cases of a dynamic range exceeding the capability of current image sensors;

FIG. 7 illustrates implementation details of the sensor-processing phase of the conventional computer-vision configuration (configuration-A);

FIG. 8 illustrates implementation details of the sensor-processing phases of configuration-B, configuration-C, and configuration-D, in accordance with embodiments of the present disclosure;

FIG. 9 illustrates components of the image-processing phase and the objection-detection phase of the conventional computer-vision configuration;

FIG. 10 illustrates an entire assembly of the conventional configuration;

FIG. 11 illustrates an image-processing phase and an objection-detection phase of computer-vision configuration-B, in accordance with an embodiment of the present disclosure;

FIG. 12 illustrates an entire assembly of configuration-B, in accordance with an embodiment of the present disclosure;

FIG. 13 illustrates an image-processing phase and an objection-detection phase of computer-vision configuration-C, in accordance with an embodiment of the present disclosure;

FIG. 14 illustrates an entire assembly of configuration-C, in accordance with an embodiment of the present disclosure;

FIG. 15 illustrates an image-processing phase and an objection-detection phase of computer-vision configuration-D, in accordance with an embodiment of the present disclosure;

FIG. 16 illustrates an entire assembly of configuration-D, in accordance with an embodiment of the present disclosure;

FIG. 17 summarizes common processes and distinct processes of configuration-A, configuration-B, configuration-C, and configuration-D;

FIG. 18 further clarifies configuration-A and configuration-B;

FIG. 19 further clarifies configuration-C and configuration-D;

FIG. 20 compares the sensor-processing phase, the image-processing phase, and the object-detection phase of computer-vision configuration-A, configuration-B, configuration-C, and configuration-D;

FIG. 21 highlights distinctive aspects of the present disclosure;

FIG. 22 illustrates backpropagation within configuration-B;

FIG. 23 is a detailed view of the sensor-processing phase of configuration-B, illustrating control of derivation of multiple exposure-specific images, in accordance with an embodiment of the present disclosure;

FIG. 24 is a detailed view of the image-processing phase and the object-detection phase of configuration-B;

FIG. 25 is an overview of computer-vision configuration-C illustrating backpropagation from a control module for iteratively recomputing training parameters, in accordance with an embodiment of the present disclosure;

FIG. 26 is a detailed view of the sensor-processing phase of configuration-C, in accordance with an embodiment of the present disclosure;

FIG. 27 is a detailed view of the image-processing phase of configuration-C, in accordance with an embodiment of the present disclosure;

FIG. 28 is a detailed view of the object-detection phase of configuration-C indicating connectivity to a respective phase controller, in accordance with an embodiment of the present disclosure;

FIG. 29 is an overview of computer-vision configuration-D indicating connections to the control module performing loss-function derivations.

FIG. 30 is a detailed view of the object-detection phase of configuration-D indicating connectivity to a respective phase controller, in accordance with an embodiment of the present disclosure;

FIG. 31 illustrates connectivity of phase processors to modules of the sensor-processing phase, the image-processing phase, and the object-detection phase for each of configuration-B, configuration-C, and configuration-D, in accordance with an embodiment of the present disclosure;

FIG. 32 illustrates multi-exposure, multi-scale luminance histograms used in forming neural auto-exposure, in accordance with an embodiment of the present disclosure;

FIG. 33 illustrates examples of selection of image zones for which illumination data are accumulated, in accordance with an embodiment of the present disclosure;

FIG. 34 illustrates late-fusion schemes, in accordance with an embodiment of the present disclosure;

FIG. 35 illustrates feedback control data and backpropagation of data from a module which determines updated training parameters based on loss-function calculations, in accordance with an embodiment of the present disclosure;

FIG. 36 is a schematic of the core computer-vision apparatus of the present disclosure using the control mechanism of FIG. 31;

FIG. 37 is a flow chart of the present method of object detection in images of scenes of diverse illumination conditions, in accordance with an embodiment of the present disclosure;

FIG. 38 illustrates an arrangement of a control mechanism of the core computer-vision apparatus of the present disclosure;

FIG. 39 illustrates timing of upstream processes of a computer-vision apparatus employing multiple sensors for concurrent acquisition of multiple images of a scene captured under constraints of specified illumination ranges, in accordance with an embodiment of the present disclosure;

FIG. 40 illustrates timing of upstream processes of a first example of a computer-vision apparatus employing a single sensor for sequential acquisition of multiple images, of a time-varying scene, for different illumination ranges, in accordance with an embodiment of the present disclosure;

FIG. 41 illustrates timing of upstream processes of a second example of a computer-vision apparatus handling multiple images of a time-varying scene;

FIG. 42 illustrates timing of upstream processes of a third example of a computer-vision apparatus employing a single sensor for sequential acquisition of multiple images, of a time-varying scene, for different illumination ranges, in accordance with an embodiment of the present disclosure;

FIG. 43 illustrates a structure of a complete pipeline, i.e., a set of parallel exposure-specific pipelines corresponding to multiple illumination settings of an HDR scene, in accordance with an embodiment of the present disclosure;

FIG. 44 illustrates an example of timing of detected objects of the complete pipeline of FIG. 43;

FIG. 45 illustrates a system of parallel complete pipelines;

FIG. 46 illustrates detection results of the object detection based on the late-fusion scheme with strategy-II with detection results of other methods;

FIG. 47 illustrates a comparison of detection results of selected scenes based on a first late-fusion method with those of baseline methods;

FIG. 48 illustrates a comparison of detection results of additional scenes based on the first late-fusion method with those of the baseline methods;

FIG. 49 illustrates a comparison of detection results of further scenes based on the first late-fusion method with those of the baseline methods;

FIG. 50 illustrates a comparison of detection results of selected scenes. based on a second late-fusion method with those of the baseline methods; and

FIG. 51 illustrates a comparison of detection results of selected scenes. based on an early-fusion method with those of the baseline methods.

Corresponding reference characters indicate corresponding parts throughout the several views of the drawings. Although specific features of various examples may be shown in some drawings and not in others, this is for convenience only. Any feature of any drawing may be reference or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

Computer-vision processing phases: The computer-vision task may be viewed as a sequence of distinct processing phases. Herein, a computer-vision pipeline is logically segmented into a sensor-processing phase, an image-processing phase, and an object-detection phase.

Object-detection stages: The object-detection phase is implemented in two stages with a first stage extracting features from processed images and a second stage identifying objects based on extracted features.

Loss function: The loss functions used herein are variants of known loss functions (specifically in references [12] and [39] covering “Fast RCNN” and “Faster RCNN”. The variants aim at enhancing predictions. The variables to be adjusted to minimize the loss are:
The weights and biases of the neural networks that form the computer-vision pipeline (auto-exposure, feature extractor, object detectors); and
The trainable parameters of the ISP (denoiser strength, filters' parameters, etc.).
Learning is ascertained upon finding values of the variables that minimize the loss on a selected number of training examples.

Processor: The term refers to a hardware processing unit, or an assembly of hardware processing unit.

Master processor: A master processor supervises an entire computer-vision pipeline and is communicatively coupled to phase processors. The master processor performs the critical operation of computing specified loss functions and determining updated parameters.

Phase processor: A phase processor is a hardware processor (which may encompass multiple processing units) for performing computations relevant to a respective processing phase.

Module: A module is a set of software instructions, held in a memory device, causing a respective processor to perform a respective function.

Device: The term refers to any hardware entity.

Field of view: The term refers to a “view” or “scene” that a specific camera can capture

Dynamic range: The term refers to luminance contrast, typically expressed as a ratio (or a logarithm of the ratio) of the intensity of the brightest point to the intensity of the darkest point in a scene.

High dynamic range (HDR): A dynamic range exceeding the capability of current image sensors.

Low dynamic range (LDR): A portion of a dynamic range within the capability of an image sensor. A number of staggered LDR images of an HDR scene may be captured and combined (fused) to form a respective HDR image of the HDR scene.

Standard dynamic range (SDR): A selected value of an illumination dynamic range, within the capability of available sensors, may be used consistently to form images of varying HDR values.

The terms SDR and LDR are often used interchangeably; the former is more commonly used.

The term “companding” refers to compression of the bit depth of the HDR linear image applying a piecewise affine function after which the resulting image is no longer a linear image. An inverse operation that produces a linear image is referenced as “decompanding”. (See details on pages 22-24 of AR0231 “Image Sensor Developer Guide”.)

Exposure bracketing: Rather than capturing a single image of a scene, several images are captured, with different exposure settings, and used to generate a high-quality image that incorporates useful content from each image.

Exposure-specific images: The term refers to time-multiplexed raw images corresponding to different exposures.

Dynamic-range compression: Several techniques for compressing the illumination dynamic range while retaining important visual information are known in the art.

Computer-vision companding: The term refers to converting an HDR image to an LDR image to be expanded back to high dynamic range.

Image signal processing (ISP): The term refers to conventional processes (described in EXHIBIT-III) to transform a raw image acquired from a camera to a processed image to enable object detection. An “ISP processor” is a hardware processor performing such processes, and an “ISP module” is a set of processor-executable instructions causing a hardware processor to perform such processes.

Differentiable ISP: The term “differentiable ISP” refers to a continuous function of each of its independent variables where the gradient with respect to the independent variables can be determined. The gradient is applied to a stochastic gradient descend optimization process.

Exposure-specific ISP: The term refers to processing individual raw images of multiple exposures independently to produce multiple processed images.

Object: The shapes of objects are not explicitly predefined. Instead, they are implicitly defined from the data. The possible shapes are learned. The ability of the detector to detect objects with shapes unseen in the training data depends on the amount and variety of training data and also critically on the generalization ability of the neural network (this depends on its architecture, among other things). In the context of 2D-object detection, and for the neural network that performs the detection, objects are defined by two things: 1. the class it belongs to (e.g., a car), 2. its bounding box, i.e., the smallest rectangle that contains the object in the image (e.g., x-coordinate of the left and right sides and y-coordinate of the top and bottom sides of the rectangle). These are the outputs of the detector. The loss is computed by comparing them with the ground truth (i.e., the values specified by the human annotators for the given training examples). With this process, the neural network implicitly learns to recognize objects based on the information in the data (including its shape, color, texture, surroundings, etc.).

Exposure-specific detected-objects: The term refers to objects from a same scene that are identified in each processed exposure-specific image.

Feature: In the field of machine learning, the term “feature” refers to significant information extracted from data. Multiple features may be combined to be further processed. Thus, extracting a feature from data is a form of data reduction.

Thus, a feature is an information extracted from the image data that is useful to the object detector and facilitates its operation. A feature has a higher information content than the simple pixel values of the image about the presence or absence of objects at their location in the image. For example, a feature could encode the likelihood of the presence of a part of an object. A map of features (i.e., several features at several locations in the image) is computed thanks to a feature extractor that has been trained on a different vision task on a large number of examples. This feature extractor is further trained (i.e., fine-tuned) on the task at hand.

In the field of deep neural network, the use of the term “feature” derives from its use in machine learning in the context of shallow models. When using shallow machine learning models (such as linear regression or logistic regression), “feature engineering” is used routinely in order to get the best results. This comprises computing features from the data with especially hand-crafted algorithms before applying the learning model to these features instead of applying the learning model directly to the data (i.e., feature engineering is a pre-processing step that happens before training the model takes place). For computer vision such features could be edges or textures, detected by hand-crafted filters. The advent of deep neural networks in computer vision has enabled learning such features automatically and implicitly from the data instead of doing feature engineering. As such, in the context of deep neural networks, a feature is essentially an intermediate result inside the neural network, that bears meaningful information that can be further process to better solve the problem at hand or even to solve other problems. Typically, in the field of computer vision, a neural network that has been trained for image classification with millions of images and for many classes is reused as a feature extractor within a detector. The feature extractor is then fine-tuned by further learning from the training examples of the object detection data set. For instance, a variant of the neural network ResNet (ref. [16]) as a feature extractor is used herein. Experimentation is performed with several layers within ResNet (Conv1, Conv2, etc.) to be used as a feature map. For object detection, a feature map could encode the presence of elements that make up the kind of objects to be detected. For example, in the context of automotive object detection, where it is desired to detect cars and pedestrians, the feature map could encode the presence of elements such as human body parts and parts of cars such as wheels, headlights, glass texture, metal texture, etc. These are examples of features that the feature extractor might learn after fine tuning. The features facilitate the operation of the detector compared with using directly the pixel values of the image.

Exposure-specific features: The term refers to features extracted from an exposure-specific image.

Fusing: Generally speaking, fusing is an operation that takes as input several entities containing different relevant information for the problem at hand and outputs a single entity that has a higher information content. It can be further detailed depending on the type of entity as described below:
1. Fusion of images: For images, fusion means producing a single image that contains all of the information (or as much information) contained in any of the input images. In HDR imaging, image fusion means producing an HDR image that covers the overall dynamic range encompassed by the set of SDR images used as input.
2. Fusion of feature maps: Each input feature map is a 4-dimensional tensor of the same shape (n, h, w, c), where n is the number of training (or evaluation) examples in a mini-batch, h is the height, w is the width and c is the number of “channels” (i.e., number of features at a given location and for a given example). The output of the feature fusion is a feature map that is again a 4-dimensional tensor of the same shape (n, h, w, c). The purpose of the feature fusion is to produce an output feature map containing a combination of the information contained in any of the input feature maps and has a higher information content, more amenable to further useful processing.
3. Fusion of sets of detected objects: Sets of detected objects are fused with the following method. First the union of the sets is done. Then a subset of the detected objects is removed from the set of detected objects using non maximal suppression (NMS). Pruning of the set of detected objects using NMS is a standard procedure which use is widespread in computer vision. See for example ref. [12] and [39].

Pooling: In the context of object detection, the word “pooling” is mostly used in phrases such as “average pooling”, “maximum pooling” and “region-of-interest (ROI) pooling”. They are used to describe parts of a neural network architecture. These are operations within neural networks. ROI pooling is an operation that is widely used in the field of object detection, it is described in ref. [12] Section 2.1.

Maximum pooling operation: In the context of “early fusion”, the phrase “maximum pooling” (or “element-wise maximum”) simply means: element-wise maximum across several tensors. In the wider context of neural network architecture, it also means: computing the maximum spatially in a small neighborhood.

Exposure Fusion: The dynamic range of a scene may be much greater than what current sensors cover, and therefore a single exposure may be insufficient for proper object detection. Exposure fusion of multiple exposures of relatively low dynamic range enables capturing a relatively high range of illuminations. The present disclosure discloses fusion strategies at different stages of feature extraction without the need to reconstruct a single HDR image.

Auto Exposure Control: Commercial auto-exposure control systems run in real-time on either the sensor or the ISP hardware. The methods of the present disclosure rely on multiple exposures, from which features are extracted to perform object detection.

Single-exposure versus multi-exposure camera: A single-exposure camera typically applies image dependent metering strategies to capture the largest dynamic range possible, while a multi-exposure camera relies on temporal multiplexing of different exposures to obtain a single HDR image.

Image classification: The term refers to a process of associating an image to one of a set of predefined categories.

Object classification: Object classification is similar to image classification. It comprises assigning a class (also called a “label”, e.g., “car”, “pedestrian”, “traffic sign”, etc.) to an object.

Object localization: The term refers to locating a target within an image. Specifically in the context of 2D object detection, the localization comprises the coordinates of the smallest enclosing box.

Object detection: Object detection identifies an object and its location in an image by placing a bounding box around it.

Segmentation: The term refers to pixel-wise classification enabling fine separation of objects.

Object segmentation: Object segmentation classifies all of the pixels in an image to localize targets.

Image segmentation: The term refers to a process of dividing an image into different regions, based on the characteristics of pixels, to identify objects or boundaries.

Bounding Box: A bounding box (often referenced as “box” for brevity) is a rectangular shape that contains an object of interest. The bounding box may be defined as selected border's coordinates that enclose the object.

Box classifier: The box classifier is a sub-network in the object detection neural network which assigns the final class to a box proposed by the region proposal network (RPN). The box classifier is applied after ROI pooling and share some of its layers with the box regressor. The concept of a box classifier is described in [12]. In the present disclosure, the architecture of the box classifier follows the principles of “networks on convolutional feature maps” described in [40].

Box regressor: The box regressor is a sub-network in the object detection neural network which refines the coordinates of a box proposed by the region proposal network (RPN). The box regressor is applied after ROI pooling and shares some of its layers with the box classifier. The concept of a box regressor is described in [12]. The architecture of the box regressor follows the principles of “networks on convolutional feature maps” described in [40].

Mean Average Precision (mAP): The term refers to a metric used to evaluate object detection models.

An illumination histogram: An illumination histogram (brightness histogram) indicates counts of pixels in an image for selected brightness values (typically in 256 bins).

Objectness: The term refers to a measure of the probability that an object exists in a proposed region of interest. High objectness indicates that an image window likely contains an object. Thus, proposed image windows that are not likely to contain any objects may be eliminated.

RCNN: “Acronym for “region-based convolutional neural network” which is a deep convolutional neural network.

Fast-RCNN: The term refers to a neural network that accepts an image as an input and returns class probabilities and bounding boxes of detected objects within the image. A major advantage of the “Fast-RCNN” over the “RCNN” is the speed of objects' detection. The “Fast-RCNN” is faster than the “R-CNN” because it shares computations across multiple region proposals.

Region-Proposal Network (RPN): An RPN is a network of unique architecture configured to propose multiple objects identifiable within a particular image.

Faster-RCNN: The term refers to a faster offshoot of the Fast-RCNN which employs an RPN module.

Two-stage object detection: In a two-stage object-detection process, a first stage generates region proposals using, for example, a region-proposal-network (RPN) while a second stage determines object classification for each region proposal.

Non-maximal suppression: The term refers to a method of selecting one entity out of many overlapping entities. The selection criteria may be a probability and an overlap measure, such as the ratio of intersection to union.

Learned auto-exposure control: The term refers to determination of auto-exposure settings based on feedback information extracted from detection results.

Reference auto-exposure control: The term refers to learned auto-exposure control using only one SDR image as disclosed in U.S. patent application Ser. No. 17/722,261.

HDR-I pipeline: A baseline HDR pipeline implementing a conventional heuristic exposure control approach.

HDR-II pipeline: A baseline HDR pipeline implementing learned auto-exposure control.

### REFERENCE NUMERALS

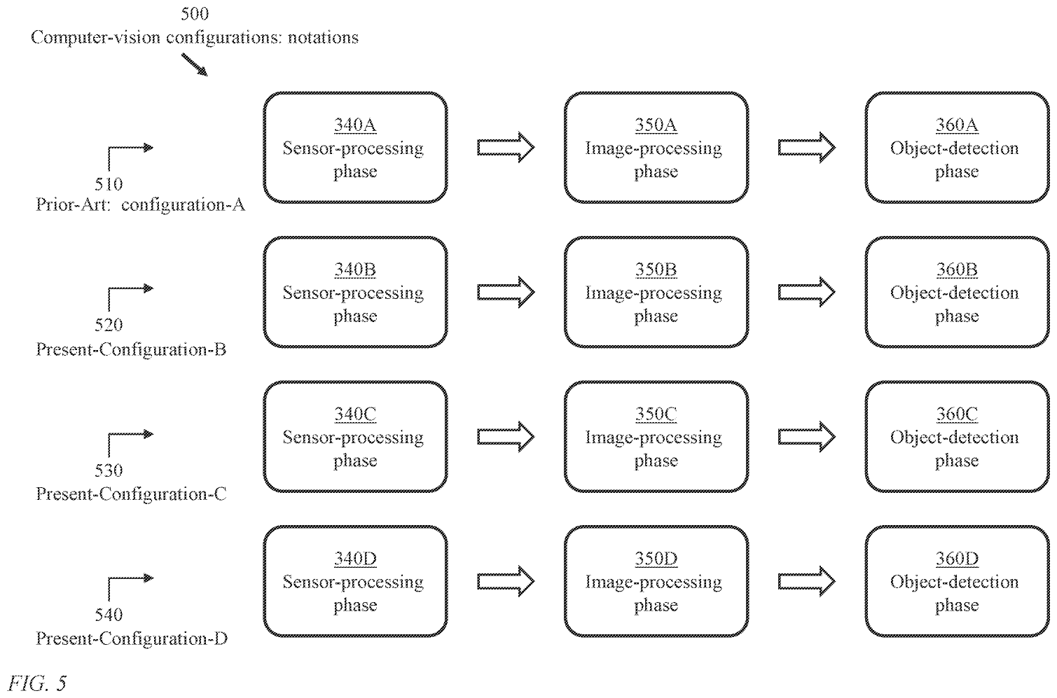

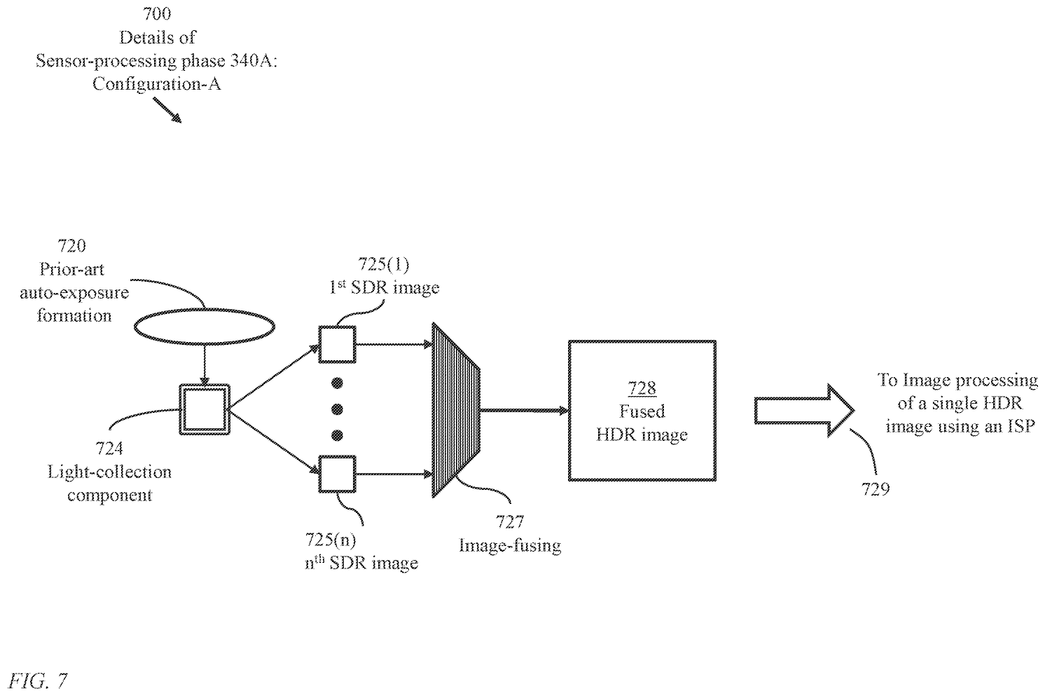

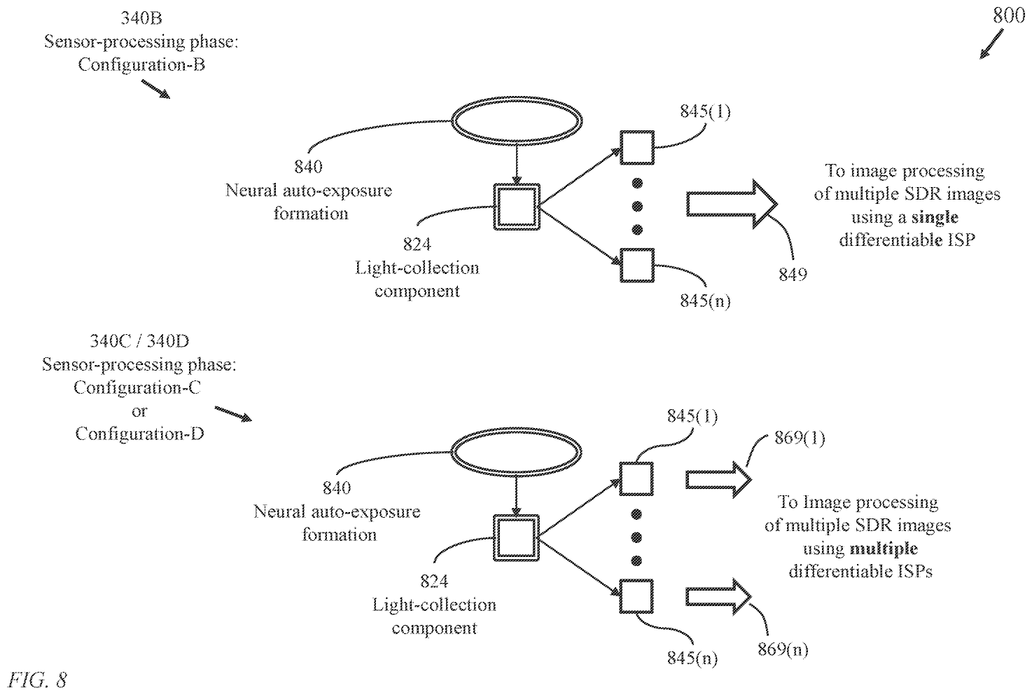

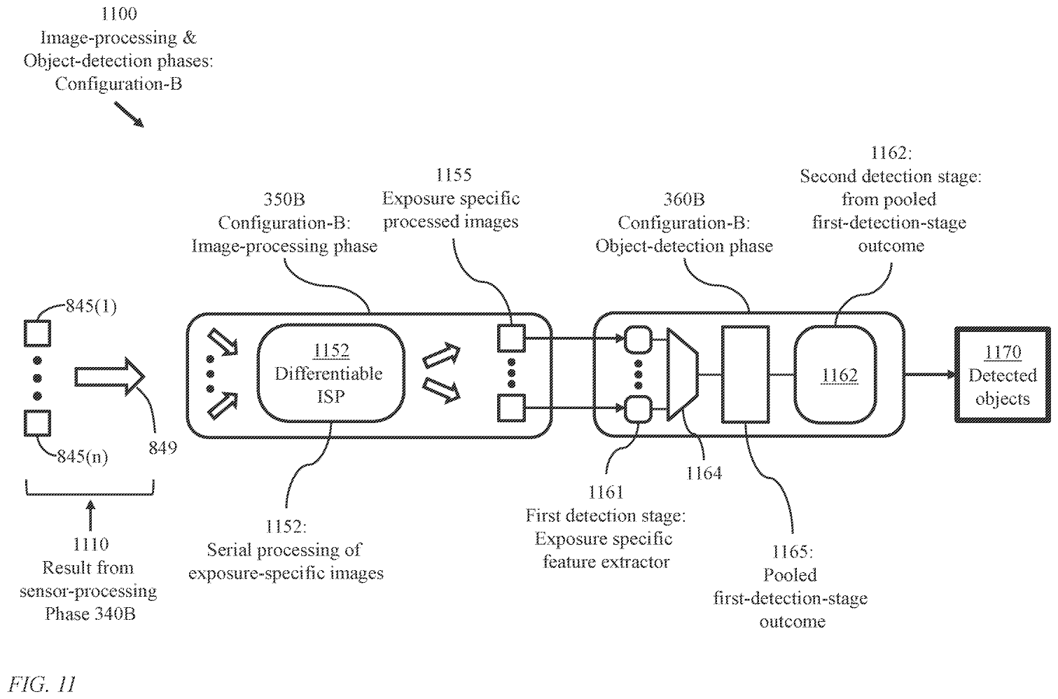

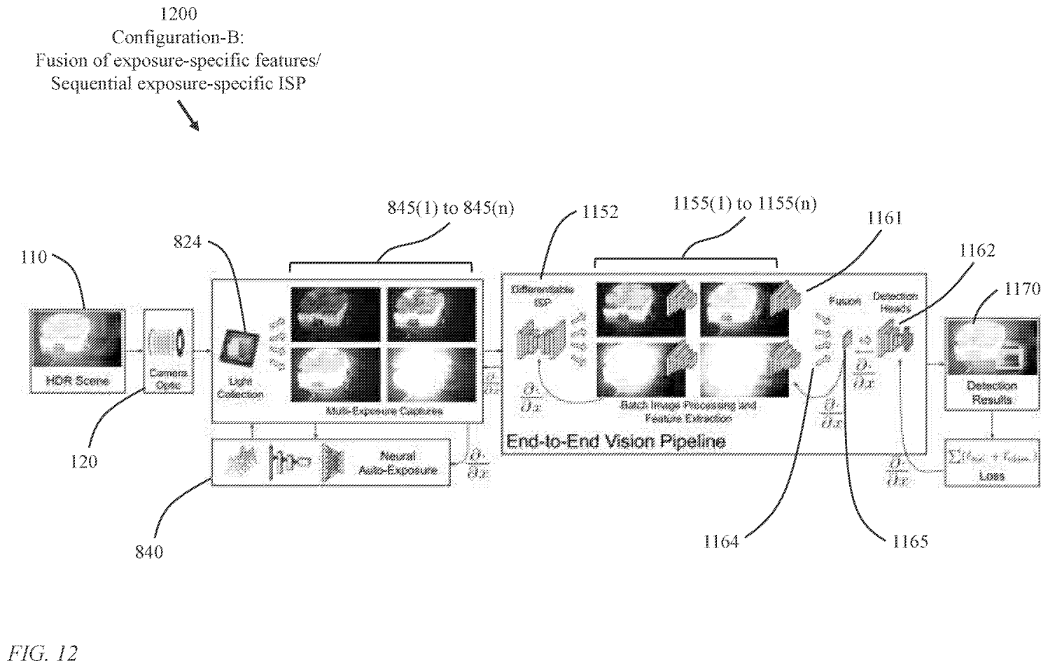

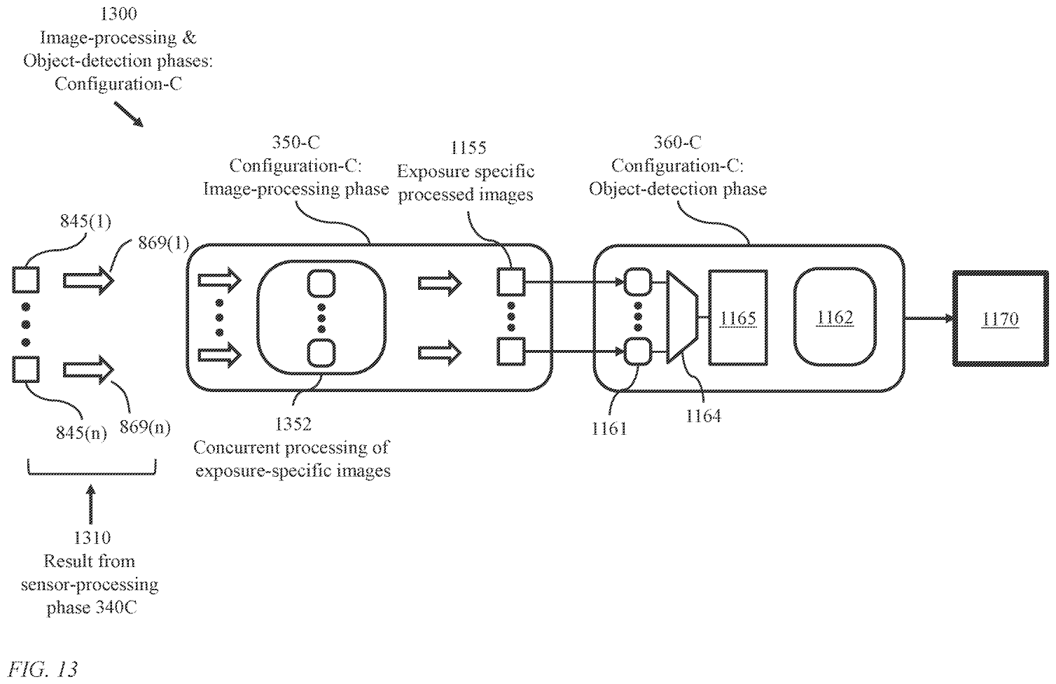

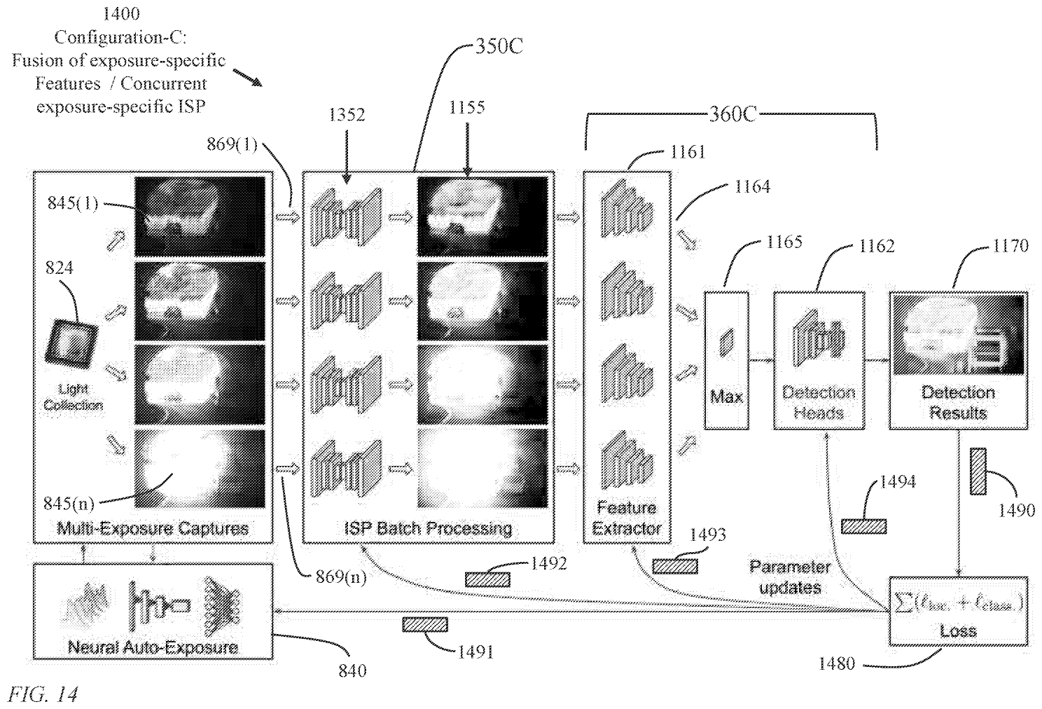

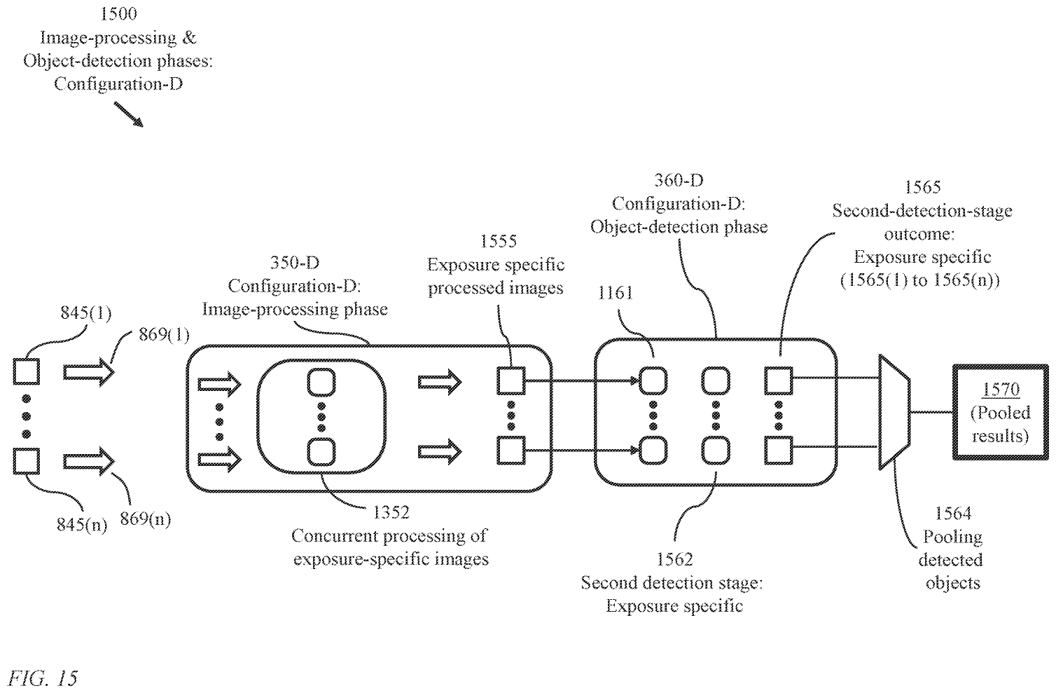

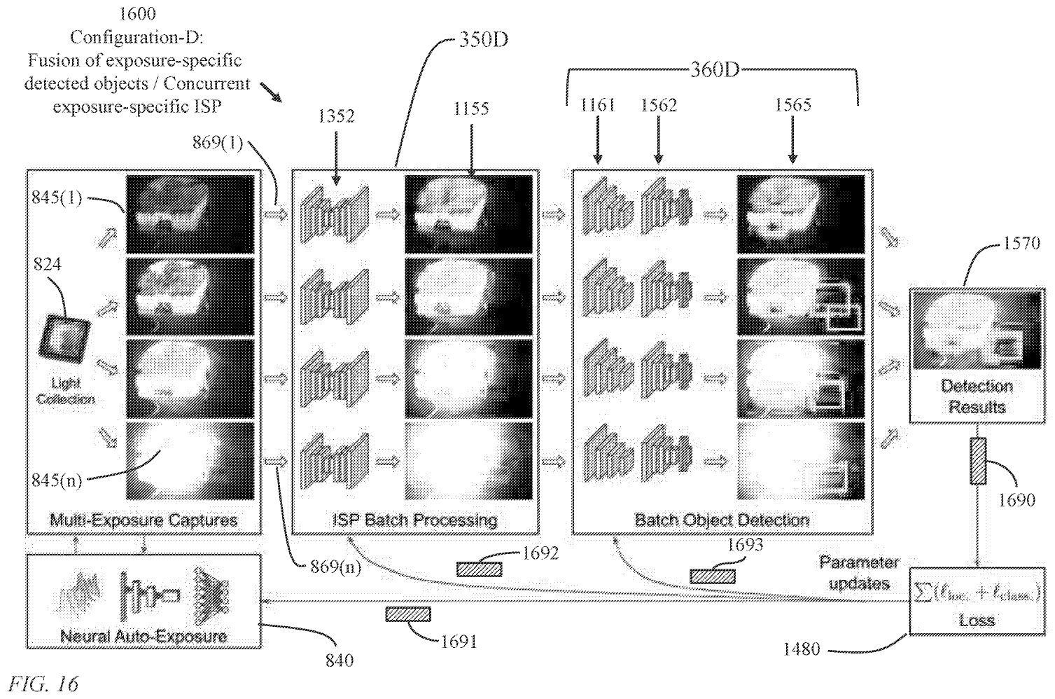

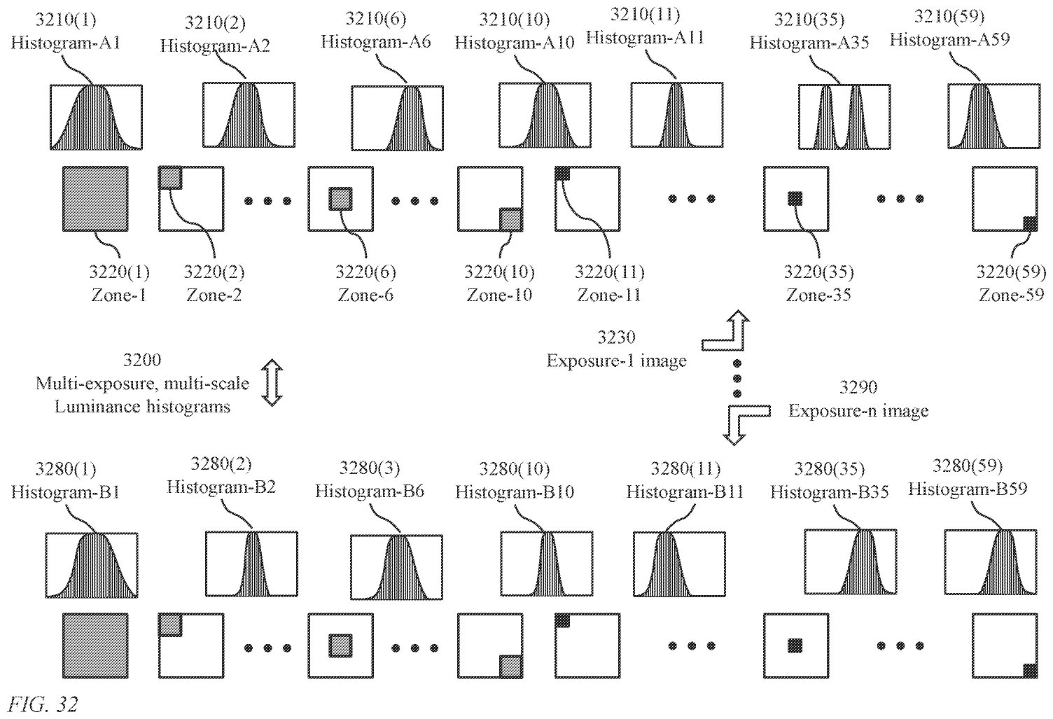

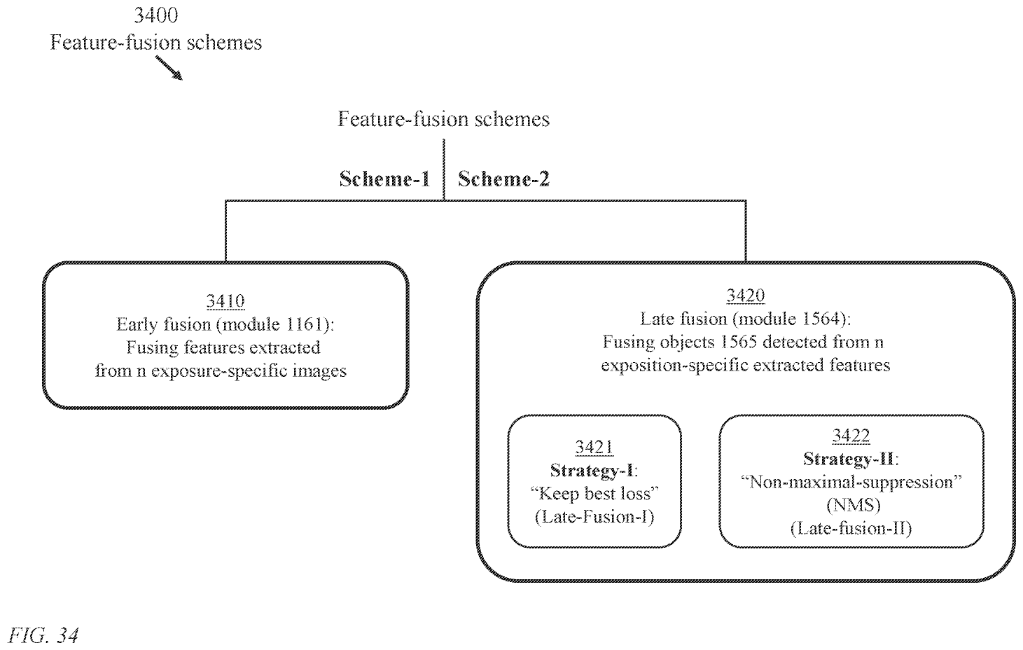

The following reference numerals are used throughout this application:
100: Overview of an arrangement for identifying objects within an image of a scene acquired from a camera;
110: Scene of a high dynamic range
120: Camera
130: Object detection apparatus
140: Training data
150: Detection results (detected objects)
200: Examples of challenging scenarios; scenes of high illumination contrast
210: Scene of a tunnel entrance
220: Scene of a tunnel exit
230: Scene of an incoming vehicle with headlight on
240: Scene of a strong backlight
300: A generic object-detection configuration
340: Sensor-processing phase
350: Image-processing phase
360: Object-detection phase
370: Detection results
400: Distributed control of a computer-vision system of a hypothetical five processing phases
420: A dual link from a phase-processor 420(j), 0□j<5, to respective modules
430: A hardware phase processor of a processing phase; 430(j) corresponds to processing-phase j
440: Memory device holding data exchanged between a phase processor and master-processor 450
450: Master processor
460: Control module maintaining software instructions causing master-processor 450 to perform loss-function computations to derive updated training parameters
462: Training parameters
500: Notations of components of four computer-vision configurations including a conventional configuration
510: Conventional computer-vision configurations, labeled configuration-A, based on fusing raw exposure-specific images to create a single raw HDR image prior to image processing
520: Present configuration-B using a single differentiable ISP for sequential image processing of multiple exposure-specific images, a bank of exposure-specific feature extraction units, a feature-fusing module, and a detection-heads module
530: Present configuration-C using a bank of differentiable ISPs for parallel image processing of multiple exposure-specific images, a bank of exposure-specific feature extraction units, a feature-fusing module, and a detection-heads module
540: Present configuration-D using a bank of differentiable ISPs, a bank of exposure-specific feature extraction units, and a bank of exposure-specific detection-heads modules
600: Methods of object detection including a conventional method and methods according to the present disclosure
610: conventional method based on exposure-specific raw image fusion
611: Method based on exposure-specific feature fusion
612: Method based on exposure-specific detected-objects fusion
620: Process of generating multiple standard-dynamic-range (SDR) exposures
622: Process of fusing multiple SDR exposures to create an image of a high-dynamic-range (HDR) of luminance (of 200 DB s, for example)
624: Conventional image processing (conventional ISP)
626: Conventional object detection
642: Exposure-specific image processing
644: Exposure-specific feature extraction
646: Fusion of all exposure-specific features
648: Objects detection based on fused exposure-specific features
684: Exposure-specific two-stage object detection
686: Fusion of all exposure-specific detected objects
700: Details of sensor-processing phase 340A of the conventional computer-vision configuration of FIG. 5
720: Prior-art auto-exposure formation module
724: Conventional light-collection component
725: Time-multiplexed exposure-specific images
727: Process of fusing the exposure-specific images to form a raw HDR image
728: Fused raw HDR image
729: Signal to image-processing phase
800: Details of sensor-processing phases of three computer-vision configurations of FIG. 5 (configuration-B, configuration-C, and configuration-D)
824: Light-collection component coupled to a neural auto-exposure formation component
840: Neural auto-exposure control module
845: Time-multiplexed raw exposure-specific images
849: Sequentially processed exposure-specific signals directed to a single differentiable ISP of the image-processing phase
869: Concurrently processed exposure-specific signals directed to multiple differentiable ISPs of the image-processing phase
900: An image-processing phase and an objection-detection phase of the conventional computer-vision configuration of FIG. 5 (configuration-A)
910: Result from sensor-processing phase 340A (detailed in FIG. 7)
952: An image-processing module handling fused raw HDR image 728
955: Processed HDR image
961: First detection stage of the object-detection phase 360A
962: Second detection stage of the object-detection phase 360A
970: Detected objects
1000: The entire conventional configuration (configuration-A)
1100: The image-processing phase and the objection-detection phase of the second computer-vision configurations (configuration-B)
1110: Result from sensor-processing phase 340B (detailed in FIG. 8)
1152: Differentiable ISP sequentially processing raw exposure images 845(1) to 845(n), n>1
1155: Processed exposure-specific images
1161: Exposure-specific feature extraction module (first detection stage of the detection phase 360B)
1162: Module for objects detection from the pooled features (Second detection stage of the detection phase 340B)
1164: Features-fusing module
1165: Pooled extracted features
1170: Detected objects according to configuration-B
1200: The entire configuration-B of the disclosure
1300: The image-processing phase and the objection-detection phase of the third computer-vision configurations (configuration-C)
1310: Result from sensor-processing phase 340C (detailed in FIG. 8)
1352: Multiple differentiable ISPs concurrently processing raw exposure-specific images 845(1) to 845(n), n>1
1355: Processed exposure-specific images
1370: Detected objects according to configuration-C
1400: The entire configuration-C of the disclosure (Control module 460 is coupled to master processor 450 and respective phase processors 430)
1480: A loss-function derivation module 1480 within control module 460
1490: Detected-objects data provided to control module 460 for recomputing training parameters
1491: Control data to sensor-processing phase 340-C of configuration-C
1492: Control data to image-processing phase 350-C of configuration-C
1493: Control data to feature-extraction module 1161, which is the first-detection stage of objection-detection phase 360-C of configuration-C
1494: Control data to object-detection process 1562, which is the second-detection stage of objection-detection phase 360-C of configuration-C 1562
1500: The image-processing phase and the objection-detection phase of the fourth computer-vision configurations (configuration-D)
1562: Module for objects detection from the exposure-specific extracted features
1564: Fusing module, fusing exposure-specific detected objects 1565
1565: Exposure-specific detected objects
1570: Detected objects according to configuration-D
1600: The entire configuration-D of the disclosure
1690: Detected-objects data provided to control module 460 (which includes loss-function derivation module 1480) for recomputing training parameters of configuration-D
1691: Control data to sensor-processing phase 340-D of configuration-D
1692: Control data to image-processing phase 350-D of configuration-D
1693: Control data to objection-detection phase 360-D of configuration-D
2100: Feature-domain fusing versus image-domain fusing
2110: Conventional auto-exposure control
2120: Trained auto-exposure control
2125: A set of raw exposure-specific images produced according to conventional exposure control
2145: An enhanced set of raw exposure-specific images produced according to learned exposure control
2155: Sets of exposure-specific processed images (FIG. 11, FIG. 13, FIGS. 15, 1155(1) to 1155(n))
2161: Sets of exposure-specific features (FIG. 11, FIG. 13, FIGS. 15, 1161(1) to 1155(n))
2165: A set of exposure-specific detected objects (FIGS. 15, 1565(1) to 1565(n))
2200: Overview of Configuration-B illustrating backpropagation from control module 460
2270: Processed exposure-specific images
2290: Detected-objects data provided to control module 460 for recomputing training parameters
2291: Backpropagated data to object-detection phase 360B and image-processing phase 350B
2292: Backpropagated data to sensor-processing phase 340B
2300: Details of sensor-processing phase 340B of configuration-B
2310: Multiple exposure-images generation for configuration-B
2350: Gradient values
2400: Details of image-processing phase 350-B and object-detection phase 350-C of configuration-B
2500: Overview of configuration-C illustrating backpropagation from control module 460
2600: Details of sensor-processing phase 340C of configuration-C
2610: Multiple exposure-images generation for configuration-C
2680: Multiple processed exposure-specific optical signals, 869(1) to 869(n), directed to multiple differentiable ISPs of the image-processing phase 350C
2700: Details of image-processing phase 350C of configuration-C
2800: Details of object-detection phase 360C of configuration-C
2900: Overview of configuration-D illustrating backpropagation from control module 460
3000: Details of object-detection phase 360D of configuration-D
3020: Dual channels from phase processor 430(3) to module 1161 and module 1562
3025: Dual channel from phase-processor 430(3) to fusing module 1564
3200: multi-exposure, multi-scale luminance histograms
3210: Luminance histograms for specific zones of a first exposure-specific image
3220: Specific zones of an image
3280: Luminance histograms for specific zones of last exposure-specific image
3300: Selection of multiple scales of luminance zones where successive scales bear a rational relationship
3400: Feature-fusion schemes
3410: Early-fusion scheme
3420: Late-fusion scheme
3421: Late-fusion strategy-I □ “keep best loss”
3422: Late-fusion strategy-II □ “non-maximal suppression”
3500: Feedback control data and backpropagation of data from control module 460 determining updated training parameters based on loss-function calculations, within configuration-C, FIG. 14, or configuration-D, FIG. 16
3600: Schematic of the core computer-vision apparatus of the present disclosure
3650: Candidate objects pruning module
3680: Overall pruned objects
3700: method of object detection in images of scenes of diverse illumination conditions
3710: Process of generating multiple exposure-specific images, 845(1) to 845(n), n>1, for a scene (implemented in the sensor-processing phase, neural auto-exposure control module 840, FIG. 8, FIG. 12, FIG. 14, FIG. 16)
3714: A process of deriving exposure-specific multi-scale zonal illumination distribution (FIG. 32, implemented in the sensor-processing phase, neural auto-exposure control module 840)
3720: Step of selecting configuration-B, option (1), or either configuration-C or configuration-D, option (2)
3724: Process of sequentially processing the n exposure-specific images using a single ISP module (1152, FIG. 11, FIG. 12)
3728: Process of concurrently processing the exposure-specific images using multiple ISP modules (1352, FIG. 13, FIG. 14, FIG. 15, FIG. 16)
3730: Process of exposure-specific feature extraction (1161, FIG. 11 to FIG. 16)
3732: Step of selecting one of “early fusion” and “Late fusion”
3734: Process of fusing exposure-specific features (1164, FIG. 11 to FIG. 14)
3735: Process of detecting objects 1165 from fused features (1162, FIG. 11 to FIG. 14)
3738: Process of detecting exposure-specific objects (1562, FIG. 15, FIG. 16)
3739: Process of fusing exposure-specific detected objects 1564 (1564, FIG. 15, FIG. 16)
3740: Detection results (1170, FIG. 11 to FIG. 14, 1570, FIG. 15, FIG. 16)
3800: An arrangement of a control mechanism of the core computer-vision apparatus of the present disclosure;
3810: Link to external sources
3812: Links to sensor-processing-phase modules
3814: Links to image-processing-phase modules
3816: Links to object-detection-phase modules
3820: Dual buffers (individually, 2820(1) to 2620(4))
3830: Dual ports of switch 4840 (individually, 3830(1) to 3830(4))
3840: Conventional 4×4 switch
3900: Timing of upstream processes of a computer-vision apparatus employing multiple sensors for concurrent acquisition of multiple images of a scene, with different illumination ranges
3910: Concurrent images captured under different illumination settings during successive exposure time intervals; images captured under a first illumination setting are denoted Uj, images captured under a second illumination setting are denoted Vj, and images captured under a third illumination setting are denoted Wj, j≥0, j being an integer
3911: A first exposure interval of duration T1 seconds during which a first image is captured
3914: Fourth exposure interval of duration T1 seconds during which a fourth image is captured
3920: Processing time windows within the image-processing phase for the third illumination setting
3921: Image-processing time window, of duration T2, for image W0
3924: Image-processing time window, of duration T2, for image W3
3930: Processing time windows within the feature-extraction stage (1st stage) of the object detection phase for the third illumination setting
3931: Feature-extraction time window, of duration T3, corresponding to image W0
3934: Feature-extraction time window, of duration T3, corresponding to image W3
3940: Processing time windows within the object identification stage (2nd stage) of the object detection phase for the third illumination setting
3941: Object identification time window, of duration T4, corresponding to image W0
3944: Object-identification time window, of duration T4, corresponding to image W3
3950: Time windows corresponding to successive images, W0, W1, W2, . . . , corresponding to the third illumination setting
4000: First example of timing of upstream processes of a computer-vision apparatus employing a single sensor for sequential acquisition of multiple images of a time-varying scene, with different illumination ranges,
4010: Sequential images captured under different illumination settings during successive exposure time intervals; images captured under a first illumination setting are denoted Aj, images captured under a second illumination setting are denoted Bj, and images captured under a third illumination setting are denoted Cj, j≥0, j being an integer (the sum of exposure time intervals of Aj, Bj, and Cj equals T1, for any value of j)
4011: A first exposure time interval of duration T seconds during which a first image is captured
4014: Fourth exposure time interval of duration T seconds during which a fourth image is captured
4100: Second example of timing of upstream processes of a computer-vision apparatus employing a single sensor for sequential acquisition of multiple images of a time-varying scene with different illumination ranges
4120: Processing time windows within the image-processing phase for the second illumination setting
4121: Image-processing time window, of duration T2, for image B0
4124: Image-processing time window, of duration T2, for image B3
4130: Processing time windows within the feature-extraction stage (1st stage of the object detection phase), for the second illumination setting
4131: Feature-extraction time window, of duration T3, corresponding to image B0
4134: Feature-extraction time window, of duration T3, corresponding to image B3
4140: Processing time windows within the object identification stage (2nd stage of the object detection phase), for the second illumination setting
4141: Object identification time window, of duration T4, corresponding to image B0
4144: Object-identification time window, of duration T4, corresponding to image B3
4150: Time windows corresponding to successive images, B0, B1, B2, . . . , corresponding to the second illumination setting
4200: Third example of timing of upstream processes of a computer-vision apparatus employing a single sensor for sequential acquisition of multiple images of a time-varying scene, with different illumination ranges; the sensor period is adjusted to realize steady-state operation
4300: Overview of parallel exposure-specific pipelines
4305: Signal received from a camera
4310: Exposure-specific pipeline processing a first stream of images corresponding to a first illumination setting
4320: Exposure-specific pipeline processing a second stream of images corresponding to a second illumination setting
4330: Exposure-specific pipeline processing a third stream of images corresponding to a third illumination setting
4341: Buffers holding raw images
4342: Buffers holding processed images
4343: Buffers holding extracted features
4340: Buffers holding identified candidate objects
4350: A module for pooling and pruning candidate objects
4355: Results including data relevant to detected-objects
4400: Timing of results of the parallel exposure-specific pipelines 4300
4410: Continuous stream of exposure-specific images where a pattern of a predefined number, n, of illumination settings recurs ad infinitum
4412: One of time windows allocated to an exposure of a specific illumination setting
4420: Time difference, Q, between completion period, Tc, and sensor cyclic period, T1, Q>0.0
4440: Results of processing n consecutive exposure-specific images (different illumination ranges, n=3)
4500: Parallel complete pipelines (each complete pipeline comprising a number n of exposure-specific pipelines, 4300)
4510: Example of two pipelines
4540: Results of n successive exposure-specific images, n being the total number of exposure settings
4600: Comparison of detection results of the method of “Late-fusion-II” with other methods for selected scenes
4610: Sample detection results, for a respective first-exposure setting, using the method of late-fusion-strategy-II
4620: Sample detection results, for a respective second-exposure setting, using the method of late-fusion-strategy-II
4630: Sample detection results, for a respective third-exposure setting, using the method of late-fusion-strategy-II
4640: Sample detection results using the HDR-II pipeline
4650: Sample detection results using the reference auto-exposure control (Onzon et al.)
4700: Comparison of detection results of the method of “Late-fusion-I” with other methods for selected scenes (4710, 4720, 4730, 4740, and 4750 are counterparts of 4610, 4620, 4630, 4640, and 4650)
4800: Comparison of detection results of the method of “Late-fusion-I” with other methods for additional selected scenes (4810, 4820, 4830, 4840, and 4850 are counterparts of 4610, 4620, 4630, 4640, and 4650)
4900: Comparison of detection results of the method of “Late-fusion-I” with other methods for further selected scenes (4910, 4920, 4930, 4940, and 4950 are counterparts of 4610, 4620, 4630, 4640, and 4650)
5000: Comparison of detection results of the method of “Late-fusion-II” with other methods for additional selected scenes (5010, 5020, 5030, 5040, and 5050 are counterparts of 4610, 4620, 4630, 4640, and 4650)
5100: Comparison of detection results of the method of Early fusion (FIG. 34) with other methods for selected scenes (5110, 5120, 5130, 5140, and 5150 are counterparts of 4610, 4620, 4630, 4640, and 4650)

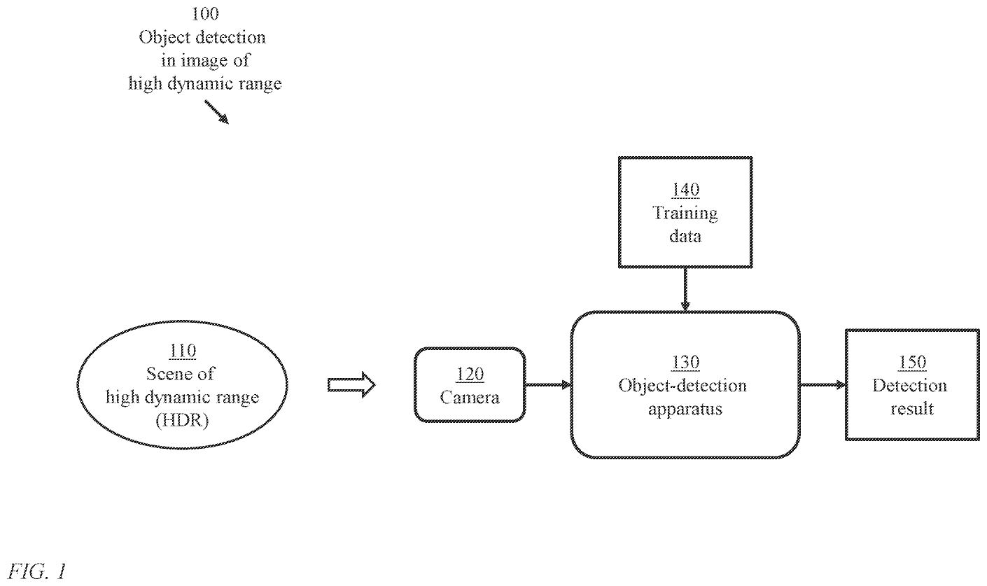

FIG. 1 is an overview 100 of a system for identifying objects within an image of a scene 110, of high illumination contrast (high dynamic range), acquired as an image from a camera 120. An object detection apparatus 130, accessing training data 140, is trained to detect objects 150 within the image.

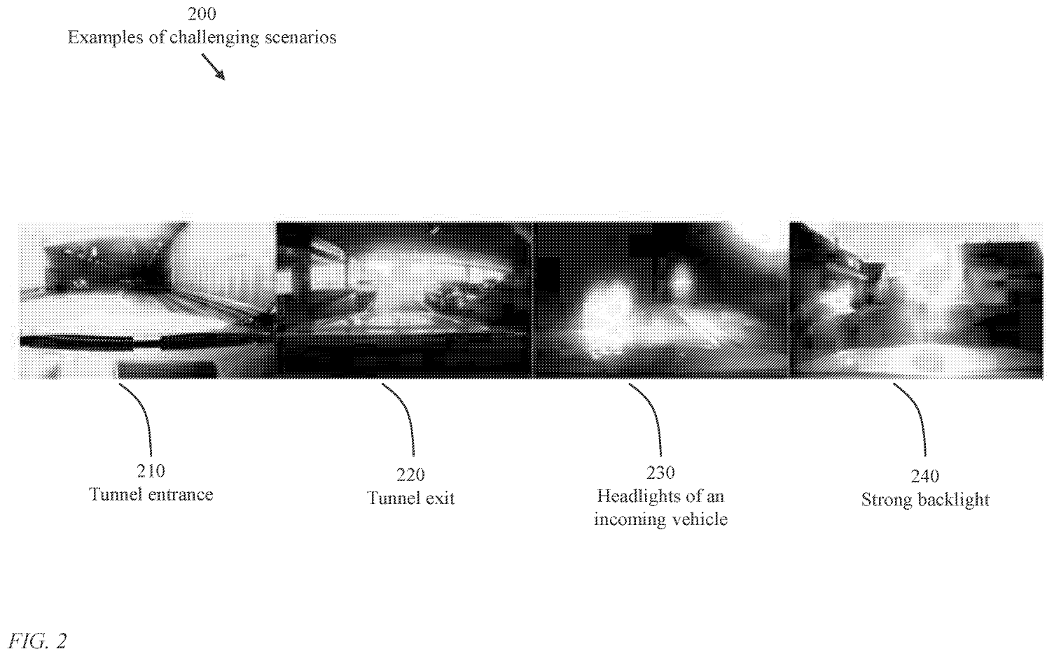

FIG. 2 illustrates four exemplary challenging fields of view of high illumination contrast, including:
scene 210 of a tunnel entrance;
scene 220 of an exit of a tunnel;
scene 230 of an incoming vehicle with headlight; and
scene 240 of a strong backlight.

Scenes with very low and high luminance complicate HDR fusion in image space and lead to poor details and low contrast.

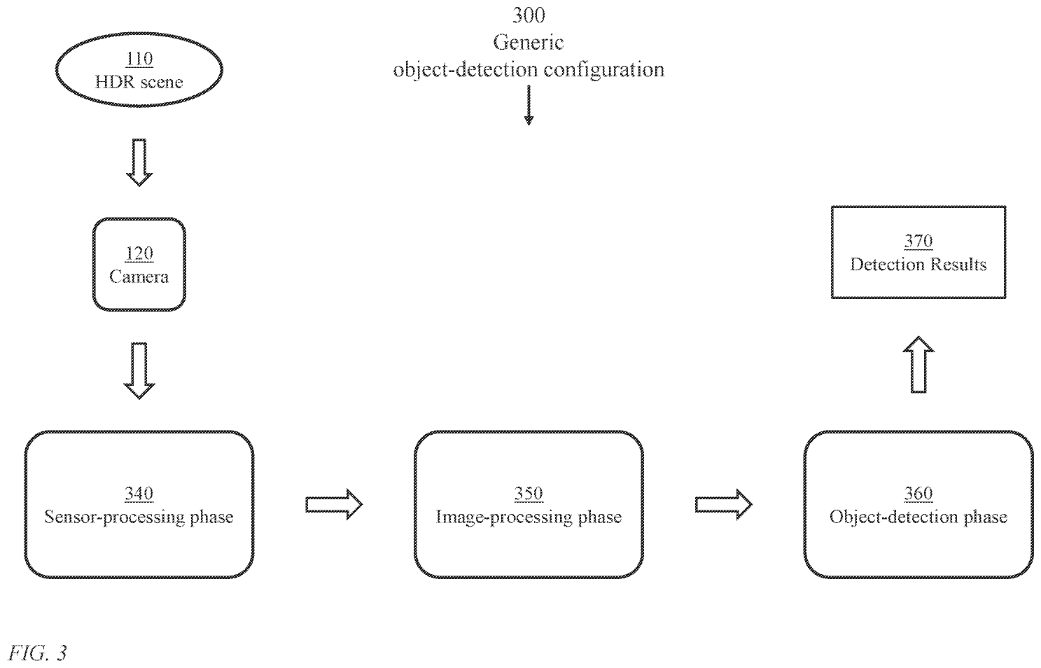

FIG. 3 illustrates a generic object-detection system 300 implemented in three phases. A sensor-processing phase 340 transforms a signal representing a field of view to a signal suitable for electronic processing. An image-processing phase 350 produces an electronic signal, organized as a conventional stream of pixels, and performs a sequence of standard image signal processing (ISP). An object-detection phase 360 identifies objects 370 within a processed image.

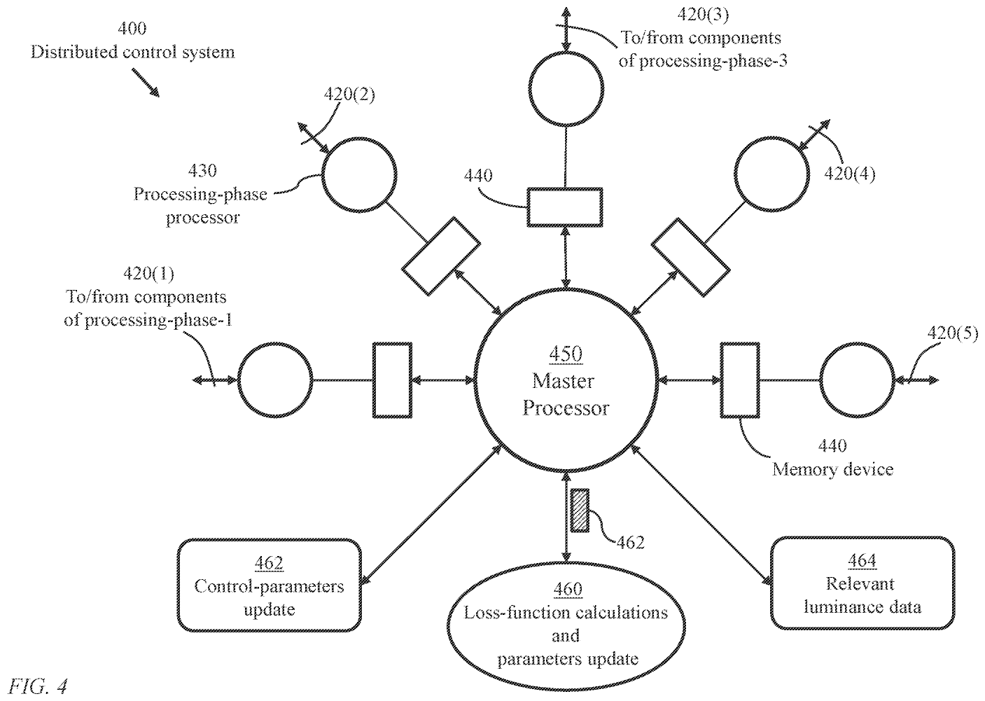

FIG. 4 illustrates a distributed-control system 400 for a generic computer-vision system, similar to system 300, but organized into an arbitrary number of processing phases, each processing phase having a respective phase processor 430 (individual phase processor are referenced as 430(1), 430(2), . . . ). The exemplary system of FIG. 4 is organized into five processing phases. Each processor 430 has a respective dual link 420 to components of a respective processing phase. A dual link 420(j) carries exchanged data between a processor 430(j) and components of processing phase j, 0≤j<5. Each processing-phase-specific processor 430 is preferably an independent hardware processor. However, the tasks of processors 430 may be performs using a shared pool of an arbitrary number of processors.

A master processor 450 communicates with each phase processor 430 through a respective memory device 440. A control module 460 comprises a memory device holding software instructions which causes master-processor 450 to perform loss-function computations to derive updated training parameters 462 to be propagated to individual phase processors. A phase processor 430 may comprise multiple processing units.

FIG. 5 sets notations 500 of components of four computer-vision configurations including:
notations 510 for a conventional computer-vision configuration which fuses exposure-specific images in a sensor-processing phase to create a single HDR image prior to image processing;
notation 520 for configuration-B, according to the present disclosure, which performs sequential image processing of multiple exposure-specific images, using a single differentiable ISP, then performs parallel exposure-specific feature extraction processes;
notations 530 for configuration-C, according to the present disclosure, which performs parallel image processing of multiple exposure-specific images, using multiple differentiable ISPs, then performs parallel exposure-specific feature extractions, and object detection from fused exposure-specific features; and
notation 540 for configuration-D, according to the present disclosure, which performs parallel image processing of multiple exposure-specific images, using multiple differentiable ISPs, then performs parallel exposure-specific feature extraction units, parallel exposure-specific object-detection, and fusing of exposure-specific detected objects.

The sensor-processing phase, the image-processing phase, and the object-detection phase for configuration-A, configuration-B, configuration-C, and configuration-D are denoted:

{340A, 350A, 360A}, {340B, 350B, 360B}, {340C, 350C, 360C}, AND {340D, 350D, 360D}, respectively.

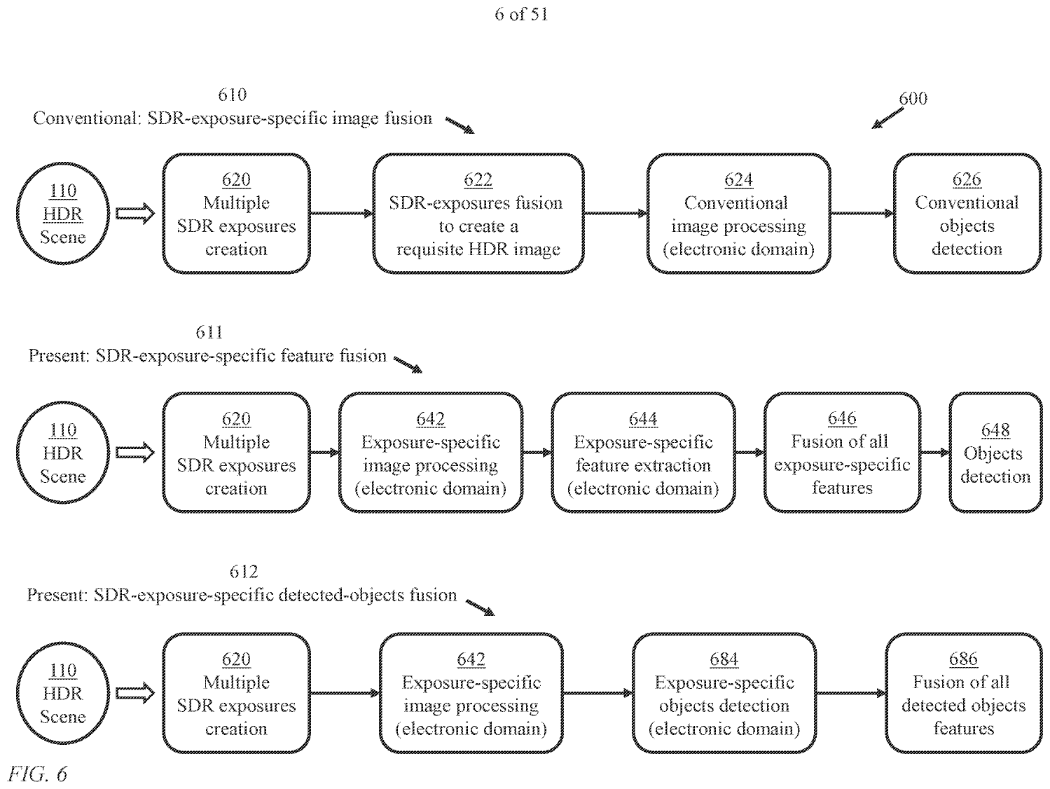

FIG. 6 illustrates methods 600 of object detection, including a conventional method 610 and methods according to the present disclosure, for handling cases of a dynamic range exceeding the capability of current image sensors. Method 610 fuses SDR-exposure-specific images. A method 611 fuses SDR-exposure-specific features. A method 612 fuses SDR-exposure-specific detected-objects fusion.

According to method 610:
process 620 derives multiple standard-dynamic-range (SDR) exposures;
process 622 fuses the multiple SDR exposures to create a fused image of a requisite high-dynamic-range (HDR) of luminance (of 200 DBs, for example);
conventional image processing (conventional ISP) 624 is applied to the fused image to produce a respective processed fused image; and
conventional object detection process 626 is applied to detect individual objects.

According to method 611:
process 620 derives multiple standard-dynamic-range (SDR) exposures;
process 642 processes individual SDR exposure images;
process 644 extracts exposure-specific features (in a first-stage of a two-stage object-detection process);
process 646 fuses all exposure-specific features; and
process 648 performs object detection from fused features (in the second stage of the two-stage objects detection).

According to method 612:
process 620 derives multiple standard-dynamic-range (SDR) exposures;
process 642 processes individual SDR exposure images;
process 684 performs exposure-specific two-stage object detection; and
process 686 fuses all exposure-specific detected objects.

FIG. 7 illustrates implementation details 700 of the sensor-processing phase 340A of the conventional computer-vision configuration (510, FIG. 5, method 610, FIG. 6). A prior-art auto-exposure derivation device 720, coupled to a conventional light-collection component 724, derives a number n, n>1, of time-multiplexed exposure-specific images, collectively referenced as 725 and individual referenced as 725(1) to 725(n). A device 727 performs a process of fusing the n exposure-specific images 725 to form an HDR image of a requisite dynamic range to form a raw HDR image 728. A signal path 729 transfers the raw HDR image to image-processing phase 340B.

FIG. 8 illustrates implementation details 800 of the sensor-processing phases of configuration-B, configuration-C, and configuration-D. A neural auto-exposure controller 840, coupled to a light-collection component 824, derives the number, n, of time-multiplexed raw exposure-specific SDR images, collectively referenced as 845 and individual referenced as 845(1) to 845(n).

It is noted that the neural auto-exposure 840 trained on data to optimize the object detection performance, whereas the prior art auto-exposure 720 is a hand-crafted algorithm (i.e., not learned).

The dynamic ranges of the SDR images are entirely determined by the exposure settings and the bit depth of the SDR images. The bit-depth is typically 12 bits. The exposure settings are determined as follows. Three SDR images, I_lower, I_middle, I_upper denoting respectively the captures with the lower, middle and upper exposures are used. An exposure e_middle of I_middle is determined by the output of the neural auto-exposure, and the exposures of I_lower and I_upper are respectively e_middle divided by delta and e_middle multiplied by delta, where delta is the corresponding value used when training neural auto-exposure. According to an implementation, delta is selected to equal 45.

In configuration-C, the n SDR images are directed, over paths 849 (individually referenced as 869(1) to 869(n)) to a single differentiable ISP of the image-processing phase for sequential signal processing. In configuration-D, the n SDR images are directed, over paths 869, to multiple differentiable ISPs of the image-processing phase for concurrent signal processing.

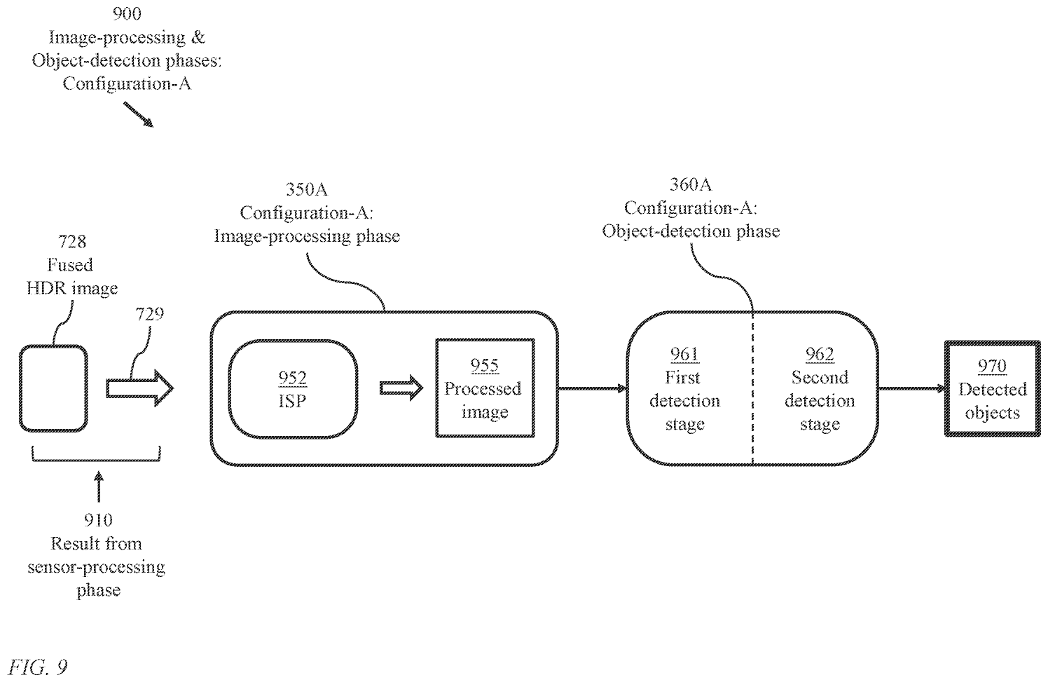

FIG. 9 illustrates components 900 of the image-processing phase 350A and the objection-detection phase 360A of the conventional computer-vision configuration (configuration-A, 510, FIG. 5). The raw HDR image 728, produced in the sensor-processing stage 340A of configuration-A, is supplied to image processor 952 which produces processed HDR image 955. A first detection stage, 961, of the object-detection phase 360A, extract features from the processed HDR image 955. A second detection stage, 962, of the object-detection phase 360A produces detected objects (identifiable objects) 970.

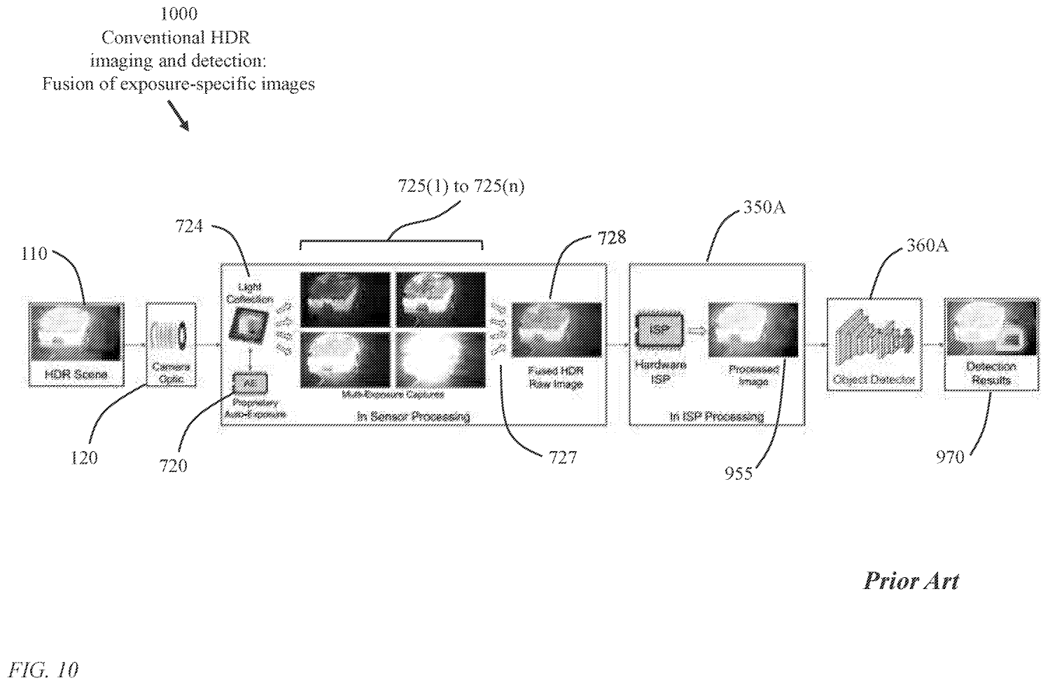

FIG. 10 illustrates an entire assembly 1000 of the conventional configuration (configuration-A). Reference numerals inserted in FIG. 10 facilitate relating components of assembly 1000 to those introduced in FIG. 1, FIG. 7, and FIG. 9.

FIG. 11 illustrates a combination 1100 of the image-processing phase 350B and the objection-detection phase 360B of computer-vision configuration-B (520, FIG. 5). Raw exposure-specific SDR images 845(1) to 845(n), produced in the sensor-processing stage 340B of configuration-B (FIG. 8), are supplied to differentiable ISP 1152 to sequentially produce n processed exposure-specific images 1155. Exposure-specific feature-extractor module 1161 performs the first detection stage of the two-stage detection phase 360B. A pooled extracted features 1165 is supplied to the second-stage 1162, of the two-stage detection phase 360B which produces detected objects 1170, according to configuration-B.

FIG. 12 illustrates an entire assembly 1200 of configuration-B. Reference numerals inserted in FIG. 12 facilitate relating components of assembly 1200 which are introduced in FIG. 1, FIG. 8, and FIG. 11.

FIG. 13 illustrates a combination 1300 of the image-processing phase 350C and the objection-detection phase 360C of computer-vision configuration-C (530, FIG. 5). Raw exposure-specific SDR images 845(1) to 845(n), produced in the sensor-processing stage 340C of configuration-C (FIG. 8), are supplied to n differentiable ISPs 1352 to concurrently process raw exposure images 845(1) to 845(n) to produce n processed exposure-specific images 1155. As in configuration-B, exposure-specific feature-extraction module 1161 performs the first stage of the two-stage detection phase 360C to extract exposure-specific features which are fused using features-fusing module. A pooled extracted features 1165 is supplied to the second-stage 1162, of the two-stage detection phase 360C which produces detected objects 1370, according to configuration-C.

FIG. 14 illustrates an entire assembly 1400 of configuration-C. Reference numerals inserted in FIG. 14 facilitate relating components of assembly 1400 to those introduced in FIG. 8 and FIG. 13. Control data 1490 derived from detected objects 1370 is supplied to control module 460 which comprises a loss-function derivation module 1480. Control module 460 is communicatively coupled to master processor 450 and respective phase processors 430 of:
neural auto-exposure derivation device 840 through control path 1491;
differentiable ISPs 1352 through control path 1492;
the first-stage 1161 (exposure-specific feature-extraction module) of the two-stage detection phase 360C through control path 1493; and
the second-stage 1162 of the two-stage detection phase 360B, through control path 1494.

Thus, the computer-vision pipeline of configuration-C performs feature-domain fusion (labeled “early fusion”) of exposure-specific extracted features in the object-detection phase 360C with corresponding generalized neural auto-exposure control in the sensor-processing phase 340C.

FIG. 15 illustrates a combination 1500 of the image-processing phase 350D and the objection-detection phase 360D of computer-vision configuration-D (540, FIG. 5). The image-processing phase 350D is identical to image-processing phase 350C. As in configuration-B and configuration-C, exposure-specific feature extraction module 1161 performs the first stage of the two-stage detection phase 360D. Exposure-specific feature-extraction module 1562 detects exposure-specific objects 1565 from extracted features corresponding to each SDR exposure. The exposure-specific detected objects are pooled (module 1564) to produce detected objects 1570.

FIG. 16 illustrates an entire assembly 1600 of configuration-D. Reference numerals inserted in FIG. 16 facilitate relating components of assembly 1600 which are introduced in FIG. 8, FIG. 13 and FIG. 15. Control data 1690 derived from detected objects 1570 is supplied to control module 460 which comprises a loss-function derivation module 1680. Control module 460 is communicatively coupled to master processor 450 and respective phase processors 430 of:
neural auto-exposure derivation device 840 through control path 1691;
differentiable ISPs 1352 through control path 1692; and
the two-stage detection phase 360D through control path 1693.

Thus, the computer-vision pipeline of configuration-D performs fusion (labelled “late fusion”) of exposure-specific detected objects in the object-detection phase 360D with corresponding generalized neural auto-exposure control in the sensor-processing phase 340D.

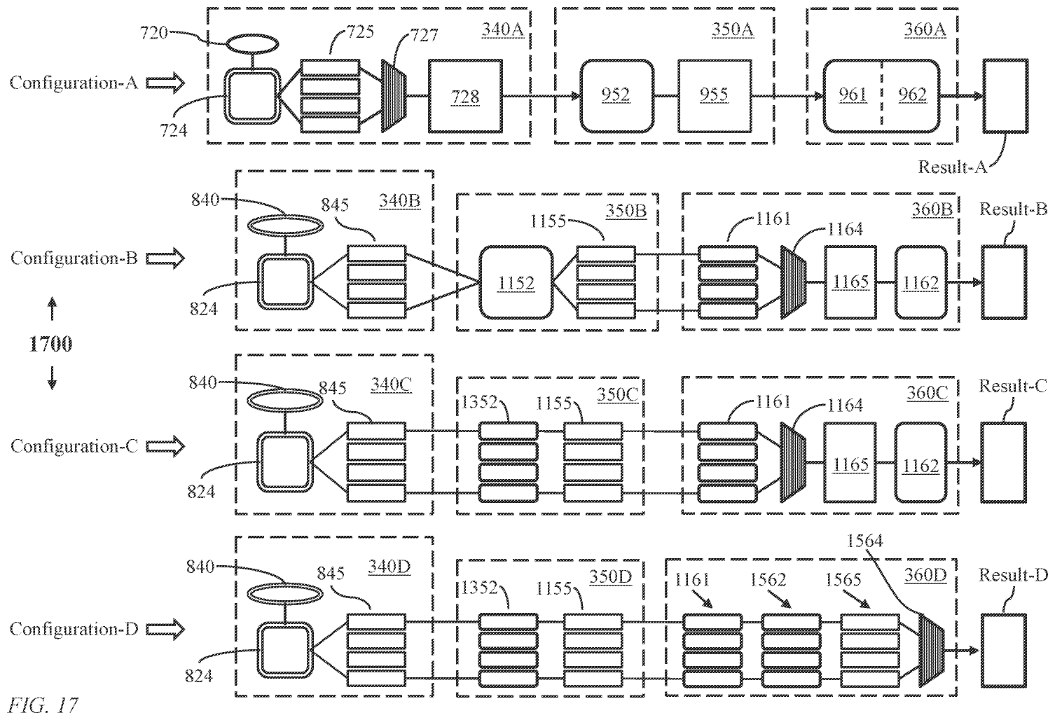

FIG. 17 summarizes common processes and respective distinct processes of configuration-A, configuration-B, configuration-C, and configuration-D. The similarities and differences of the configurations within each processing phase are outlined below.

### Sensor-Processing Phase

In configuration-A, exposure-specific images are produced using conventional auto-exposure formation module 720 then fused to form a fused raw HDR image 728, this—in effect—compensates for the unavailability of an image sensor capable of handling a target HDR.

In configuration-B, configuration-C, and configuration-D, exposure-specific images are produced using trained neural auto-exposure formation module 840 and are used separately in subsequent image processing (340B, 340C, and 340D are identical).

### Image-Processing Phase

Configuration-A performs conventional image processing of the fused raw HDR image to produce a processed image.

Configuration-B sequentially process the exposure-specific images.

Configuration-C and configuration-D concurrently process the exposure-specific images (450C and 350D are identical)

### Object-Detection Phase

Configuration-A performs a conventional two-stage object detection from the processed image.

Each of configuration-B and configuration-C uses exposure-specific feature extraction module 1161 to produce exposure-specific features which are fused, using features-fusing module 1164, to produce pooled extracted features 1165, from which objects are detected using module 1162 (360B and 360C are identical).

Configuration-D uses exposure-specific feature extraction module 1161 to produce exposure-specific features from which exposure-specific objects 1565 are detected, using module 1562, to be fused using module 1564.

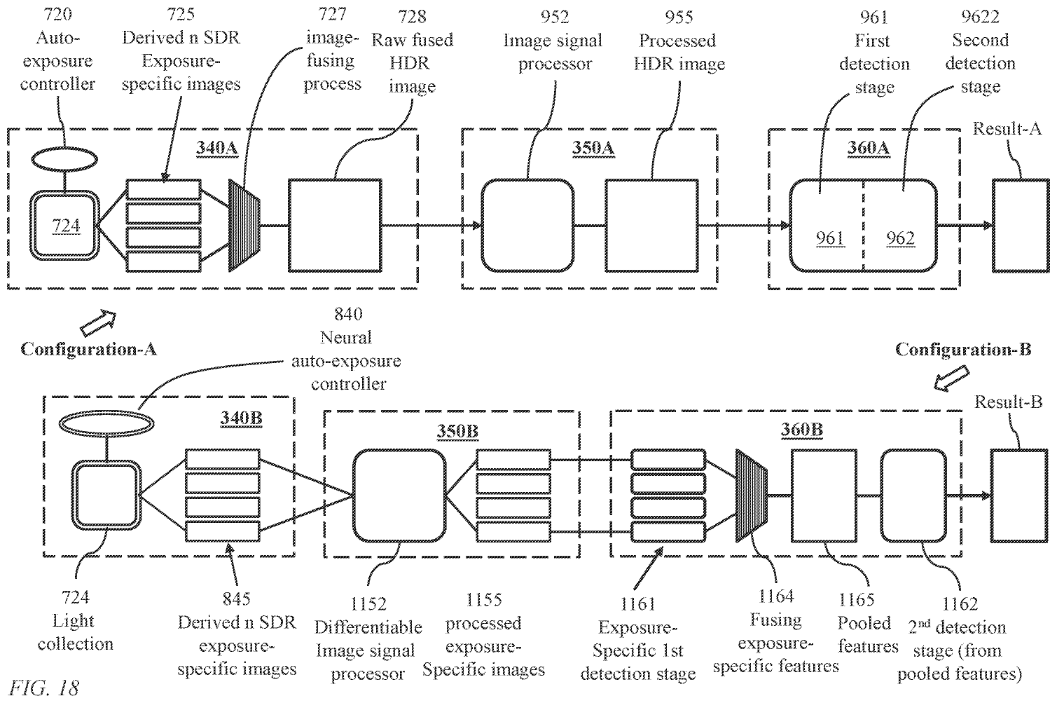

FIG. 18 further clarifies configuration-A and configuration-B. It is seen that each of the sensor-processing phase, the image-processing phase, and the object-detection phase of configuration-B is distinct from its prior-art counterpart.

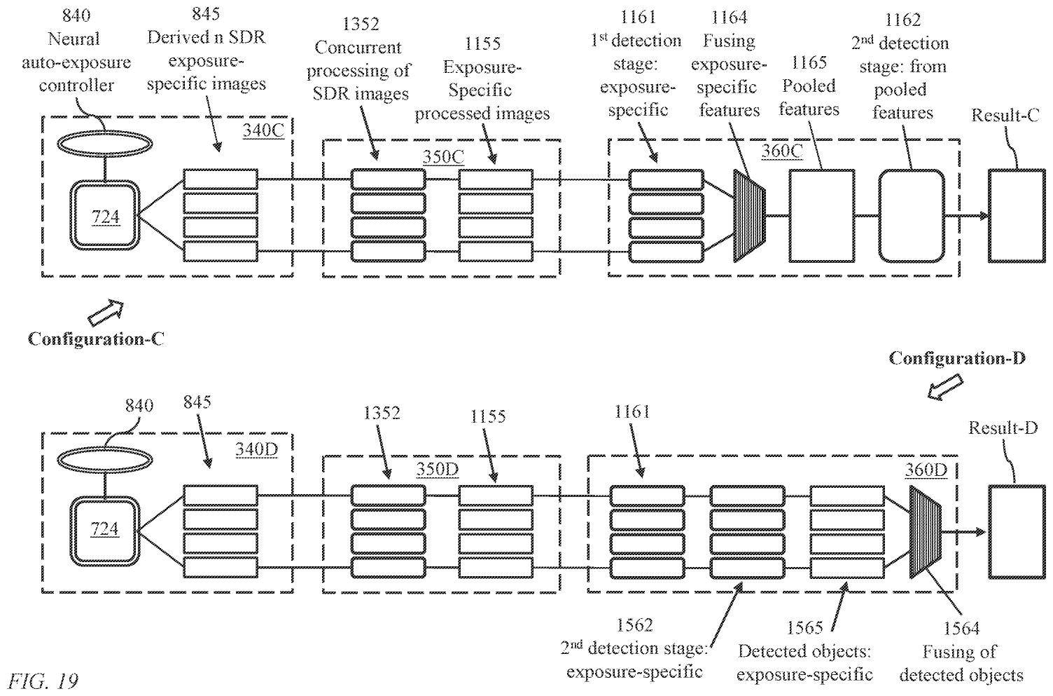

FIG. 19 further clarifies configuration-C and configuration-D. The main difference between the two configurations is the application of early fusion in configuration-C but late fusion in configuration-D.

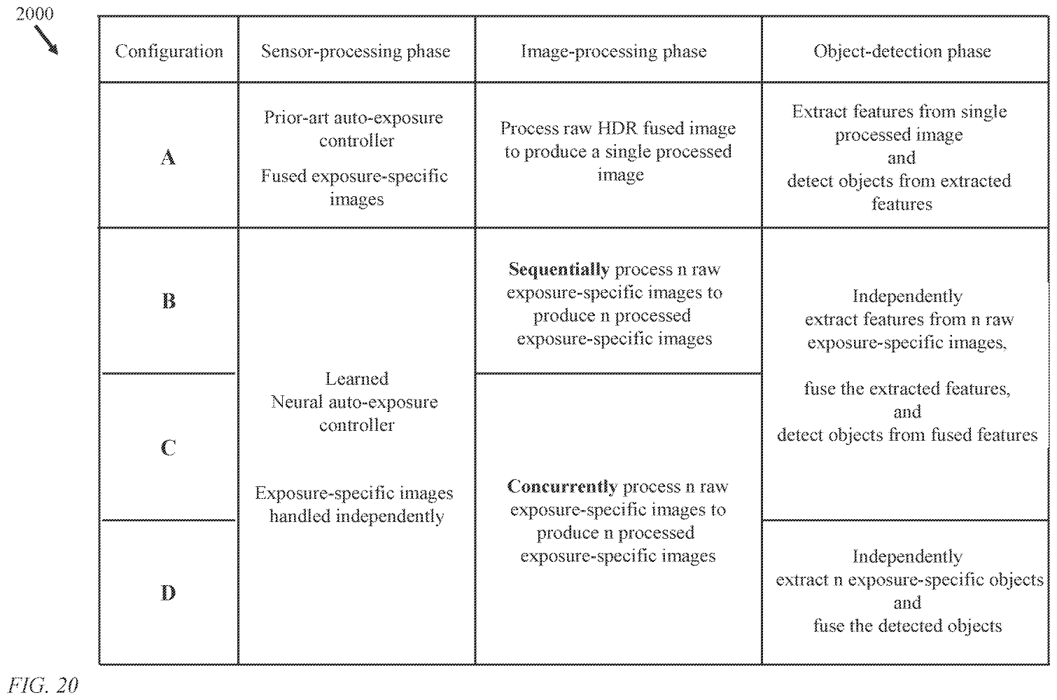

FIG. 20 compares further aspects of the sensor-processing phase, the image-processing phase, and the object-detection phase of the aforementioned four computer-vision configurations (configuration-A to configuration-D).

For the sensor-processing phase 340, configuration-A employs a prior-art auto-exposure controller 720 to derive n exposure-specific images which are subsequently fused to form a raw HDR fused image 728 to be processed in the subsequent phases, 350 and 360, using conventional methods. Each of configuration-B, configuration-C, and configuration-D employs a neural auto-exposure control module 840 to derive n exposure-specific images 845 which are handled independently in the subsequent image-processing phase 350.

For the image-processing phase 350, configuration-A processes the single raw HDR fused message using a conventional ISP method. Configuration-B uses differential ISP 1152 to sequentially process the n exposure-specific images 845 to produce n processed exposure-specific images 1155 from which features are extracted in subsequent phase 360B. Each of configuration-C and configuration-D concurrently process the n exposure-specific images 845 to produce n processed exposure-specific images 1355 from which features are extracted in subsequent phase 360C or 360D.

For the objection-detection phase 360, configuration-A employs the conventional two-stage detection method. Configuration-B concurrently extracts features from the n processed exposure-specific images 1155. The feature-extraction process is performed in a first stage of the detection-phase 360B. The extracted n exposure-specific features are fused (module 1164) to produce pooled features 1165 from which objects are detected in the second detection stage 1162 of the detection phase 360B.

The object-detection phase 360C of configuration-C is identical to object-detection-phase 360B.

Configuration-D concurrently extracts features from the n processed exposure-specific images 1355. The feature-extraction process is performed in a first stage of the detection-phase 360D. The second stage 1562 detects n exposure-specific objects 1565 which are fused (module 1564) to produce the overall objects.

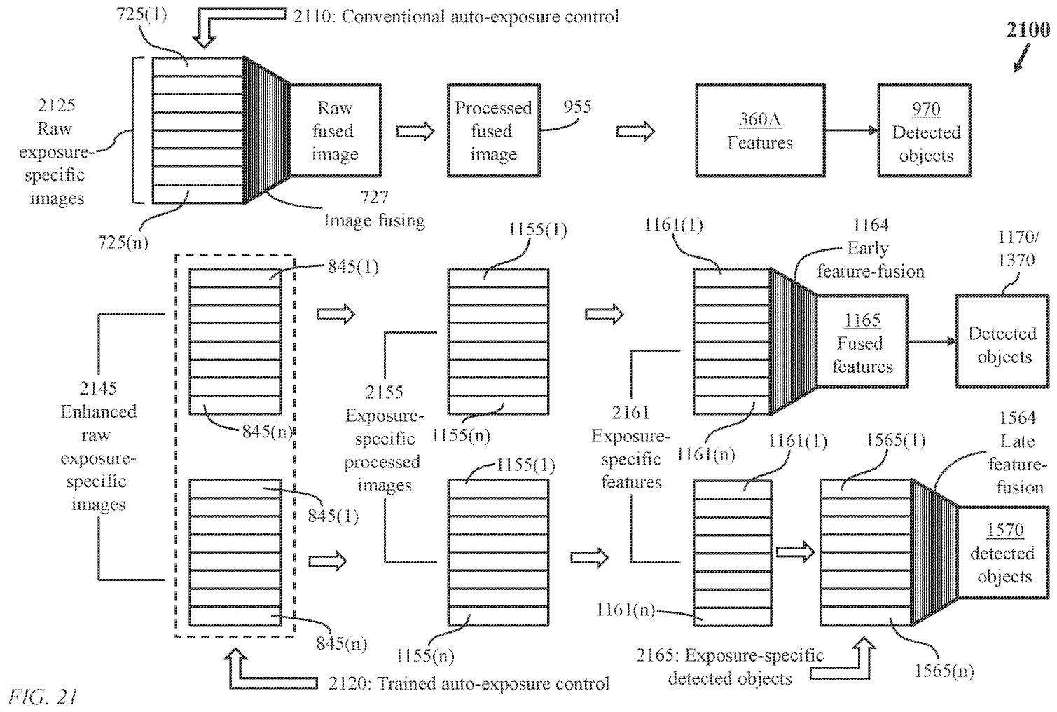

FIG. 21 highlights some aspects 2100 distinguishing the present disclosure from the prior art.

Firstly, in the sensor-processing phase, each of configuration-B, configuration-C, and configuration-D comprises a trained auto-exposure control module 840 while the sensor-processing phase of prior-art configuration-A comprises an independent auto-exposure controller 720. Additionally, auto-exposure controller 840 uses multi-exposure, multi-scale luminance histograms 3200 which are determined for each raw exposure-specific image 845(j), 0≤j<n, for each zone of a set of predefined zones. Configuration-A generates a set 2125 of n raw exposure-specific images, 725(1) to 725(n), produced according to conventional exposure control. Each of configuration-B, configuration-C, and configuration-D generates a set 2145 of enhanced raw exposure-specific images, 845(1) to 845(n), produced according to learned exposure control (module 840). Prior-art configuration-A implements exposure-specific image fusing (module 727) to produce a raw fused image 728.

Secondly, in the image-processing phase, configuration-A processes raw fused image 728 to produce a processed fused image 955. Each of configuration-B, configuration-C, and configuration-D processes a set 2145 of enhanced raw exposure-specific images to produce a set 2155 of exposure-specific processed images (1155(1) to 1155(n), FIG. 11, FIG. 13, FIG. 15).

Thirdly, in the objection-detection phase, configuration-A implements conventional object detection from the processed fused image 955. Each of configuration-B, and configuration-C extracts exposure-specific features, from set 2155 of exposure-specific processed images, to produce a set 2161 of exposure-specific features (1161(1) to 1155(n), FIG. 11, FIG. 13, FIG. 15). Each of configuration-B and configuration-C implements exposure-specific feature fusing (module 1164) to produce fused features 1165 from which detected objects 1170/1370 are determined.

Configuration-D detects exposure-specific objects from set 2161 to produce a set 2165 of exposure-specific detected objects (1565(1) to 1565(n), FIG. 15) which are fused to produce detected objects 1570.

For configuration B and C, feature fusion is done by element-wise maximum across the n feature maps corresponding to n exposures, i.e., each element of the output tensor is the maximum of the set of the corresponding elements in the n tensors representing the n feature maps. SDR images are not fused. Only the feature maps (configuration B and C) or the set of detected objects (configuration D) are fused together.

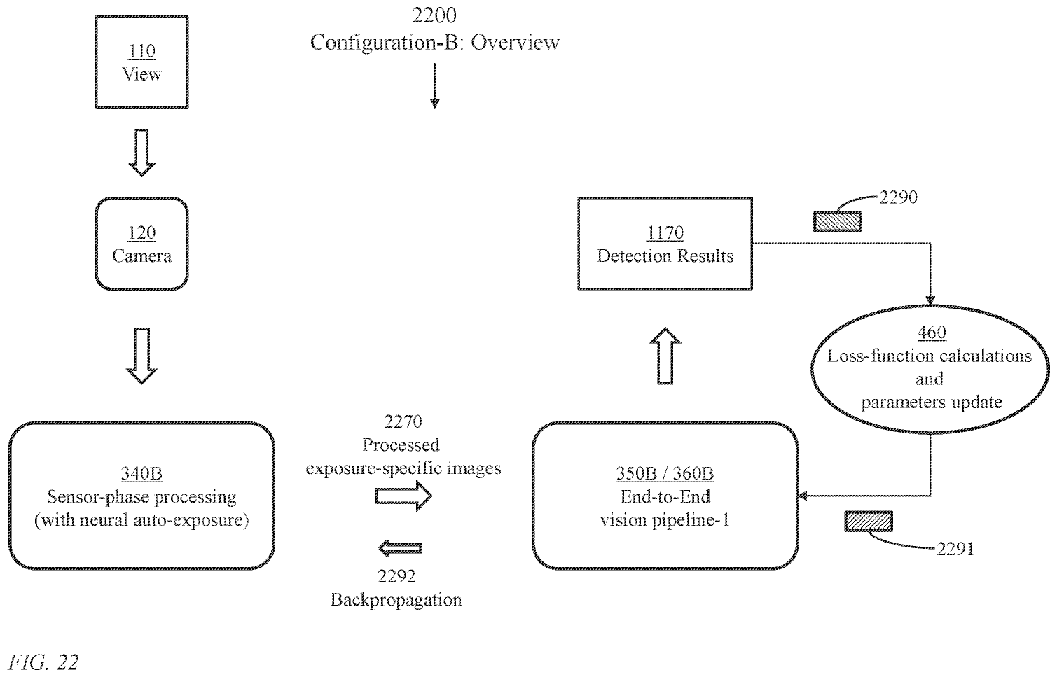

FIG. 22 is an overview 2200 of Configuration-B illustrating backpropagation of control data from module 460 based on information 2290 extracted from detected objects 1170. The backpropagated data comprises backpropagated data 2291 to object-detection phase 360B and image-processing phase 350B and backpropagated data 2192 to sensor-processing phase 340B

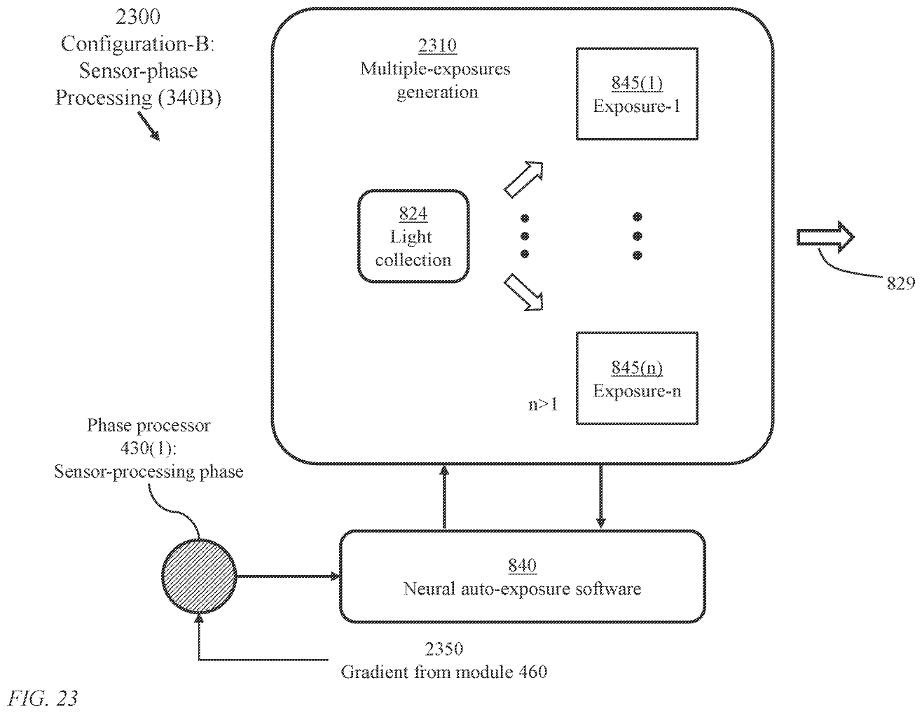

FIG. 23 is a detailed view 2300 of the sensor-processing phase 340B of configuration-B illustrating control of derivation of multiple exposure-specific images. Phase-processor 430(1) is coupled to neural auto-exposure module 840 which controls module 2310. Module 2310 derives the number n of SDR exposures {845(1), . . . , 845(n)} of scene 110.

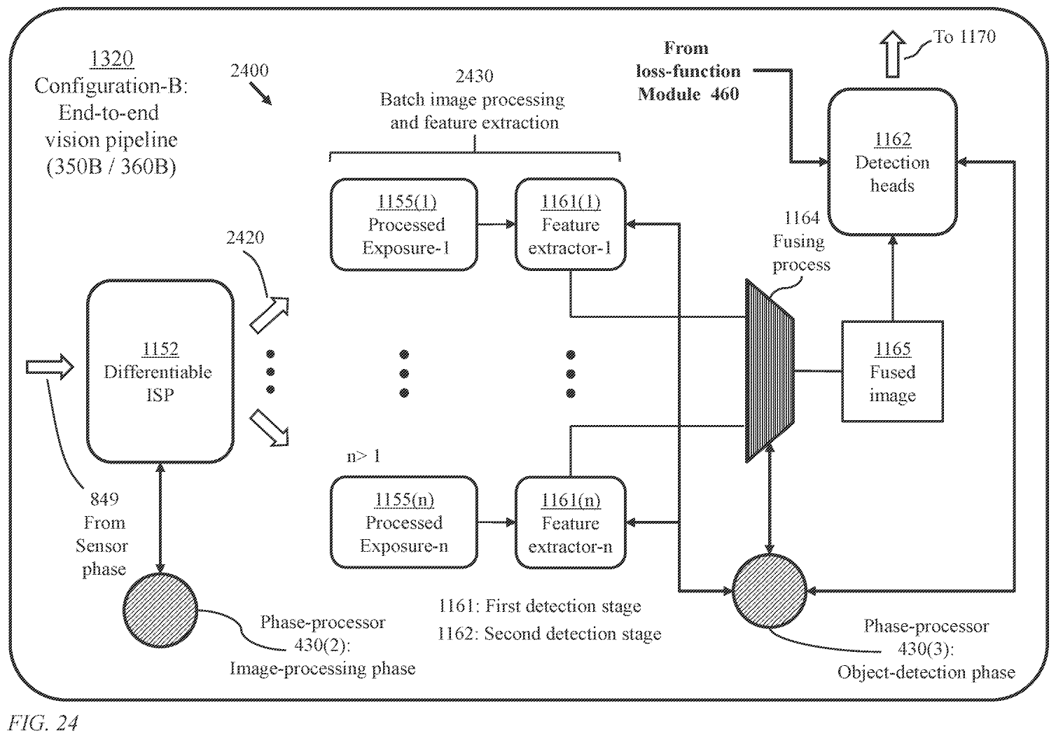

FIG. 24 is a detailed view 2400 of the image-processing phase 350B and the object-detection phase 360B of configuration-B. The two-stage object-detection phase 360B comprises exposure-specific feature extractors, collectively referenced as module 1161, which constitute the first stage, and the “detection heads” module 1162 of the second stage which identifies objects from pooled features, referenced as 1165. The detection-heads module receives loss-function derivatives from control module 460 which is coupled to master processor 450.

Phase-processor 430(2) is communicatively coupled to differentiable ISP 1152 (FIG. 11). Phase-processor 430(3) is communicatively coupled to: module 1161 comprising feature extractors {1161(1), . . . , 1161(n)}, feature-fusing module 1164, and detection-heads module 1162.

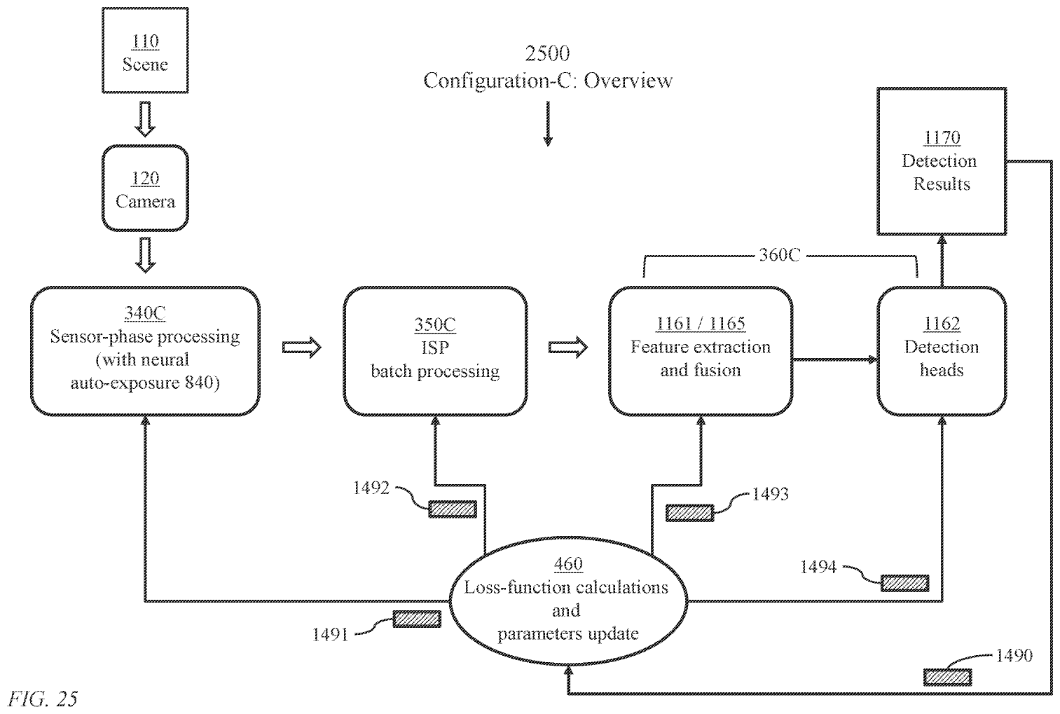

FIG. 25 is an overview 2500 of computer-vision configuration-C illustrating backpropagation from module 460. Detected-objects data 1370 is provided to module 460 for iteratively recomputing training parameters. Module 460 sends Control data 1491 to sensor-processing phase 340-C, control data 1492 to image-processing phase 350-C, control data 1493 to feature-extraction module 1161 which is the first stage of objection-detection phase 360-C, control data 1494 to object-detection module 1162, which is the second stage of objection-detection phase 360-C of configuration-C.

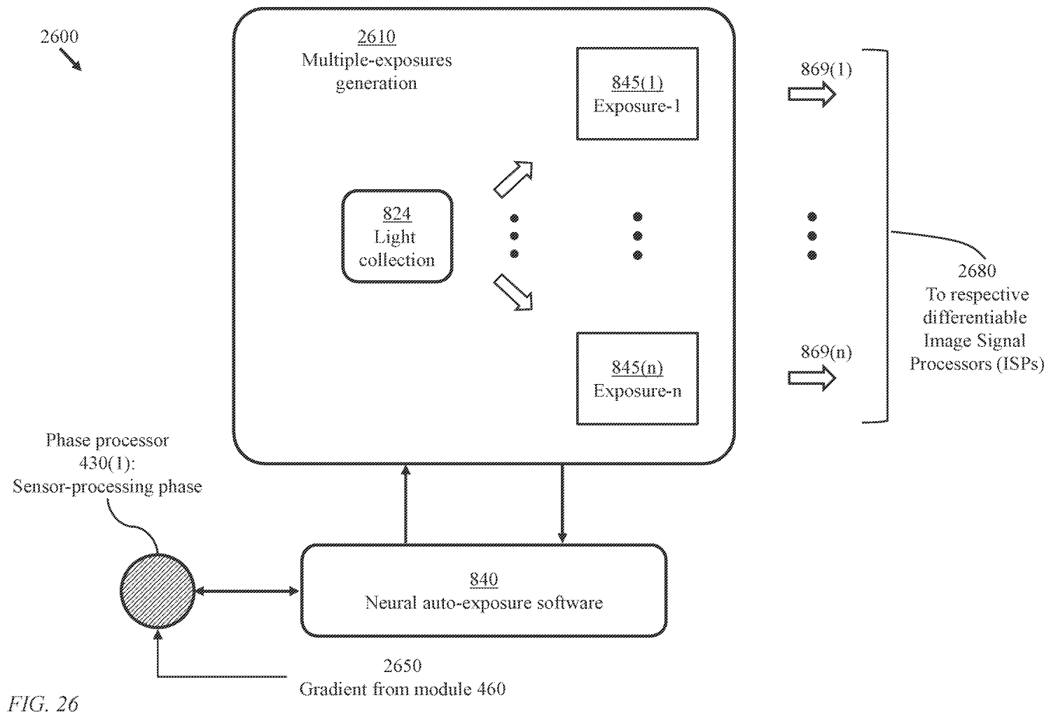

FIG. 26 is a detailed view 2600 of the sensor-processing phase 340C of configuration-C. Phase-processor 430(1) is coupled to neural auto-exposure module 840. Phase-processor 430(1) is coupled to neural auto-exposure module 840 which controls module 2610. Module 2610 derives the n SDR raw exposure-specific images {845(1), . . . , 845(n)} of scene 110.

Multiple processed exposure-specific signals {845(1), . . . , 845(n)} are sent, along paths {869(1), . . . , 869(n)}, to multiple differentiable ISPs {1352(1), . . . , 1352(n)} of the image-processing phase 350C.

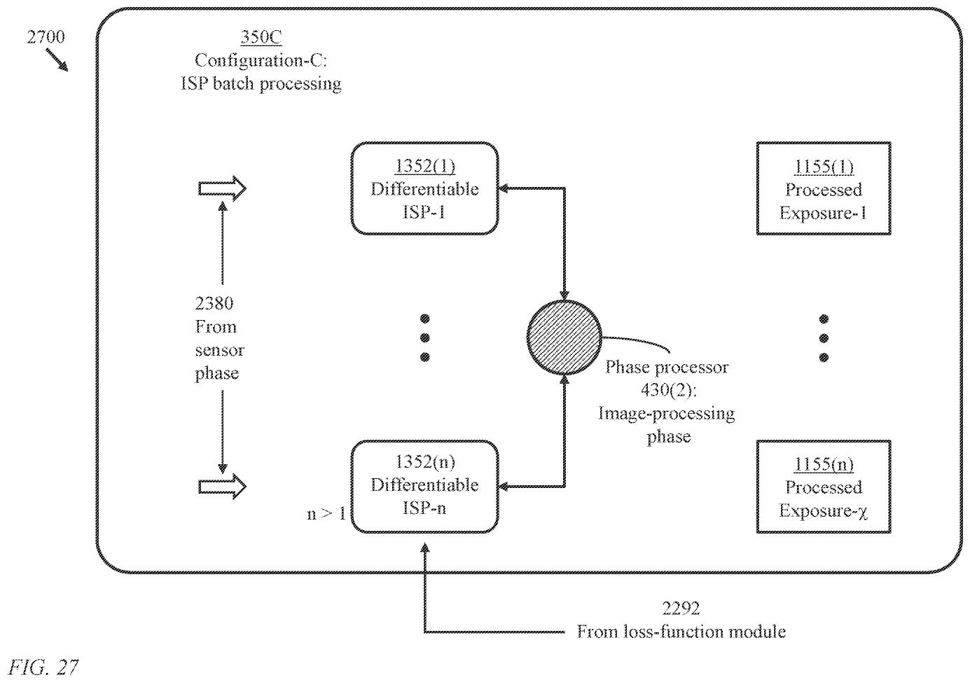

FIG. 27 is a detailed view 2700 of the image-processing phase 350C of configuration-C. Phase-processor 430(2) is communicatively coupled to a bank of exposure-specific differentiable ISPs {1352(1), . . . , 1352(n)} (FIG. 13). Derivatives 1492 of the loss function are supplied to the bank of differentiable ISPs through phase-processor 430(2) or through any other control path.

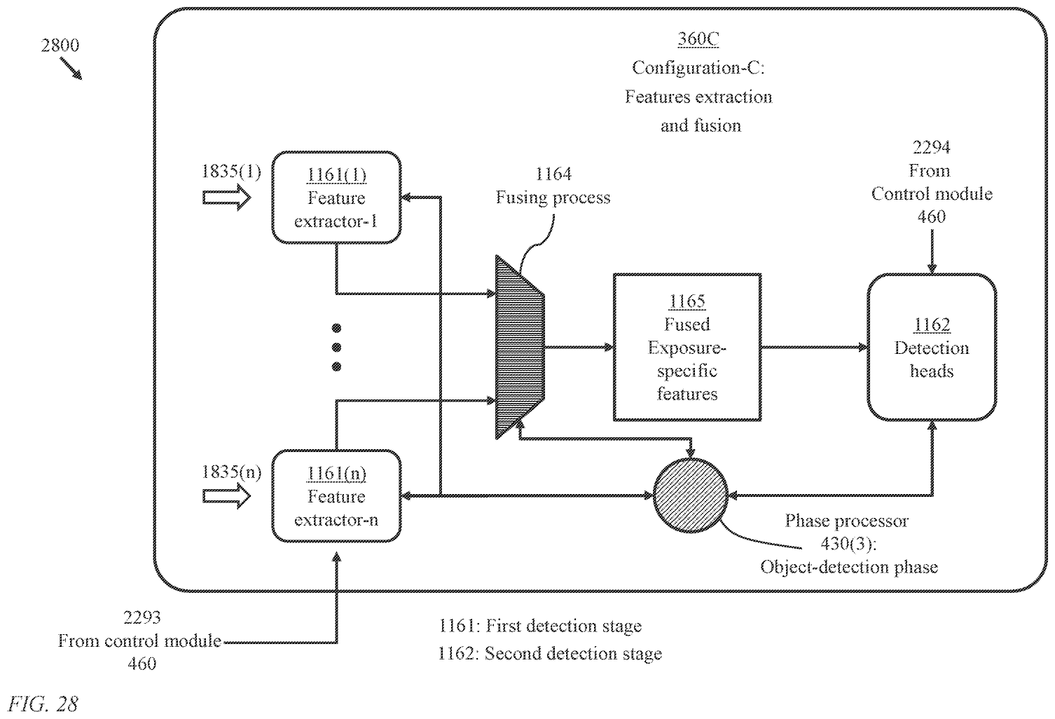

FIG. 28 is a detailed view 2800 of the object-detection phase 360C of configuration-C indicating control aspects. Phase-processor 430(3) is coupled to: module 1161, which is a bank of exposure-specific feature extractors {1161(1) . . . 1161(n)} of the first-detection stage; feature-fusing module 1164; and the second stage, detection-heads module 1162, of the two-stage detection phase 360D.

Derivatives 1493 of the loss function are supplied to the bank of feature-extraction modules through phase-processor 430(3) or through any other control path.

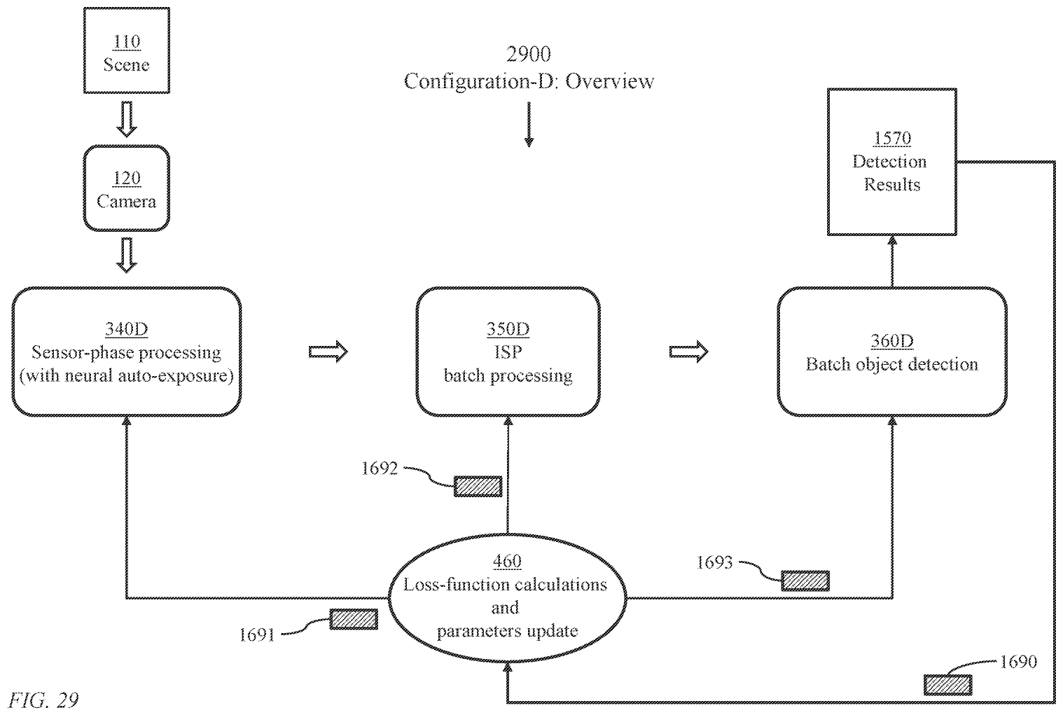

FIG. 29 is an overview 2900 of computer-vision configuration-D indicating connections to control module 460. Detected-objects data 1570 is provided to module 460 for iteratively recomputing training parameters of configuration-D. Module 460 sends:
control data 1691 to neural auto-exposure module 840 (FIG. 8) of sensor-processing phase 340-D;
control data 1692 to feature-extraction modules {1352(1) . . . 1352(n)) of image-processing phase 350-D; and
control data 1693 to objection-detection phase 360-D.

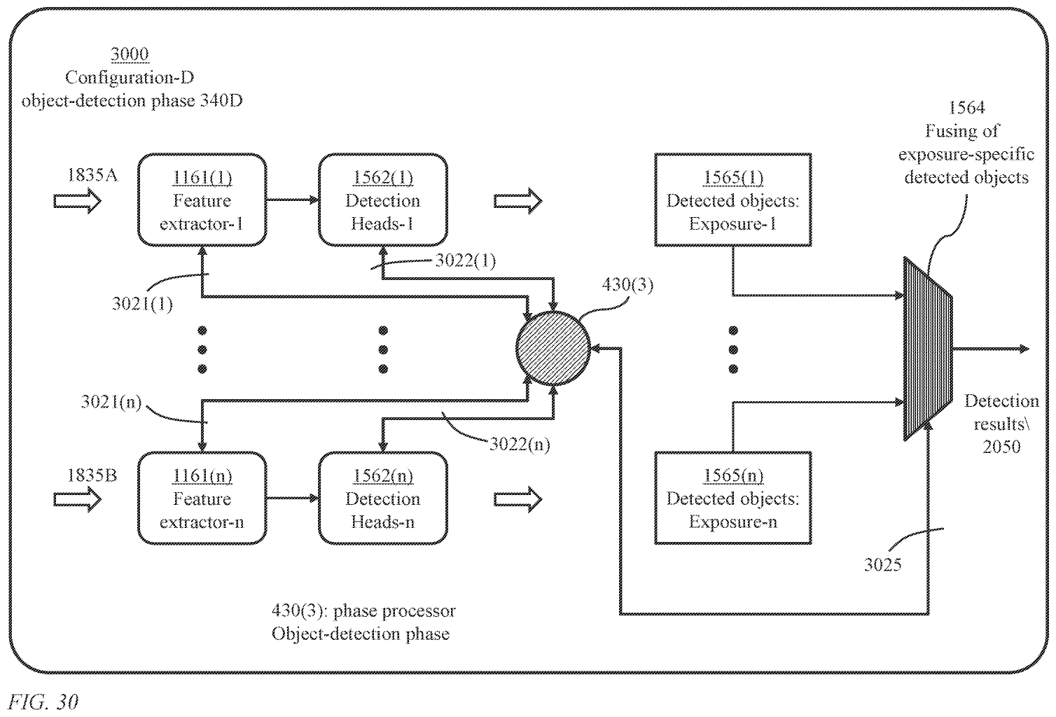

FIG. 30 is a detailed view 3000 of the object-detection phase 360D of configuration-D. Phase-processor 430(3) is coupled to: module 1161, comprising feature extractors {1161(1) . . . 1161(n)}, of the first-detection stage; second detection-stage {1562(1) . . . 1562(n)}; and object-fusing module 1564 of the two-stage detection phase 360D.

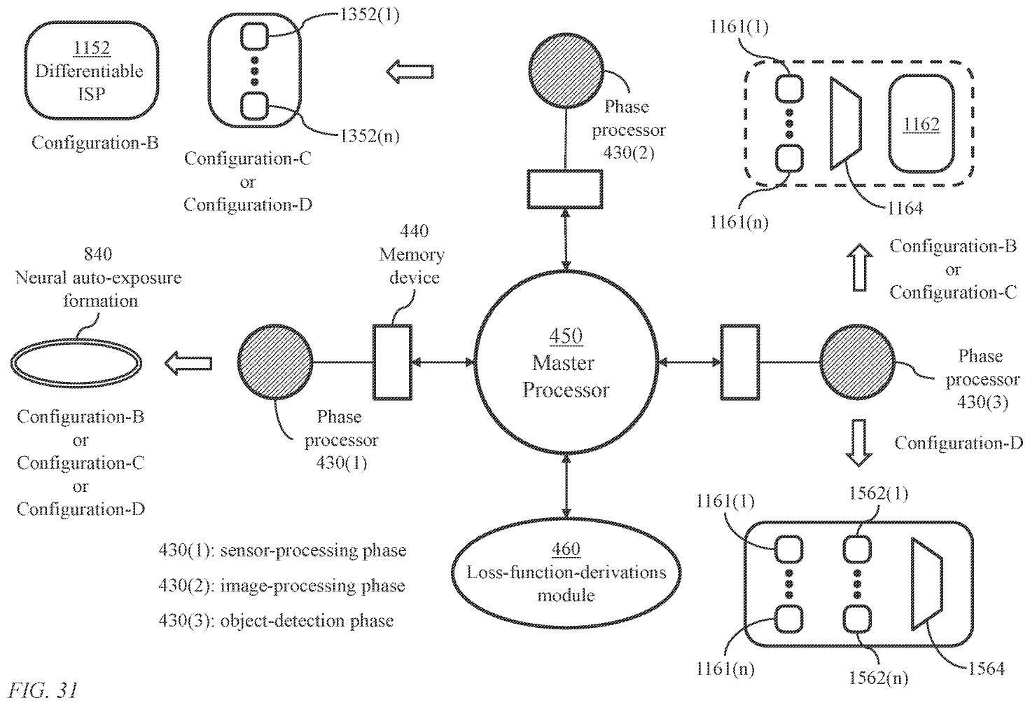

FIG. 31 illustrates connectivity of phase processors to modules of the sensor-processing phase 340, the image-processing phase 350, and the object-detection phase 360 for each of configuration-B, configuration-C, and configuration-D. The computer-vision system described above, with reference to FIG. 5 to FIG. 30, is organized into three processing phases, each processing phase having a respective phase processor 430 (individual phase processor are denoted 430(1), 430(2), . . . . Each module is a set of software instructions stored in a respective memory device causing a respective phase processor 430 to perform respective functions.

The phase processors, 430(1), 430(2), and 430(3), exchange data with master processor 450 through memory devices, collectively referenced as 440. The phase processors may inter-communicate through the master processor 450 and/or through a pipelining arrangement (not illustrated). A phase processor may comprise multiple processing units (not illustrated). Table-I, below, further clarifies the association of modules, illustrated in FIG. 11, FIG. 13, and FIG. 15, with phase processors 430.

TABLE-I
Computer-vision modules coupled to respective phase processors

| Phase | | | |
|---|---|---|---|
| Processor | Configuration | | |
| ↓ | B | C | D |
| 430(1) | Neural auto-exposure formation module 840 (FIG. 23, FIG. 26) | | |
| 430(2) | Differentiable | n differentiable ISP units, {1352(1), . . . , | |
| | ISP 1152 | 1352(n)}, n > 1 (FIG. 27) | |
| | (FIG. 24) | | |

| | | |
|---|---|---|
| 430(3) | Feature extractors {1161(1) . . . | Feature extractors 1161(1) . . . 1161(n), |
| | 1161(n)}, | n detection modules {1562(1) . . . |
| | Features-fusing module 1164, and | 1562(n)}, n > 1 |
| | Detection-heads module 1162 | Objects-fusing module 1564 |
| | (FIG. 24, FIG. 28) | (FIG. 30) |

FIG. 32 illustrates an example 3200 of multi-exposure, multi-scale luminance histograms used in the neural auto-exposure formation module 840. Each histogram indicates counts of pixels in an image versus brightness values. The (logarithmic) brightness values are categorized into 256 bins. Luminance histograms are determined for each raw exposure-specific image 845(j), 0≤j<n, for each zone of a set of predefined zones.

Three scales are considered in the example of FIG. 32: a first scale treats an entire image as a single zone, a second scale divides an image into 9 non-overlapping rectangular zones (three rows and three columns of zones), and a third scale divides an image into 49 non-overlapping rectangular zones (seven rows and seven columns of zones), to a total of 59 zones per image, yielding 59 histograms. A set of 59 histograms is determined for each of the n exposure-specific images 845 (FIG. 8).

Sample luminance histograms 3210(1), 3210(2), 3210(6), 3210(10), 3210(11), 3210(35), and 3210(59) are illustrated for selected image zones of the first exposure-specific image 845(1). Likewise, sample luminance histograms 3280 are illustrated for selected zones of the last exposure-specific image 845(n). The total number of illumination histograms is 5×n, n being the number of exposure-specific images.

It is noted that the luminance characteristics of each of the 59×n zones may be parameterized, using for example the mean value, standard deviation, mean absolute deviation (which is faster to compute than the standard deviation), the mode, etc.?

The histograms-formation (or corresponding illumination-quantifying parameters) can be optimized to avoid redundant computations or other data manipulations. For example, an image may be divided into a grid of 21×21=441 small images and a histogram for each of these small images is computed. These are then combined to get the histograms for a 7 by 7 grid and a 3 by 3 grid. Histograms of small images belonging to a patch of 3 by 3 contiguous small images are combined. A histogram of a 7 by 7 grid combines corresponding histograms of small images and histograms of 3 by 3 grids.

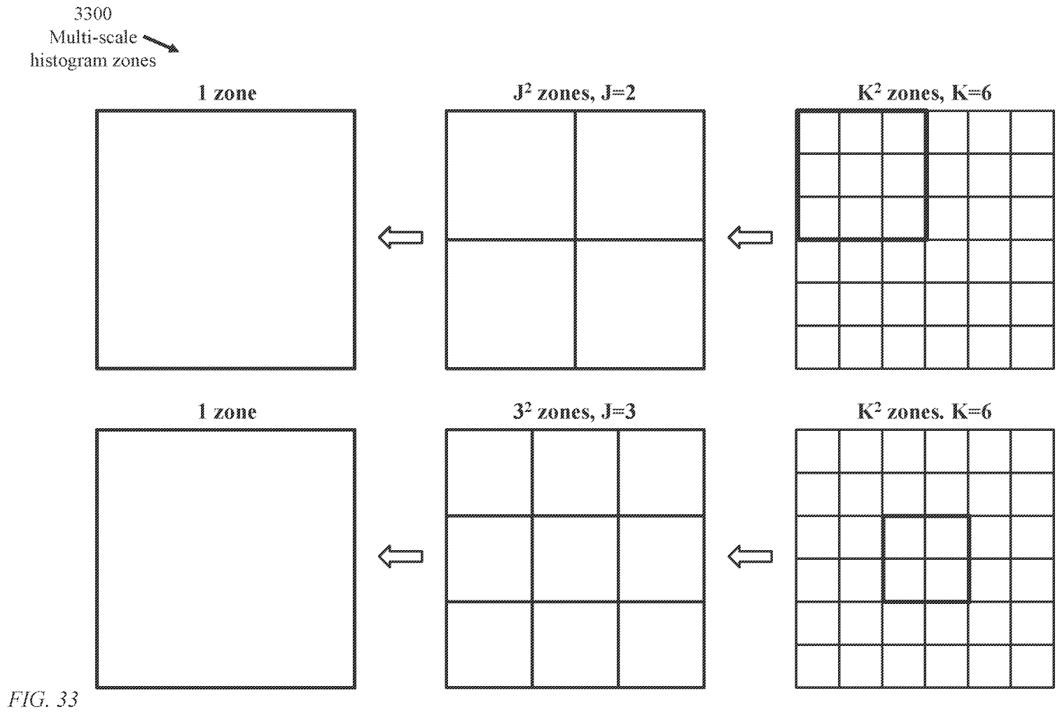

Using multiple scales where successive scales bear a rational relationship expedites establishing the histograms (or relevant parameters) for an (exposure-specific) raw image. For example, selecting three scales to define {1, J2, K2} zones where K is an integer multiple of J, expedites establishing (1+J2+K2) histograms (or relevant parameters) since data relevant to each second-scale zone is the collective data of respective (K/J)2 third-scale (finest scale) zones. Please see FIG. 33. In the case where K is a multiple of J it is possible to save a lot of computation. Even in the case where K is not a multiple of J, it is still possible to reduce computations by computing histograms of smaller grids as described in the example above.

FIG. 33 illustrates examples of selection of image zones for which illumination data are accumulate (presented as respective histograms or relevant illumination parameters). Three scales are selected to yield one zone (entire image), (K/J)2 zones, and K2 zones. In one example, J=2 and K=6 (top of the figure). In a second example, J=3 and K=6.

FIG. 34 illustrates feature-fusion schemes 3400. A first scheme (scheme-I, 3410), referenced as an “early-fusion scheme”, fuses exposure-specific features (module 1164, FIG. 11, FIG. 13) to produce pooled extracted features from which objects are detected. A second scheme (scheme-II, 3420), referenced as a “late-fusion scheme”, fuses exposure-specific detected objects 1565 (FIG. 15, module 1562, module 1564) to produce the object-detection results. Two versions of late fusion are considered. The first, 3421, labeled “late-fusion-I”, implements a strategy (Strategy-I) based on the principle of “keep best loss”, The second, 3422, labeled “Late-fusion-II”, implements a strategy (strategy-II) based on the principle of “non-maximal suppression”.

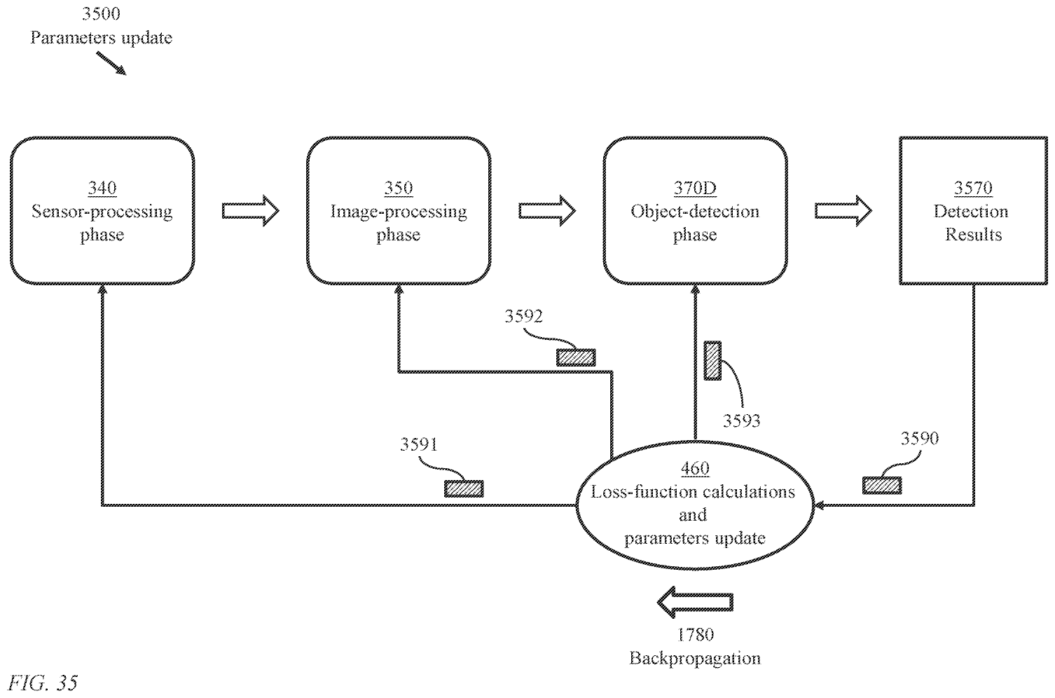

FIG. 35 illustrates feedback and backpropagation 3500 of control data from module 460 which determines updated training parameters based on loss-function derivations, within computer-vision configuration-B, configuration-C, and configuration-D. Module 460 uses information 3590 from detected objects 1170/1370/1570 (FIG. 11, FIG. 13, and FIG. 15) for recomputing training parameters.

Changes made to backpropagated control data at each downstream processing entity include parameter updates according to the gradient descent optimization method. Each of the sensor processing phase, the image processing phase and the object detection phase has training parameters. For the sensor processing phase those are actually the training parameters of the neural auto-exposure. The gradient of the loss is computed with respect to these training parameters. It can be computed using back-propagation of the gradient which is the most widespread automatic differentiation method used in neural network training Note that other alternative automatic differentiation methods could be used.

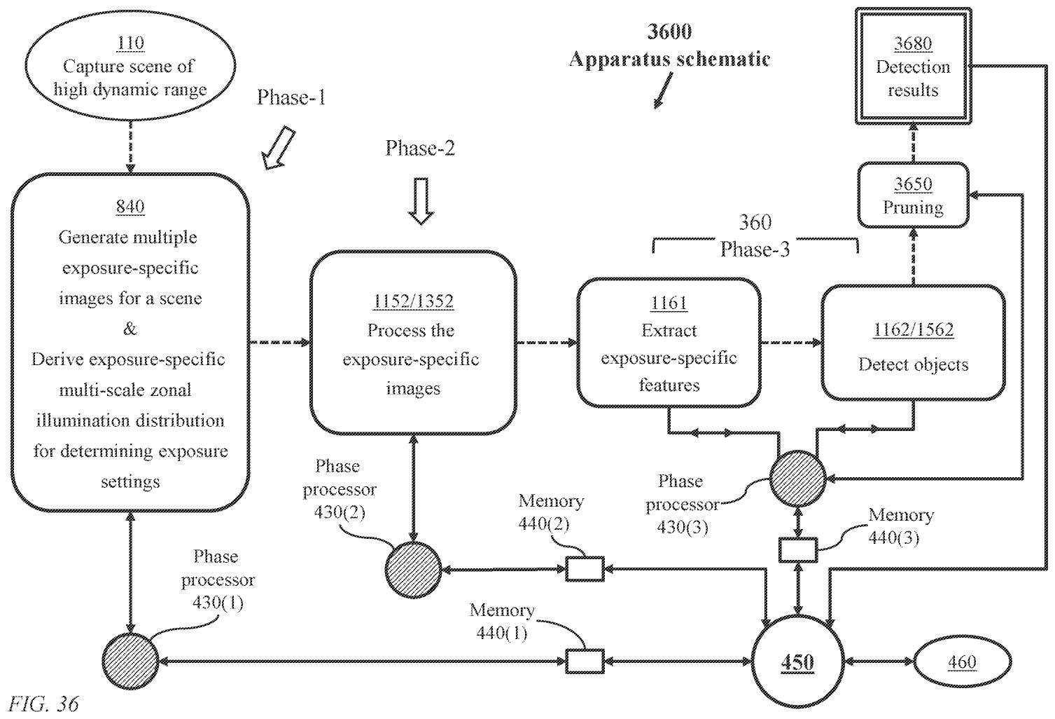

FIG. 36 is a schematic 3600 of the core computer-vision apparatus of the present disclosure using the control mechanism of FIG. 31. Specifically, hardware phase processors 430(1), 430(2), and 430(3) are coupled to a hardware master controller 450 and to modules: 840 of the sensor-processing phase 340; 1152 of the image-processing phase 350; and 1161, 1162, and 1562 of the object-detection phase 360.

Memory devices 440(1), 440(2), and 440(3) serve as transit buffer for holding intermediate data.

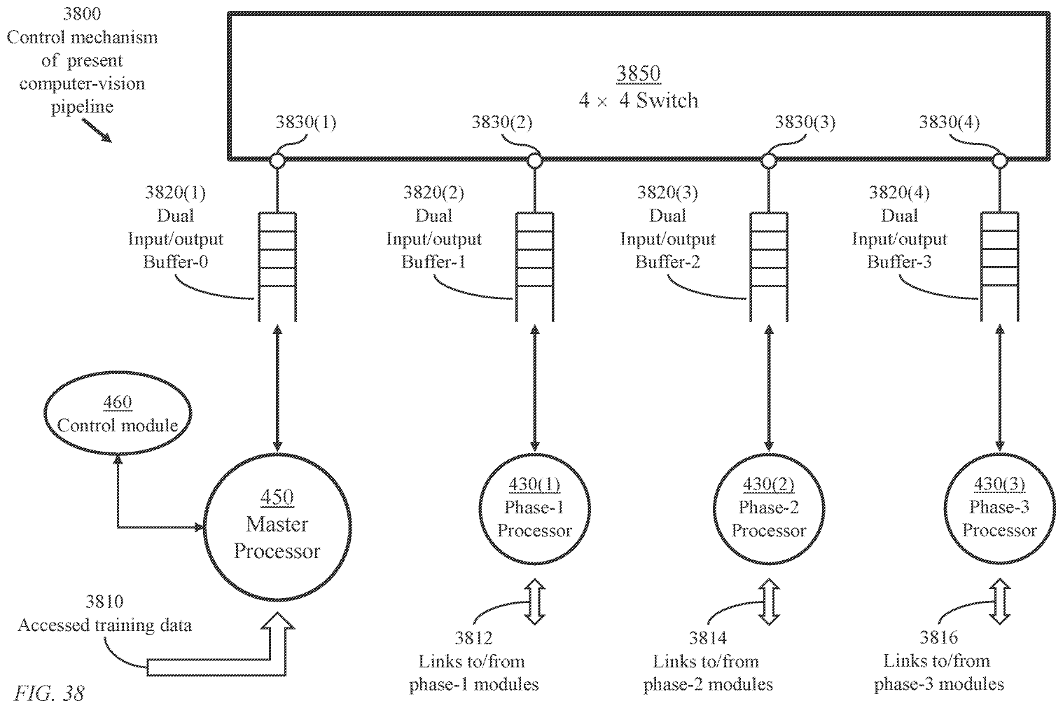

Control module 460, and operational modules 840, 1152, 1161, 1162, 1562, 3650, and 3680 are software instructions stored in respective memory devices (not illustrated) which are coupled to respective hardware processors as indicated in the figure. The dashed lines between modules indicate the order of processing. Modules communicate through the illustrated hardware processors. It is emphasized that although a star network of a master processor and phase processors is illustrated, several alternate arrangements, such as the arrangement of FIG. 38, may be implemented.

In operation, a camera captures multiple images of different illumination bands of a scene 110 under control of a neural auto-exposure control module 840, of the sensor-processing phase 340, to generate a number, n, n>1, of exposure-specific images. With a time-varying scene, consecutive images of a same exposure-setting constitute a distinct image stream. Module 840 generates multi-exposure, multi-scale luminance histograms (FIG. 32) for use in defining the exposure-specific images.

Both module 1152 (FIG. 11) and module 1352 (FIG. 13, FIG. 15) of the image-processing phase 350 enhance the raw exposure-specific images to produce processed exposure-specific images suitable for feature extraction. Module 1161 (FIGS. 11, 13, 15) extracts from the processed exposure-specific images respective sets of exposure-specific features collectively constituting a superset of features.

In both configuration B and configuration-C, the exposure-specific features of the superset of features are fused and module 1162 (FIG. 11, FIG. 13) identifies a set of overall candidate objects from the fused features. In configuration-D, module 1565 identifies exposure-specific candidate objects then module 1564 fuses the exposure-specific candidate objects to produce a set of overall candidate objects.

Control module 460 is configured to cause master processor 450 to derive updated device parameters, based on overall pruned objects 3680, for dissemination to respective modules through the phase processors.

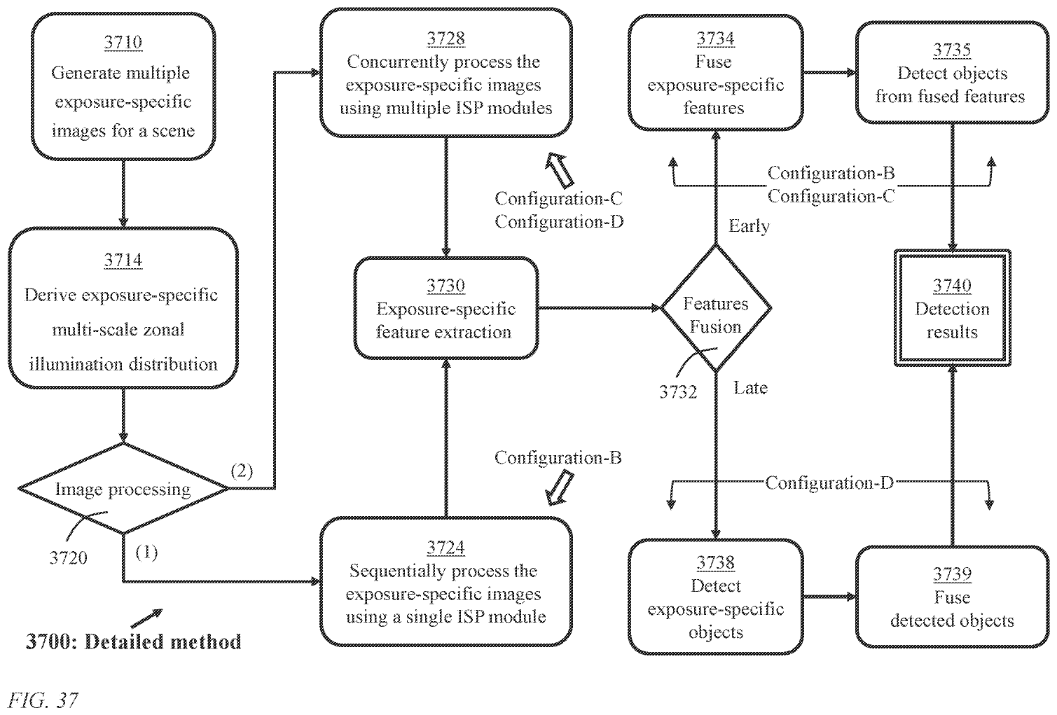

FIG. 37 is a flow chart 3700 of the present method of object detection in images of scenes of diverse illumination conditions. Processes 3710 and 3714 belong to the sensor-processing phase of each of configuration-B, configuration-C, and configuration-D. Process 3724 belongs to the image-processing phase 350B of configuration-B. Process 3728 belongs to the image-processing phases 350C and 350D of configuration-C and configuration-D, respectively. Process 3730 belongs to the object-detection phases 360B, 360C, and 360D, of configurations B to D, respectively. Processes 3734 and 3735 belong to object-detection phases 360B and 360C of configurations B and C, respectively. Processes 3738 and 3739 belong to object-detection phase 360D of configuration D.

Process 3710 generates multiple exposure-specific images, 845(1) to 845(n), for a scene (implemented in the sensor-processing phase, neural auto-exposure control module 840, FIG. 8, FIG. 12, FIG. 14, FIG. 16). Process 3714 derives exposure-specific multi-scale zonal illumination distribution (FIG. 32, implemented in the sensor-processing phase, neural auto-exposure control module 840).

Step 3720 branches to configuration-B (option (1)) or to either of configuration-C or configuration-D (option (2)).

Process 3724 sequentially processes the multiple exposure-specific images using a single ISP module (1152, FIG. 11, FIG. 12). Process 3728 concurrently processes the multiple exposure-specific images using multiple ISP modules (1352, FIG. 13, FIG. 14, FIG. 15, FIG. 16).

Process 3730 extracts exposure-specific features (module 1161, FIG. 11 to FIG. 16).

Process 3734 fuses exposure-specific features (module 1164, FIG. 11 to FIG. 14).

Process 3735 detects objects from fused features (module 1162, FIG. 11 to FIG. 14).

Process 3738 detects exposure-specific objects 1565 (module 1562, FIG. 15, FIG. 16),

Process 3739 fuses exposure-specific detected objects (module 1564, FIG. 15, FIG. 16).

To select configuration-B, option-1 is selected in step 3720 and the option of “early fusion” is selected in step 3732.

To select configuration-C, option-2 is selected in step 3720 and the option of “early fusion” is selected in step 3732.

To select configuration-D, option-2 is selected in step 3720 and the option of “late fusion” is selected in step 3732.

The processes executed in configuration-B are 3710, 3714, 3724, 3730, 3734, and 3735.

The processes executed in configuration-C are 3710, 3714, 3728, 3730, 3734, and 3735.

The processes executed in configuration-D are 3710, 3714, 3728, 3730, 3738, and 3739.

Detection results 3740 are those of a selected configuration.

FIG. 38 illustrates an arrangement 3800 of a control mechanism of the core computer-vision apparatus of the present disclosure. The master processor 450, and phase processors 430(1), 430(2), and 430(3) communicate through a conventional switch 3840. The ports 3830 of the switch (individually referenced as 3830(1) to 3830(4)) are equipped with respective dual buffers 3820 (individually referenced as 3820(1) to 3820(4)). The master processor 450 acquires data, such as training data, from external sources, through a link 3810. Phase-1 processor 430(1) accesses modules of the phase-processing phase 340 through dual links 3812. Likewise, phase-2 processor 430(2) accesses modules of the image-processing phase 350 through dual links 3814 and phase-3 processor 430(3) accesses modules of the objection-detection phase 360 through dual links 3816.

### Pipeline Flow Control

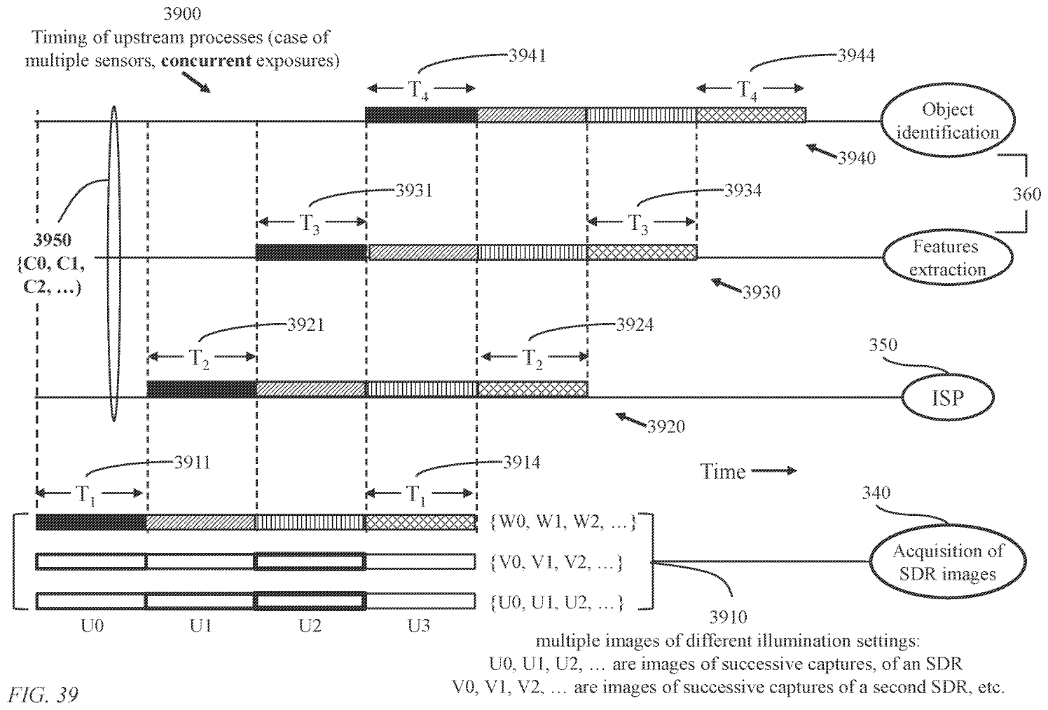

FIG. 39 is a timing representation 3900 of upstream processes of a computer-vision apparatus employing multiple sensors for concurrent acquisition of multiple images of a scene, captured under constraints of specified illumination ranges.

Three concurrent streams of raw images 3910 are captured under different illumination settings during successive exposure time intervals. Images captured under a first illumination setting are denoted Uj, images captured under a second illumination setting are denoted Vj, and images captured under a third illumination setting are denoted Wj, j≥0, j being an integer. For each of the three illumination settings, an image is captured during an exposure interval of duration T1 seconds; a first exposure interval is referenced as 3911, a fourth exposure interval is referenced as 3914. The illustrated processing time windows 3950 correspond to successive images, {W0, W1, W2, . . . }, corresponding to the third illumination setting.

In the image-processing phase 350 (FIG. 3), raw images are processed to produce processed images during time windows 3920. During time window 3921, of duration T2, raw image W0 is processed. During time window 3924, of duration T2, raw image W3 is processed.

In the object-detection phase 360, first-stage (1161, FIG. 11, FIG. 13, and FIG. 15), features are extracted from the processed images during time windows 3930. During time window 3931, of duration T3, features are extracted from processed image W0. During time window 3934, of duration T3, features are extracted from processed image W3.

In the object-detection phase 360, second-stage (1162, FIG. 11, FIG. 13, or 1562, FIG. 15), objects are identified using the features extracted from processed images during time windows 3940. During time window 3941, of duration T4, objects are identified using the features extracted from processed image W0. During time window 3944, of duration T4, objects are identified using the features extracted from processed image W3.

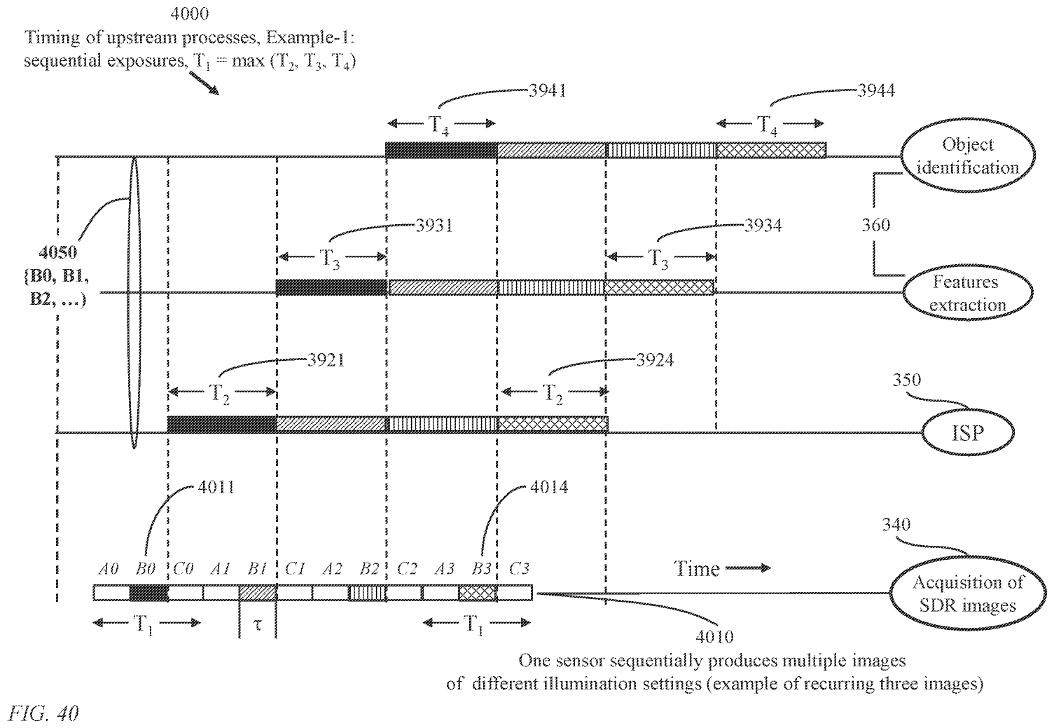

FIG. 40 is a timing representation 4000 of upstream processes of a first example of a computer-vision apparatus employing a single sensor for sequential acquisition of multiple images of a time-varying scene, for different illumination ranges.

Three time-multiplexed streams of raw images 4010 are captured under different illumination settings during successive exposure time intervals. Images captured under a first illumination setting are denoted Aj, images captured under a second illumination setting are denoted Bj, and images captured under a third illumination setting are denoted Cj, j≥0, j being an integer. The sum of the capture time intervals of Aj, Bj, and Cj is T1 for any value of j. For a specific image stream, such as stream {B0, B1, B2, . . . }, corresponding to the second illumination setting, an exposure interval, τ, is specified. Each of the exposure intervals 4011, of the first raw image, and 4014, of the fourth raw image equals τ. The processing time windows 4050 corresponding to successive images, {B0, B1, B2, . . . } are similar to processing time windows 3950 of FIG. 39.

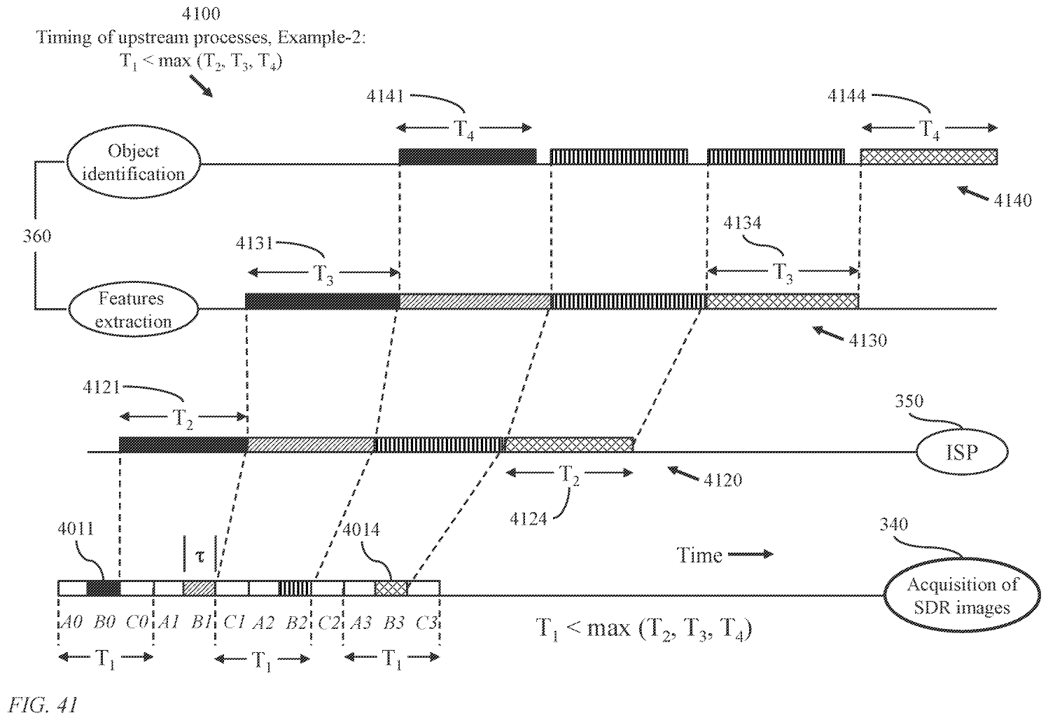

FIG. 41 is a timing representation 4100 of upstream processes of a second example of a computer-vision apparatus employing a single sensor for sequential acquisition of multiple images of a time-varying scene, for different illumination ranges. Unlike the apparatus of FIG. 40, the time window T1 of sequentially capturing three raw images, one image from each stream, is less than the largest processing time per image, within any processing phase, defined as {max (T2, T3, T4)}. Processing time windows corresponding to the second illumination setting only (raw images B0, B1, . . . ) are indicated in the figure.

Within the image-processing phase 350, raw images {B0, B1, B2, B3, . . . } are processed during time windows 4120, each of duration T2, to produce respective processed (enhanced) images. Raw image B0 is processed during time interval 4121. Raw image B3 is processed during time interval 4124. In this example, T2>T1 thus necessitating that raw-image data be held in a buffer in sensor-processing phase 340 awaiting admission to the image-processing phase 350. However, this process can be done for only a small number of successive raw images and is not sustainable for a continuous stream of raw images recurring every T1 seconds.

Within the feature extraction stage (1161, FIG. 11, FIG. 13, and FIG. 15) of the object-detection phase 360, features are extracted from the processed images during time windows 4130, each of duration T3. Features corresponding to raw image B0 are extracted during time interval 4131. Features corresponding to raw image B3 are extracted during time interval 4134. In this example, T3>T2 thus necessitating that extracted features be held in a buffer awaiting admission to the second stage (the object identification stage) of the object-detection phase 360.

Within the object-identification stage (1162, FIG. 11, FIG. 13, or 1562, FIG. 15), candidate objects are identified during time windows 4140, each of duration T4. Candidate objects corresponding to raw image B0 are identified during time interval 4141. Candidate objects corresponding to raw image B3 are identified during time interval 4144. In this example, T4<T3 thus object identification immediately follows corresponding feature extraction.

Generally, if the requisite processing time interval in the image-processing phase, the feature-extraction stage, or the object-identification phase, corresponding to a single raw image, exceeds the sensor cyclic period T1, the end-to-end flow becomes unsustainable.

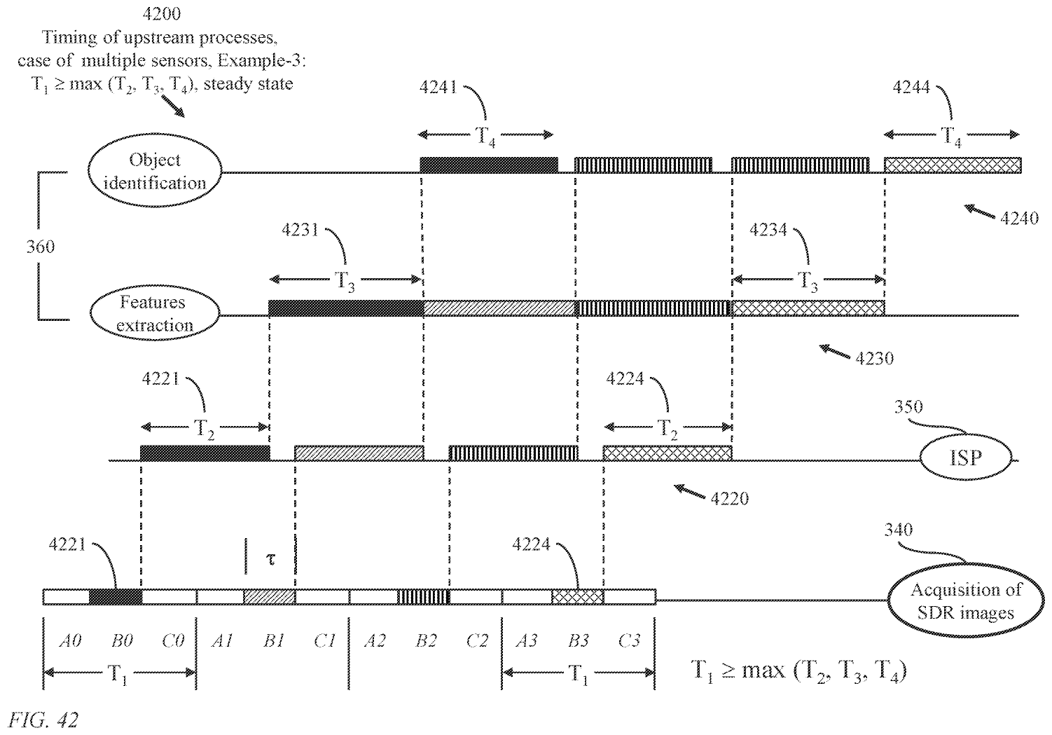

FIG. 42 is a timing representation 4200 of upstream processes of a third example of a computer-vision apparatus employing a single sensor for sequential acquisition of multiple images of a time-varying scene, for different illumination ranges.

Unlike the apparatus of FIG. 41, the sensor' cyclic period, i.e., the time window T1 of capturing n successive images, is adjusted to realize steady-state operation. T1 is set to at least equal the largest processing time per image; T1 □ max (T2, T3, T4)=T3. As indicated, the processing time windows corresponding to the second illumination setting (raw images B0, B1, . . . ) are aligned to enable contention-free operation. In general, T1 may be selected to equal or exceed the value of max (T2, T3, T4).

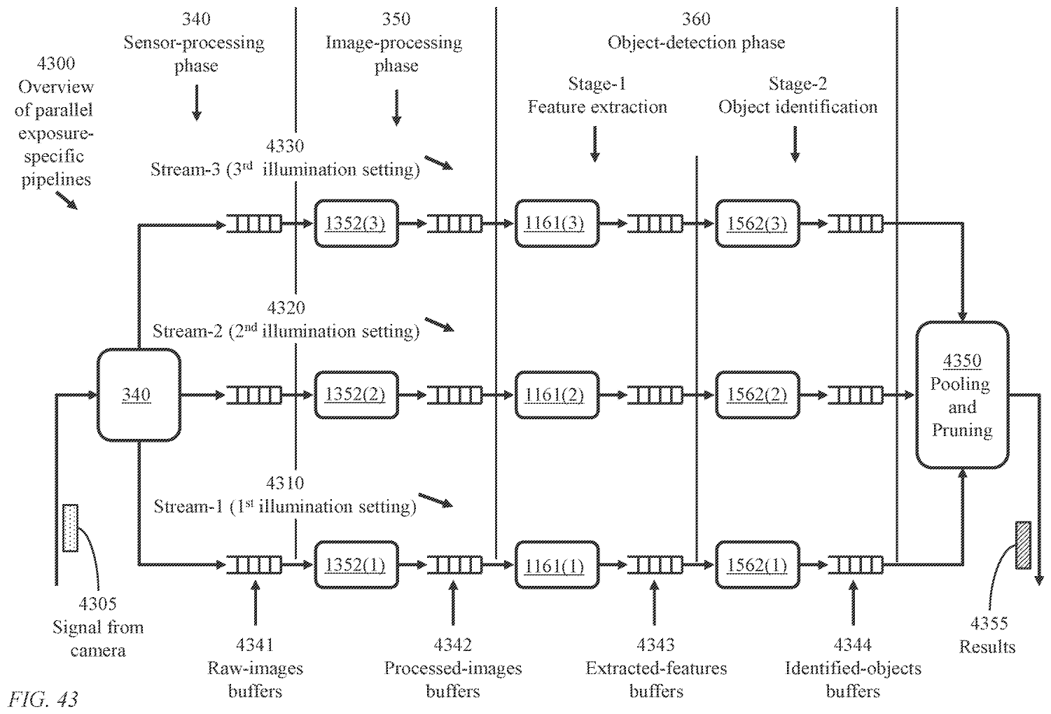

FIG. 43 illustrates a structure 4300 of a complete pipeline, i.e., a set of n parallel exposure-specific pipelines corresponding to n illumination settings, for a case of n=3. The illustration is specific to configuration-D (FIG. 15, FIG. 16) but can easily be adapted to configuration-B and configuration-C. Exposure-specific pipeline 4310 processes a first stream of images corresponding to a first illumination setting. Exposure-specific pipeline 4320 processes a second stream of images corresponding to a second illumination setting. Exposure-specific pipeline 4330 processes a third stream of images corresponding to a third illumination setting.

A phase processor 430(1) of sensor-processing phase 340 (FIG. 31) receives a signal 4305 representing a scene. Under control of neural auto-exposure control module 840 (FIG. 8) of the sensor-processing phase 340, n raw exposure-specific images {845(1), 845(2), and 845(3)} are generated and corresponding exposure-specific signals {869(1), 869(2), 869(3)} are placed in buffers 4341 preceding n differentiable ISPs 1352 of the image-processing phase 350. ISPs 1352 concurrently process the raw exposure-specific images 845(1) to 845(n), to produce corresponding enhanced images to be held in processed-images buffers 4342.

Exposure-specific feature extraction modules 1161 (first stage of the object detection phase 360) extract features corresponding to the n illumination settings and place corresponding data in extracted-features buffers 4343. Modules 1562 identify candidate objects based on the exposure-specific extracted features. Data relevant to the candidate objects are placed in identified-objects buffers 4344.

Module 4350 pools (fuses) and prunes the candidate objects to produce a set of selected detected objects. Data 4355 relevant to detected-objects is communicated for further actions.

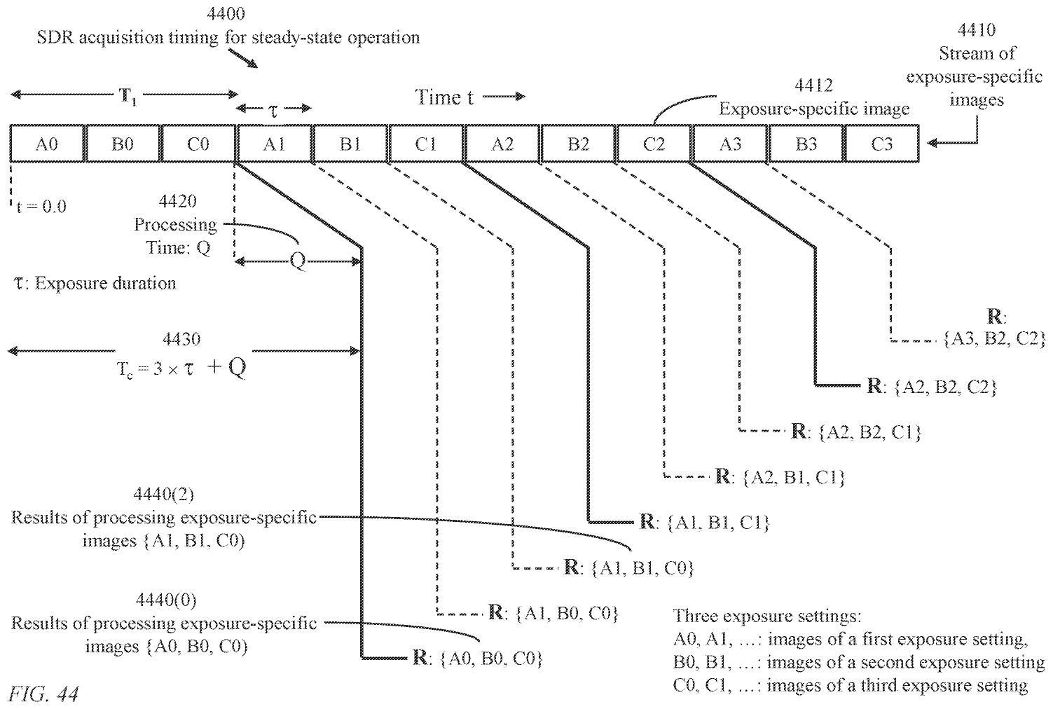

FIG. 44 illustrates an example 4400 of timing of detected objects of the parallel exposure-specific pipelines 4300 for n illumination ranges (n=3). A continuous stream 4410 of exposure-specific images produced in the sensor-processing phase comprises a recurring pattern of raw images {Aj, Bj, Cj}, j≥0, where raw image Aj is captured according to a first illumination range, raw image Bj is captured according to a second illumination range, and raw image Cj is captured according to a third illumination range. Each raw image of a same exposure setting is captured during a respective duration r (reference 4412). Extracted features from any n consecutive images, n=3, such as {A0, B0, C0}, {B0, C0, A1}, etc., may form a basis for detecting objects within a respective HDR time-varying scene to produce respective results 4440, denoted R:{A0, B0, C0}, R:{B0, C0, A1}, etc.

The completion period Tc (reference 4430) of detecting objects from a processed set of n consecutive images, may exceed the sensor's cyclic period T1 due to post-detection tasks. A time difference 4420, denoted Q, between completion period, Tc, and sensor's cyclic period, T1, Q>0.0, is the sum of pipeline delay and a time interval of executing post-detection tasks. It is emphasized that post-detection tasks follow the final pruning of detected objects and, therefore, are not subject to contention for computing resources.

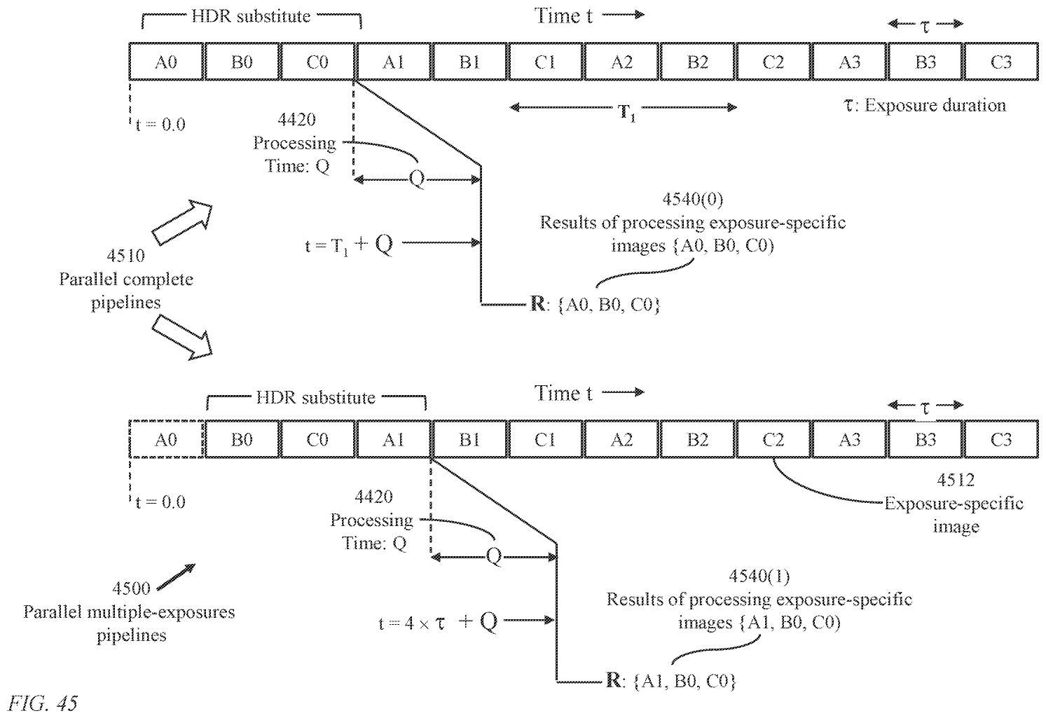

FIG. 45 illustrates a system 4500 of parallel complete pipelines 4300, each complete pipeline 4300 comprising a number n of exposure-specific pipelines illustrated in FIG. 43, to handle a case of a relatively high capturing rate, i.e., a relatively small sensor's cyclic period T1. Configuration 4510 employs two complete pipelines operating concurrently. Results 4540(1) and 4540(2) of the complete pipelines are based on intersecting sets of raw exposure-specific images {A0, B0, C0} and {A1, B0, C0}.

### Experimental Results

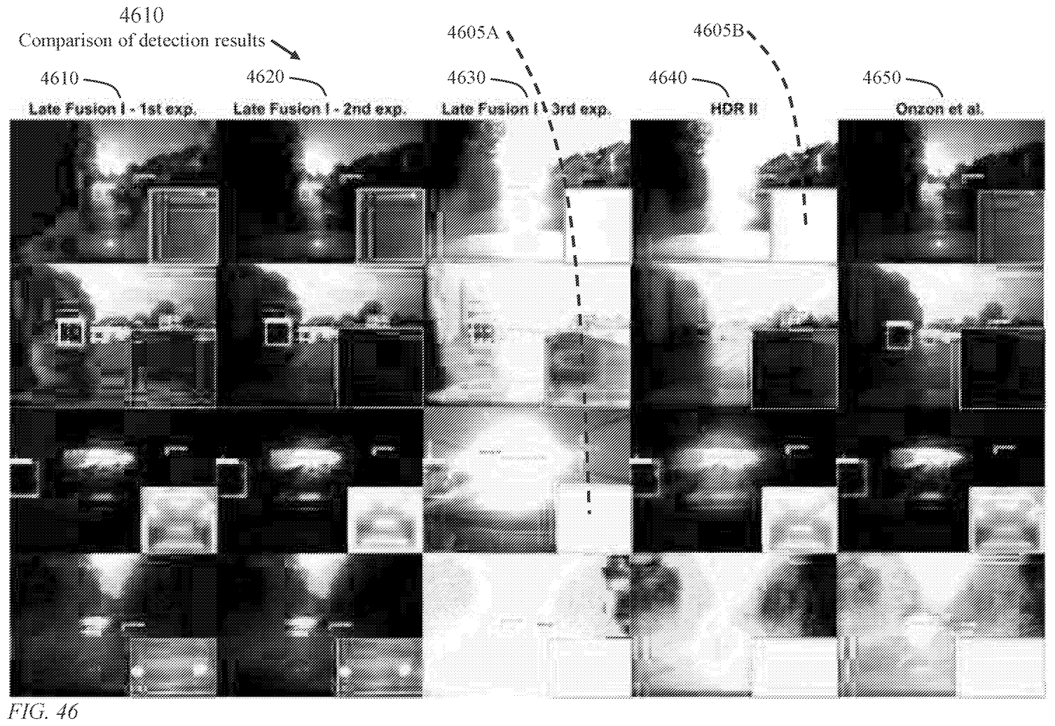

FIG. 46 illustrates sample detection results 4600, for selected scenes, comprising results 4610, 4620, 4630, of the present method with the Late-Fusion-strategy-II 3422 (FIG. 34, configuration-D, FIG. 15 and FIG. 16), results 4640 of the HDR-II pipeline, and results 4650 of the reference auto-exposure control (Onzon et al.), for challenging scenes. Insets, such as inset 4605A and 4605B, are highlighted with orange outline. The present method Late-Fusion-II can recover features from separate exposure streams, where the image region is well exposed to make a decision. In contrast, the reference methods miss details and local contrast in the observed areas, leading to false negatives.

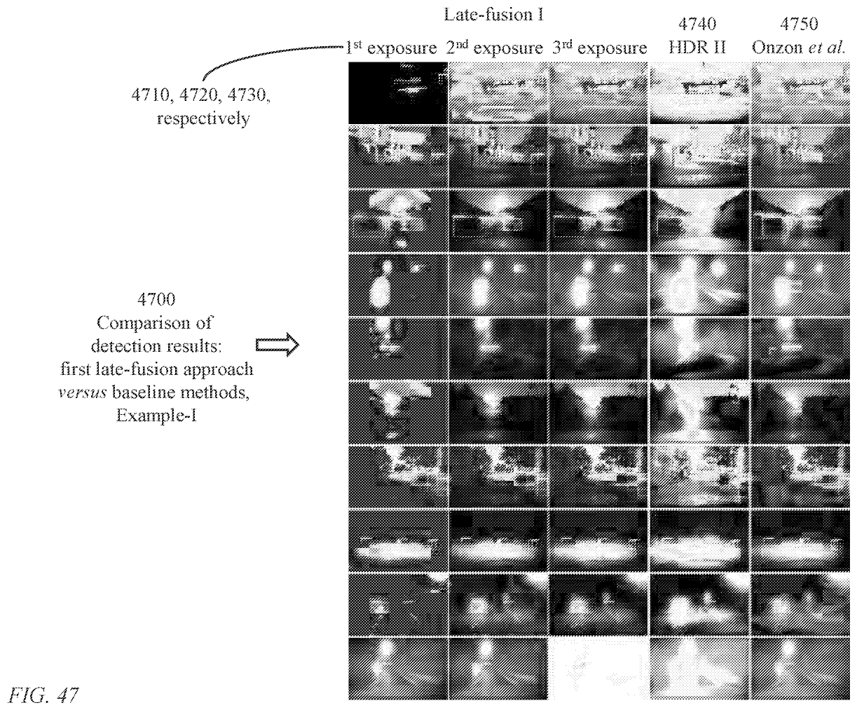

FIG. 47 illustrates sample detection results 4700, for selected scenes, comprising results 4710, 4720, 4730 of the present method with the Late-Fusion-strategy-I 3421 (FIG. 34, configuration-D, FIG. 15 and FIG. 16), results 4740 of the HDR-II pipeline, and results 4750 of the reference auto-exposure control (Onzon et al.), for challenging scenes. Insets are highlighted. The present Late-Fusion-I method can recover features from separate exposure streams, where the image region is well exposed to make a decision. In contrast, the reference methods miss details and local contrast in the observed areas, leading to false negatives.

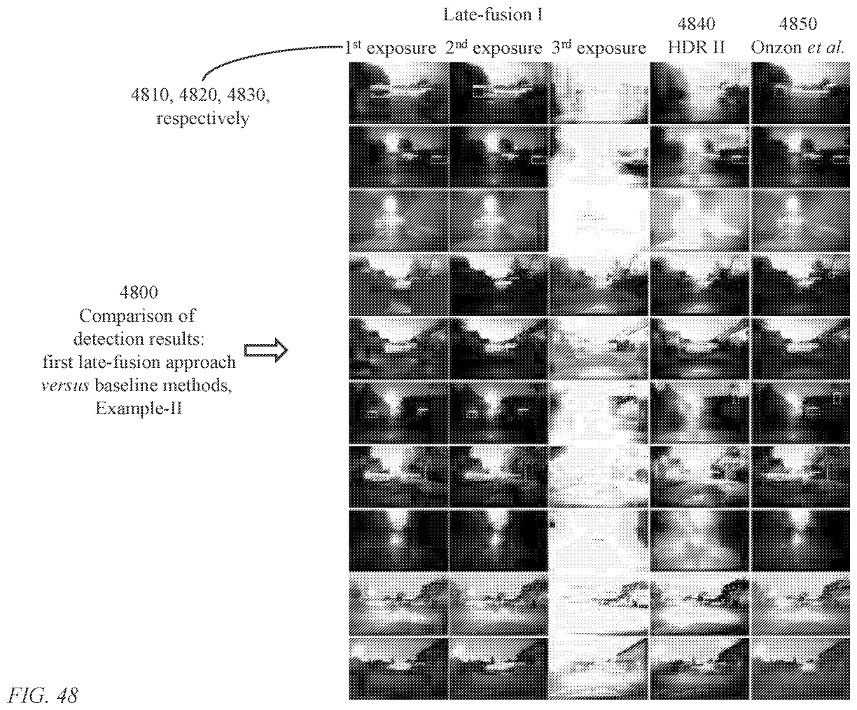

FIG. 48 illustrates additional sample detection results 4800, for selected scenes, comprising results 4810, 4820, 4830 of the present method with the Late-Fusion-strategy-I (3421 FIG. 34, configuration-D, FIG. 15 and FIG. 16), results 4840 of the HDR-II pipeline, and results 4850 of the reference auto-exposure control (Onzon et al.), for challenging scenes. Insets are highlighted. The present Late-Fusion-I method can recover features from separate exposure streams, where the image region is well exposed to make a decision. In contrast, the reference methods miss details and local contrast in the observed areas, leading to false negatives.

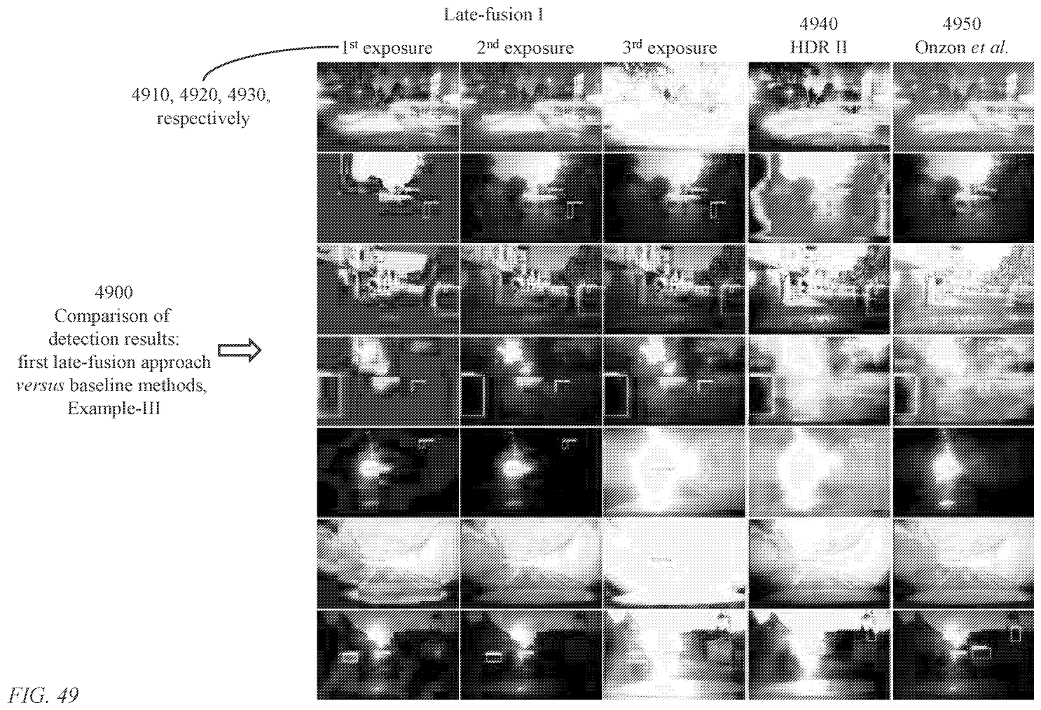

FIG. 49 illustrates further sample detection results 4900, for selected scenes, comprising results 4910, 4920, 4930 of the present method with the Late-Fusion-strategy-I 3421 (FIG. 34, configuration-D, FIG. 15 and FIG. 16), results 4940 of the HDR-II pipeline, and results 4950 of the reference auto-exposure control (Onzon et al.), for challenging scenes. Insets are highlighted. The present Late-Fusion-I method can recover features from separate exposure streams, where the image region is well exposed to make a decision. In contrast, the reference methods miss details and local contrast in the observed areas, leading to false negatives.

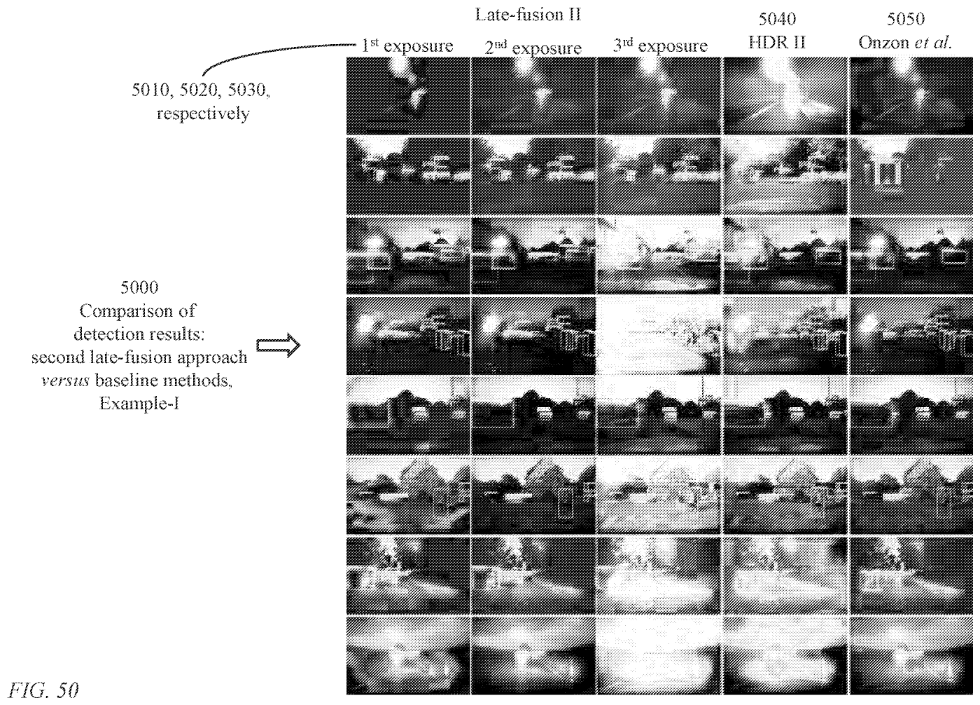

FIG. 50 illustrates further sample detection results 5000, for selected scenes, comprising results 5010, 5020, 5030 of the present method with the Late-Fusion-strategy-II (3422, FIG. 34, configuration-D, FIG. 15 and FIG. 16), results 5040 of the HDR-II pipeline, and results 5050 of the reference auto-exposure control (Onzon et al.), for challenging scenes. Insets are highlighted. The present method Late-Fusion-I can recover features from separate exposure streams, where the image region is well exposed to make a decision. In contrast, the reference methods miss details and local contrast in the observed areas, leading to false negatives.

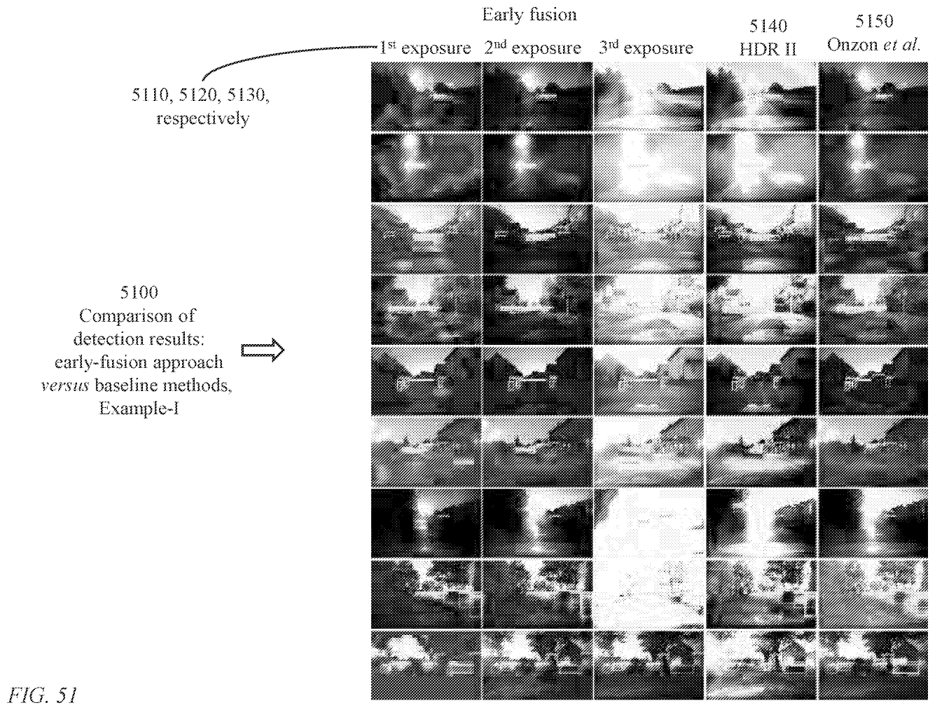

FIG. 51 illustrates further sample detection results 5100, for selected scenes, comprising results 5110, 5120, 5130 of the present method with the Early-Fusion scheme (3410, FIG. 34, configurations B, C, and D, FIG. 11, FIG. 13, and FIG. 15, respectively), results 5140 of the HDR-II pipeline, and results 5150 of the reference auto-exposure control (Onzon et al.), for challenging scenes. Insets are highlighted. The present Early-Fusion method can recover features from separate exposure streams, where the image region is well exposed to make a decision. In contrast, the method based on the fused HDR image misses details and local contrast in the observed areas, leading to false negatives.

Exhibits 1 to 8 detail processes discussed above.

### Exhibit-I: Generalized Neural Auto-Exposure Control

To select the exposures of the multiple captures acquired per HDR frame, the neural auto-exposure model of U.S. application Ser. No. 17/722,261 is generalized to apply to a multi-image input (multi-exposure-specific images). In U.S. Ser. No. 17/722,261, 59 histograms, each with 256 bins, indicating counts of pixels in an image versus brightness values, are generated. The histograms are computed at three different scales: the coarsest scale being the whole image which yields one histogram; at an intermediate scale the image is divided into 3×3 blocks yielding 9 histograms; and at the finest scale, the image is divided into 7×7 blocks yielding 49 histograms. The exposure prediction network takes as input a stack of 59 multi-scale histograms of the input image forming a tensor of shape [256, 59].

The neural auto-exposure derivation module 840 (FIGS. 8, 12, 14, 16) computes multi-scale histograms for each of the n input images. The histograms are stacked to produce a resulting tensor of shape [256, 59×n]. The tensor is used as input to the neural networks of following layers. The network weights are learned with semantic feedback from the detection loss at the end of the pipeline.

### Exhibit-II: Image Fusion

Conventional image-space exposure fusion is typically performed on the sensor. Typical HDR image sensors produce an HDR raw image I_HDR by fusing n SDR images R_1, . . . , R_n:

IHDR=ExpoFusion(R1, . . . ,Rn).

The SDR images R_1, . . . , R_n are recorded sequentially (or simultaneously using separate photo-sites per pixel) as n different recordings of the radiant scene power ϕ_scene. Specifically, an image Rj, j∈{1, . . . , n}, with exposure time tj and gain setting Kj, is determined as:

Rj=max((ϕscene·tj+npre)·g·Kj+npost,Mwhite),

where g is the conversion factor of the camera from radiant energy to digital number for unit-gain, npre and npost are the pre-amplification and post-amplification noises, and Mwhite is the white level, i.e., the maximum sensor value that can be recorded.

The fused HDR image is formed as a weighted average of the SDR images:

I_{HDR}=Σⱼ₌₁ⁿwjRj

where the wⱼ, 1≤j≤n, are per-pixel weights with pixels that are saturated given a zero weight.

The role of the weights is to merge content from different regions of the dynamic range in a way that reduces artifacts; in particular noise. The weights wj are preferably selected such that IHDR is a minimum variance unbiased estimator.

A conventional approach to tackle the aforementioned challenges uses a pipeline of an HDR (high dynamic range) image sensor coupled with a hardware image signal processor (ISP) and an auto-exposure control mechanism, each being configured independently. HDR exposure fusion is done at the sensor level, before ISP processing and object detection. Specifically, the HDR image sensor produces a fused HDR raw image which is then processed by an ISP.

A sensor-processing phase, comprising an auto-exposure selector, generates a set of standard dynamic range (SDR) images, each within a specified luminance range (of 70 DBs, for example) which are fused onto a single HDR raw image which is supplied to an image signal processor (ISP) which produces an RGB image which is further supplied to a computer vision module which is designed and trained independently of the other components in the pipeline.

Since existing sensors are limited to a dynamic range which may be much below that of some outdoor scenes, an HDR image sensor output is not a direct measurement of pixel irradiance at a single exposure. Instead, it is the result of the fusion of the information contained in several captures of the scene, made at different exposures.

Each of these captures covers a respective standard dynamic range (SDR) image, typically not exceeding 70˜dB per image, while the total dynamic range covered by the set of SDR images covers a larger dynamic range. The fusion algorithm that produces the sensor-stage output (i.e., the fused image) from the set of SDR captures, is designed in isolation of the other components of the vision pipeline. In particular, it is not optimized for the computer vision task at hand, be that detection, segmentation, or localization.

### Exhibit-III: Differentiable ISP

An image signal processor (ISP) comprises a sequence of standard ISP modules performing processes comprising:
contrast stretching applied on the raw image, a contrast stretcher uses a lower and upper percentile to do a pixel-wise affine mapping;
demosaicing of the image, creating a three-channel color image; a demosaicer used is a variant of bilinear demosaicing;
resizing of the image to a shape with height 600 pixels and width 960 pixels;
a pixel-wise power transformation×7→xγ with γ=0.8 where γ is not learned for this step;
application of color correction matrix, i.e., for each pixel, the (r, g, b) vector, of the red, green and blue values, is mapped linearly with a 3×3 matrix which is learned during training; the matrix is initialized to identity;
color space transformation to the color space YCbCr;
low frequency denoising, using a denoiser based on a difference of Gaussian (DoG) filters, a detail image is extracted as:

Idetail=K1*Iinput−K2*Iinput,

where * is the convolution operator and K1 and K2 are Gaussian kernels with standard deviations σ1 and σ2 respectively, which are learned and such that σ1<σ2. The output of the DoG denoiser is: Ioutput=Iinput−g·Idetail·1|Idetail|≤t, where the parameters g and t are learned;
color conversion back to the previous RGB color space;
thresholded unsharp mask filtering where the standard deviation of the Gaussian filter, the magnitude and the threshold are learned;
pixel-wise affine transformation with learned parameters; and
learned gamma correction.
   Exhibit-IV: Feature fusion

Conventional HDR computer vision pipelines capture multiple exposures that are fused as a raw HDR image, which is converted by a hardware ISP into an RGB image that is fed to a high-level vision module. A raw HDR image is formed as the result of a fusion of a number n of SDR raw images (n>1) which are recorded in a burst following an exposure bracketing scheme. The on-sensor and image-space exposure fusion are designed independently of the vision task.

According to an embodiment of the present disclosure, instead of fusing in the sensor-processing phase, feature-space fusion may be implemented where features from all exposures are recovered before fusion and exchanged (either early or late in the separate pipelines) with the knowledge of semantic information.

A conventional HDR object detection pipeline is expressed as the following composition of operations:

(bᵢ,cᵢ,sᵢ)_{i∈J}=OD(ISP_{hw}(ExpoFusion(R₁, . . . ,Rₙ))),

where b_i denotes a detected bounding box, ci denotes a corresponding inferred class, and si denotes a corresponding confidence score.

The notations OD, ISP_{hw} and ExpoFusion denote the object detector, the hardware ISP and the in-sensor exposure fusion, respectively. R_1, . . . , R_n denote the raw SDR images recorded by the HDR image sensor. The exposure fusion process produces a single image that is supplied to a subsequent pipeline stage to extract features.

In contrast, the methods of the present disclosure use the feature-space fusion:

(bᵢ,cᵢ,sᵢ)_{i∈J}=ODₗₐₜₑ(Fusion(OD_{early}(ISP(R₁)), . . . ,OD_{early}(ISP(Rₙ)))).

Thus, instead of a fused HDR image produced at the sensor-processing stage, features for each exposure are extracted and fused in feature-space.

The operator OD_{early} is the upstream part of the object detector, i.e., computations that happen before the fusion takes place, and the operator ODₗₐₜₑ is the downstream part of the object detector, which is computed after the fusion. The symbol Fusion denotes the neural fusion, which is performed at some intermediate point inside the object detector. A differentiable ISP is applied on each of the n raw SDR images R_1, . . . , R_n.

U.S. patent application Ser. No. 17/722,261 teaches that rendering an entire vision pipeline trainable, including modules that are traditionally not learned, such as the ISP and the auto-exposure control, improves downstream vision tasks. Moreover, the end-to-end training of such a fully trainable vision pipeline results in optimized synergies between the different modules. The present application discloses end-to-end differentiable HDR capture and vision pipeline where the auto-exposure control, the ISP and the object detector are trained jointly.

In the pipelines of FIG. 12, FIG. 14, and FIG. 16 (configurations B, C, and D. respectively):
auto-exposure control is based on a variation of the neural network described in the aforementioned patent application, generalized to apply to a stack of n exposures, n>1;
object detection employs the “Faster-Region-based Convolutional Neural Network” architecture (Faster-R-CNN); and
feature extraction employs a 28-layer variant of the conventional “ResNet” feature extractor.

The ISP, detailed in EXHIBIT-III, is composed of standard image processing modules that are implemented as differentiable operations such that the entire pipeline can be trained end-to-end with a stochastic gradient descent optimizer.

In contrast to HDR object detection, multi-exposure images are not merged at the sensor-processing phase but fused later after feature extraction from separate exposures. A pipeline of:
a sensor-processing phase;
an image-signal-processing phase; and
a two-stage object-detection phase, comprising a feature-extractors (first stage) and detection-heads (second stage),
reasons on features from separate exposures and relies on a learned neural auto-exposure trained end-to-end.

### Exhibit-V: Features-Fusion Schemes

Two fusion schemes, referenced as “early fusion” and “late fusion”, implemented at different stages of the detection pipeline are disclosed. Early fusion takes place during feature extraction while late fusion takes place at the end of the object detection stage, i.e., at the level of the box post-processing.

### Early Fusion (FIG. 14)

The n images produced at the ISP stage are processed independently as a batch in the feature extractor. At the end of the feature extractor and just before the region proposal network (RPN), the exposure fusion takes place in the feature-domain as a maximum pooling operation across the batch of n images, as illustrated in FIG. 14.

### Late Fusion (FIG. 16)

Features of the individual exposures are processed independently at the feature extraction stage and the object-detection stage (almost until the end of the second stage of the object detector, but just before the final per class non-maximal suppression (NMS) of the detection results (i.e., the per-class box post-processing) where all the refined detection results produced from the n exposures are gathered in a single global set of detections.

Finally, per-class NMS is performed on this global set of detections, producing a refined and non-maximally suppressed set of detections pertaining to the n SDR exposures as a whole, i.e., pertaining to a single HDR scene. FIG. 16 illustrates the late fusion scheme.

### Feature-Fusion Details

Let Rⱼ, j∈{1, . . . , n) be the n SDR raw images extracted from the image sensor. Then the fused feature map is determined as:

f_{fm}=max(FE(ISP(R₁)), . . . ,FE(ISP(Rₙ))),

where the maximum is computed element-wise across its n arguments, i.e., ffm has the same shape as FE (ISP(Rⱼ)), “FE” denoting the feature extractor.

The fused feature map is input to the RPN (region-proposal network), as well as to the ROI (region of interest) pooling operation, to produce the M ROI feature vectors:

f_{ROI,i},i∈{1 . . . ,M}

corresponding to each of the M region proposals, i.e.,

f_{ROI,i}=NoC(RoiPool(f_{fm},RPN(f_{fm},i)))

The notation RPN(f_fm,i) refers to the region proposal number i produced by the RPN based on the fused feature mapf_fm, and the notation NoC refers to the network recovering convolutional feature maps after ROI pooling in object detectors based on ResNet as a feature extractor. Then, the ROI (region of interest) feature vector is used as input to both detection heads, i.e., the box classifier and the box regressor. The outputs of which being:

(p^{k,i})_{k∈{0, . . . ,K}}=ClS(f_{ROI,i}),i∈{1, . . . ,M}, and

(t^{k,i})_{k∈{0, . . . ,K}}=Loc(f_{ROI,i}),i∈{1, . . . ,M},

where p\hat{ }(k,i) is the estimated probability of the object in the region proposal i to belong to class k, and t\hat{ }(k,i) is the bounding box regression offsets for the object in the region proposal i assuming it is of class k (the class k=0 corresponds to the background class). The operators Cls and Loc refer to the object classifier and the bounding box regressor respectively. A per-class non-maximal suppression step is performed on the set of bounding boxes {t\hat{ }(k,i)∨k=1, . . . , K; i=1, . . . , M}. The method has been evaluated, and ablation studies were carried out, to investigate several variants of the early fusion scheme.

### Objectness Score

The objectness score of a region proposal is a predicted probability that the region actually contains an object of one of the considered object classes. This terminology is introduced in reference [39] which proposes a Region Proposal Network (RPN). The RPN outputs a set of region proposals that needs to be further refined by the second stage of the object detector. The RPN also computes and outputs an objectness score attached to each region proposal. The computation of the objectness scores is detailed in [39]. Alternative methods of computing the objectness may be used. The method described in [39] is commonly used.

As in U.S. application Ser. No. 17/722,261, temporal mini sequences of two consecutive frames are used and all blocks are trained jointly using the object detection loss, which is a sum of the first stage L_RPN and second stage lossL_2ndStage: L_Total=L_RPN+L_2ndStage.

The RPN loss, denoted LRPN, is the sum of the lowest objectnessL_Obj and localization lossesL_Locover all n exposure pipelines computed per anchora∈A, where the set of available anchors A is identical in each stream:

$${L}_{RPN} = {\sum }_{a} {min}_{j ∈ \{ 1 , … , n \}} ( \frac{1}{{N}_{Obj}} {L}_{Obj} ( {p}_{j , a} , {p}_{a}^{*} ) + \frac{λ}{{N}_{Loc}} {L}_{Loc} ( {t}_{j , a} , {t}_{a}^{*} ) )$$

As such, the model is encouraged to have high diversity in predictions between different streams and not punished if instances are missed that are recovered by other streams.

Masked versions of the second stage loss, which depend on the chosen late fusion scheme, is computed as:

$${L}_{2 ndStage} = {\sum }_{j = 1}^{n} {\sum }_{i} {α}_{j}^{i} ( \frac{1}{{N}_{Cls}} {L}_{Cls} ( {p}_{j}^{i} , {c}_{j}^{* i} ) + \frac{λ}{{N}_{Loc}} {L}_{Loc} ( {t}_{j}^{i} , {t}_{j}^{* i} ) )$$

where cⱼ^{*i} and tⱼ^{*i} are the GT (ground truth) class and box assigned to the predicted boxtⱼⁱ. The symbol 1_{c}_{ⱼ}_{^{*i}}_{≥1} is equal to 1 when the GT is an object and 0 when it is the background. The coefficients αⱼⁱ are the masks, each of them is set to 0 or 1.

By pruning the less relevant loss components with these masks, the resulting loss better specializes to well-exposed regions in the image, for a given exposure pipeline, while at the same time avoiding false negatives in sub-optimal exposures, as these cannot be filtered out in the final NMS step.

Two strategies to define the masks are detailed below. Strategy-I, Keep Best Loss, for each ground truth object, keeps the loss components corresponding to the pipeline that performs best for that ground truth, and prunes the others. Strategy-II, NMS Loss, prunes the loss components based on the same NMS step as performed at inference time. While Strategy-I more precisely prunes the loss across exposure pipelines, resulting in more relevant masks, Strategy-II is conceptually simpler, which makes it an interesting alternative to test.

### Strategy-I: “Keep Best Loss”

In the second stage of the object detector, a subset of the refined bounding boxes is selected for each exposure pipeline. These subsets are merged into a single set of predicted bounding boxes by assigning each box to a single ground truth (GT) object.

If the GT is positive (i.e., there is an object to assign to the bounding box), then the exposure stream j that predicted the bounding box, which received the lowest aggregated loss

L_{Agg,j}ⁱ=L_{Cls,j}ⁱ+L_{Loc,j}ⁱ,

is identified for the GT object. Afterwards, the losses for the bounding boxes assigned to the GT object which were predicted by the same pipeline j are backpropagated.

As an exception, the losses of all of the bounding boxes that are associated with negative GT (background class) are backpropagated, regardless of which exposure stream predicted them. With the notations from the formula of L_2ndStage, this is

$$Strategy ‐ II : “ NMS Loss ”$$

$${α}_{j}^{i} = \{ \begin{matrix}\begin{matrix}1 , {ifc}_{j}^{* i} ⩾ 1 and for some {i}^{′} , with GT ( i , j ) = GT ( {i}^{′} , j ) , {L}_{Agg , j}^{{i}^{′}} is \\ minimal among all predicions assigned to this ground truth ,\end{matrix} \\ 1 , {ifc}_{j}^{* i} = 0 , \\ 0 , otherwise\end{matrix}$$

As in strategy-I, the final detection results after class-wise NMS on the combined set of all predictions are determined. The non-suppressed proposals are the only ones for which the second stage loss gets backpropagated:

$${α}_{j}^{i} = \{ \begin{matrix}1 , if not filtered by NMS , \\ 0 , otherwise .\end{matrix}$$

Early fusion is performed following the feature extractor. The SDR captures are processed independently by the ISP and the feature extractor. The fusion is performed according to a maximum pooling operation.

Late fusion performed at the end of the object detector. The SDR captures are processed independently by the ISP, the feature extractor, and the object detector. The fusion is performed according to a non-maximal-suppression operation.

### Exhibit-VI: Region Proposal Network Fusion (RPN Fusion)

In RPN fusion, the different exposure pipelines are treated separately until the Region Proposal Network (RPN). The network predicts different first stage proposals for each stream j, which leads to n·Mproposals in total. Based on the proposals, the RoI (region-of-interest) pooling layer crops out of the concatenated outputsf_fm of the RPN of all pipelines. A single second stage box classifier, which is applied on the full list of cropped feature maps yields the second stage proposals, that is

f_{fm}=concat(FE(ISP(R₁)), . . . ,FE(ISP(Rₙ))),

f_{ROI,i,j}=NoC(RoiPool(f_{fm},RPN(FE(ISP(Rⱼ))),i)).

The loss function used is the same loss function used for the early-fusion scheme (the loss function introduced in reference [39]).

### Exhibit-VII: Validation

A vision pipeline is trained in an end-to-end fashion, including a learned auto-exposure module as well as the simulation of the capture process (detailed below) based on exposure settings produced by the auto-exposure control. Training the vision pipeline is driven by detection losses, typically used in object detection training pipelines, with specific modifications for the late fusion strategy. As disclosed in U.S. application Ser. No. 17/722,261, auto-exposure control is learned jointly with the rest of the vision pipeline. However, unlike the single-exposure approach, an exposure fusion module is learned for a number n, n>1, of SDR captures.

The disclosed feature-domain exposure fusion, with corresponding generalized neural auto-exposure control, is validated using a test set of automotive scenarios. The proposed method outperforms the conventional exposure fusion and auto-exposure methods by more than 6% mAP. The algorithm choices are evaluated with extensive ablation experiments that test different feature-domain HDR fusion strategies.

The prior art methods relevant to auto-exposure control for single low dynamic range (LDR) sensor, high dynamic range imaging using exposure fusion, object detection and deep-learning-based exposure methods, primarily treat exposure control and perception as independent tasks which can lead to failure in high contrast scenes.

### HDR Training Dataset

A dataset of automotive HDR images captured with the Sony IMX490 Sensor mounted with a 60°-FOV (field-of-view) lens behind the windshield of a test vehicle is used for training and testing of the disclosed method. The sensor produces 24-bit images when decompanded. Training examples are formed from two successive images from sequences of images taken while driving. The size of the training set is 1870 examples and the size of the test set is 500 examples. The examples are distributed across the following different illumination categories: sunny, cloud/rain, backlight, tunnel, dusk, night. Table-II, below, provides the dataset distribution of the instance counts in these categories.

TABLE-II
Break down of the counts of examples depending
on the illumination conditions.

| | | Cloud/ | Back- | | | | |
|---|---|---|---|---|---|---|---|
| Input | Sunny | rain | light | Tunnel | Dusk | Night | Total |
| Training set | 870 | 150 | 50 | 75 | 210 | 515 | 1870 |
| Test set | 168 | 64 | 48 | 60 | 60 | 100 | 500 |
| Entire set | 1038 | 214 | 98 | 135 | 270 | 615 | 2370 |

### Network Training

To train the end-to-end HDR object detection network, mini sequences of two consecutive decompanded 24-bit raw images are used.

The n SDR captures are simulated in the training pipeline by applying a random exposure shift to the 24-bit HDR image of the dataset followed by 12-bit quantization. The computation of the random exposure shift for these SDR captures is done as described in U.S. application Ser. No. 17/722,261 except that a further shifted j for each of the n simulated captures is applied. Specifically, for capture j the random exposure shift is,

e_{rand,j}=κ_{shift}·e_{base}·dⱼ

From the n simulated captures, the predicted exposure change is computed with the auto-exposure model. The exposure change is used to further simulate n SDR captures. These are further processed by the ISP and the object detector. Backpropagation through this entire pipeline allows updating all trainable parameters in the auto-exposure model as well as in the object detector and the ISP.

For an HDR baselines, detailed below, a 20-bit quantization (instead of 12-bit quantization) is performed in order to simulate a single 20-bit HDR image.

### Training Pipeline

### Pretraining

The feature extractor is pretrained with ImageNet 1K. The object detector is pretrained jointly with the ISP with several public and proprietary datasets. Public datasets used for pretraining are:
The cityscapes dataset for semantic urban scene (automotive object detection dataset);
The kitti vision benchmark suite (automotive object detection dataset);
Microsoft coco: Common objects in context (general object detection dataset); and
Bdd100k: A diverse driving dataset for heterogeneous multitask learning (automotive object detection dataset).

One of the public datasets used to pretrain the object detector (Microsoft coco) has 91 classes of objects and 328,000 images. The classes are general (e.g., aeroplane, sofa, dog, dining table, person). The three other datasets are automotive datasets. The images are driving scenes, i.e., taken with a camera attached to a vehicle while driving. The object classes are relevant for autonomous driving and driving assistance systems (e.g., car, pedestrian, traffic light). The total number of annotated images for these three datasets is about 140,000 images.

The resulting pretrained ISP and object detector pipeline are used as a starting point for the training of all the performed experiments.

### Hyper-Parameters

Prior-art (Reference [4]) hyperparameters and learning rate schedules are used.

### SDR Captures Simulation

The training pipeline for multi exposure object detection involves simulation of three SDR exposure-specific images of the same scene (n=3, lower, middle, and upper exposures), referenced as Ilower, Imiddle, Iupper. The middle exposure capture Imiddle is simulated exactly as in reference [4], except that instead of sampling the logarithm of the exposure shift in the interval [log 0.1, log 10], sampling is done in the interval [−15 log 2, 15 log 2]. The two other captures, Ilower and Iupper, are simulated the same way, except that on top of the exposure shift, extra constant exposure shifts are applied, respectively dlower and dupper. The experiments are performed with dlower=45−1 and dupper=45.

### Evaluation of the Disclosed Methods

Variants of the neural-exposure-fusion approach are compared with the conventional HDR imaging and detection pipelines in diverse HDR scenarios. A test set comprising 500 pairs of consecutive HDR frames taken under a variety of challenging conditions (see Table-II) is used for evaluation. The second frame of each mini sequence is manually annotated with 2D bounding boxes.

An exposure shiftκ_shift.is created for each image pair. In contrast to the training pipeline, a fixed set of exposure shiftsκ_shift∈2\hat{ }{−15,−10,−5,0,5,10,15} is used for each frame and detection performance is averaged over them. The evaluation metric is the object detection average precision (AP) at 50% IoU (intersection over union), which is computed for the full test set.

### Baseline HDR Object Detection Pipeline

Four of the proposed methods that appear in Table 2, last four rows, are compared with two baseline HDR pipelines, which differ in the way the exposure times are predicted. The methods are: Early Fusion, RPN Fusion, Late Fusion I and Late Fusion II. Both variants use the same differentiable ISP module (EXHIBIT-III) and object detector and they are jointly finetuned on the training dataset, ensuring fair comparison. The first variant HDR-I implements a conventional heuristic exposure control approach, while the variant HDR II is an HDR exposure with learned exposure control.

### HDR-I, Average AE

This baseline model uses a 20 bit HDR image I_{HDR} as input and an auto-exposure algorithm base on a heuristic. More precisely the exposure change is computer as follows,

e_{change}=0.5·M_{white}·Ī_{HDR}⁻¹,

Where I_{HDR} is the mean pixel value of I_{HDR}. This baseline model is similar to the Average AE baseline model of except that it uses a 20-bit HDR image as input instead of a 12 bit SDR image.

### HDR-II, Learned Exposure

Exposure shifts are predicted using the learned Histogram NN model of [33]. This approach is similar to the proposed method in that the exposure control is learned, but no feature fusion is performed.

### Evaluation Results

The proposed methods of Early Fusion, RPN Fusion, Late Fusion I and Late Fusion II are compared with the above described HDR pipelines and the SDR method from Onzon et al. [33], which uses learned exposure control and a single SDR image. The proposed neural fusion variants, which are using three exposures, outperform the HDR baselines. Late Fusion I is best with more than 6% mAP respectively 3% mAP compared to HDR I and HDR II. Weaker results of RPN Fusion compared to the early and late variants are due to the architectural differences. Note that no pretrained weights are used for the second stage box classifier. Results are reported in Table-III and Table-V. The main findings are: 1) identifying learned exposure control and neural exposure fusion as the two main contributors for the performance gain. 2) a trend that later fusion of exposure streams leads to better detections, which is also supported by the ablations (EXHIBIT-VIII).

TABLE-III
HDR object detection evaluation for different neural exposure fusion strategies
compared to conventional HDR imaging and object detection pipelines.

| | Classes | | | | | | |
|---|---|---|---|---|---|---|---|
| | | Bus & | Car & | | Traffic | Traffic | |
| Method | Bicycle | truck | Van | Person | light | sign | mAP |
| SDR Gradient AE [42] | 11.29 | 2.64 | 24.61 | 13.43 | 3.61 | 10.26 | 10.97 |
| SDR Average AE [1] | 17.66 | 4.89 | 33.21 | 20.89 | 5.35 | 14.60 | 16.10 |
| HDR I | 25.77 | 4.23 | 46.92 | 29.31 | 7.72 | 20.16 | 22.35 |
| HDR II | 27.99 | 6.44 | 53.58 | 34.00 | 9.12 | 23.22 | 25.73 |
| Onzon et al. [33] (SDR) | 29.52 | 7.95 | 55.32 | 32.79 | 9.91 | 24.06 | 26.59 |
| Early Fusion | 32.75 | 7.83 | 58.30 | 35.69 | 10.89 | 26.38 | 28.64 |
| (Present disclosure) | | | | | | | |
| RPN Fusion | 28.34 | 4.08 | 57.49 | 34.43 | 9.73 | 25.29 | 26.56 |
| Late Fusion II | 30.51 | 10.01 | 58.99 | 34.80 | 9.96 | 26.09 | 28.39 |
| Late Fusion I | 30.96 | 9.45 | 59.14 | 36.54 | 10.65 | 27.35 | 29.02 |

Qualitatively, it can be seen that the proposed method is beneficial for scenes with large dynamic range, where conventional HDR pipelines fail to maintain task-specific features. FIG. 5 indicates that traditional HDR image fusion can lead to under or overexposed regions with poor local detection performance, while the proposed approach can rely on features of those exposure streams that provide enough details. Moreover, streams can collaborate by fusing features and therefore achieve higher performance than each of them in isolation. Posterization effect can appear on the first of the three exposures because of under-exposure (first column in FIG. 46).

In the reported experiments, processes that take place in the sensor were not trained. Training processes within the sensor would be possible if the auto-exposure neural network is implemented in the sensor.

### Additional Qualitative and Quantitative Evaluations

### Additional Quantitative Evaluation

Additional object detection results for an extra dataset are provided in Table-IV. The dataset covers scenes of entrances and exits of tunnels. The total number of examples is 418.

TABLE-IV
HDR object detection evaluation for different neural exposure fusion
strategies compared to conventional HDR imaging and object detection pipelines

| | Classes | | | | | | |
|---|---|---|---|---|---|---|---|
| | | Bus & | Car & | | Traffic | Traffic | |
| Method | Bicycle | truck | Van | Person | light | sign | mAP |
| HDR II | 3.20 | 9.25 | 30.32 | 10.57 | 5.09 | 7.17 | 10.93 |
| Onzon et al. | 3.94 | 9.96 | 36.26 | 14.76 | 5.51 | 9.41 | 13.31 |
| Early Fusion | 5.01 | 11.55 | 38.11 | 15.35 | 5.30 | 10.04 | 14.23 |
| Late-Fusion-II | 4.87 | 11.31 | 41.14 | 15.26 | 5.83 | 9.14 | 14.59 |
| Lat-fusion-I | 4.63 | 11.94 | 40.55 | 16.86 | 5.92 | 10.36 | 15.04 |

### Additional Qualitative Evaluation

Additional qualitative evaluations are illustrated in FIG. 46, FIG. 47, FIG. 48, FIG. 49, and FIG. 50. The highest margins in performance can be achieved in scenes with large dynamic range, where conventional HDR pipelines fail to maintain details in the task relevant image regions. A major distinction of the methods of the present disclosure from the prior art is twofold:
a learned exposure control, using the downstream task, is applied in the sensor-processing phase; and
exposure fusion is performed in the feature domain instead of the image domain

Traditional HDR pipelines (e.g., HDR II described above) fuse the information of different exposures in the image domain. For a large range of illuminations, this can lead to underexposed or overexposed regions, which finally results in poor local detection performance.

U.S. application Ser. No. 17/722,261 discloses a task-specific learned auto-exposure control method to maintain relevant scene features. However, as the method uses a single SDR exposure stream, the method cannot handle scenarios of a high difference in spatial illumination, such as backlights scenarios or scenarios of vehicles moving from indoor to outdoor and vice versa.

The disclosed neural fusion method, which is performed in the feature domain, avoids losing details. Using multiple exposures instead of a single exposure has the advantages of:
details that are not visible in one stream can be recovered by relying on features of those streams, which expose the observed image region better; and
streams can collaborate by fusing features and therefore achieve higher performance than each of them in isolation, which could be interpreted as a natural form of test time augmentations.

### Exhibit-VIIII: Ablation Studies and Training Variant

In the early fusion scheme, the n images produced by the ISP are processed independently as a batch in the feature extractor and are fused together at the end of the feature extractor. Experiments are presented where instead of doing the fusion at the end of the feature extractor, several other intermediate layers are tested to perform the fusion. The experiments cover the following stages for fusion: the end of the root block (conv1 in [39]), the end of each of the first 3 blocks made from residual modules (conv2, conv3 and conv4 in [39]), and a compression layer added after the third block of residual modules. Accordingly, these possible fusion stages are called: conv1, conv2, conv3, conv4, and conv4_compress. The latter corresponds to the end of the feature extractor and the beginning of the region proposal network (RPN), and it is the early fusion scheme described EXHIBIT-V. Table-VI reports the results of these different fusion stages. The last ResNet block (conv5 in [39]) is applied on top of ROI pooling (following [40]). Fusion at the end of this block is not tested. The reason is that when the n exposures are processed independently up to this last block, the ROIs produced by the RPN are not the same across the different exposures, and so it is not possible to do maximum pooling across exposures.

TABLE-V
Comparison of object-detection performance (in mAP)
depending on the illumination conditions

| | Illumination conditions | | | | | |
|---|---|---|---|---|---|---|
| | | Cloud & | | | | |
| Method | Sunny | Rain | Backlight | Tunnel | Dusk | Night |
| HDR I | 23.84 | 14.07 | 12.10 | 31.18 | 26.72 | 25.42 |
| HDR II | 27.46 | 27.37 | 14.27 | 25.17 | 31.26 | 27.05 |
| Onzon et al. | 29.53 | 19.25 | 16.48 | 43.93 | 33.61 | 32.46 |
| Early Fusion | 29.53 | 19.25 | 17.11 | 44.04 | 33.61 | 34.53 |
| (Present disclosure) | | | | | | |
| RPN Fusion | 27.67 | 18.57 | 16.30 | 42.64 | 30.63 | 34.28 |
| (Present disclosure) | | | | | | |
| Late Fusion II | 29.34 | 19.59 | 16.81 | 45.58 | 33.62 | 32.46 |
| (Present disclosure) | | | | | | |
| Late Fusion I | 30.37 | 20.22 | 16.48 | 43.93 | 33.91 | 34.56 |
| (Present disclosure) | | | | | | |

TABLE-VI
Object-detection performance corresponding to Feature Fusion at Different Stages
in the Joint Image Processing and Detection Pipeline

| | Classes | | | | | | |
|---|---|---|---|---|---|---|---|
| | | | | | Traffic | Traffic | |
| Method | Bicycle | Bus & truck | Car & Van | Person | light | sign | mAP |
| Conv1 Fusion | 29.81 | 8.79 | 57.84 | 34.08 | 9.46 | 25.81 | 27.63 |
| Conv2 Fusion] | 29.56 | 9.37 | 58.24 | 35.42 | 10.60 | 25.98 | 28.19 |
| Conv3 Fusion | 30.63 | 7.92 | 58.33 | 35.61 | 10.07 | 26.45 | 28.17 |
| Conv4 Fusion | 31.68 | 6.56 | 58.28 | 36.07 | 10.76 | 26.33 | 28.28 |
| Conv4* | 32.75 | 7.83 | 58.30 | 35.69 | 10.89 | 26.38 | 28.64 |
| Late Fusion** | 30.23 | 7.75 | 58.51 | 35.29 | 10.10 | 26.55 | 28.07 |
| Late Fusion*** | 30.96 | 9.45 | 59.14 | 36.54 | 10.65 | 27.35 | 29.02 |

*The results reported in this row correspond to the early fusion made at the latest stage in the feature extractor The stage is referenced as “conv4_compress”.
**Standard loss function
***The results reported in this row correspond to the method of Late Fusion I (Keep best loss).

TABLE-VII
Object-detection performance based on late-fusion models for
the first-stage and second-stage of the object detector

| | Classes | | | | | | |
|---|---|---|---|---|---|---|---|
| | | Bus & | Car & | | Traffic | Traffic | |
| Method | Bicycle | truck | Van | Person | light | sign | mAP |
| (1) | 30.23 | 7.75 | 58.51 | 35.29 | 10.10 | 26.55 | 28.07 |
| (2) | 30.97 | 6.93 | 58.92 | 35.01 | 10.17 | 25.86 | 27.98 |
| (3) | 30.14 | 9.87 | 58.95 | 35.36 | 9.91 | 25.86 | 28.35.17 |
| (4) | 29.88 | 10.98 | 59.00 | 35.82 | 10.35 | 27.55 | 28.93 |
| (5) | 30.51 | 10.01 | 58.99 | 34.80 | 9.96 | 36.09 | 28.39 |
| (6) | 30.96 | 9.45 | 59.14 | 35.54 | 10.65 | 37.35 | 29.02 |

The loss functions corresponding to methods (1) to (6) of Table-VII are indicated in the table blow.

| | Loss functions for the two stages of object detection | |
|---|---|---|
| Method | First stage | Second stage |
| (1) | Standard | Standard loss function |
| (2) | loss function | loss following late-fusion strategy I (keep best loss) |
| (3) | | loss following late fusion strategy II (NMS loss) |
| (4) | Proposed | Standard loss function |
| (5) | loss function | loss following late fusion strategy I (keep best loss) |
| (6) | | loss following late fusion strategy II (NMS loss) |

### Late Fusion Scheme Ablations

Ablation studies are performed by training the late fusion model and varying between the proposed and the standard losses for first and second stages of the object detector.

### Loss Functions According to the Present Disclosure

For the first stage loss, the proposed loss L_{(RPN,proposed)} is compared with the standard first stage loss L_{(RPN,standard)}.

The difference between the two losses is that in the proposed loss the minimum across the n exposure pipelines is taken, for each RPN anchor, whereas for the standard loss, all the terms in the loss are kept without taking the minimum.

The standard first stage loss is determined as,

$${L}_{RPN , standard} = {\sum }_{a} {\sum }_{j = 1}^{n} ( \frac{1}{{N}_{Obj}} {L}_{Obj} ( {p}_{j , a} , {p}_{a}^{*} ) + \frac{λ}{{N}_{Loc}} {L}_{Loc} ( {t}_{j , a} , {t}_{a}^{*} ) ) ,$$

and the first stage loss is:

$${L}_{RPN , proposed} = {\sum }_{a} {min}_{j ∈ \{ 1 , … , n \}} ( \frac{1}{{N}_{Obj}} {L}_{Obj} ( {p}_{j , a} , {p}_{a}^{*} ) + \frac{λ}{{N}_{Loc}} {L}_{Loc} ( {t}_{j , a} , {t}_{a}^{*} ) ) .$$

For the second stage, the standard second stage loss:

$${L}_{{2}^{nd} Stage , standard} = {\sum }_{j = 1}^{n} {\sum }_{i} ( \frac{1}{{N}_{Cls}} {L}_{Cls} ( {p}_{j}^{i} , {c}_{j}^{* i} ) + \frac{λ}{{N}_{Loc}} {L}_{Loc} ( {t}_{j}^{i} , {t}_{j}^{* i} ) ) .$$

is compared with the proposed second stage losses:

$${L}_{{2}^{nd} Stage , proposed} = {\sum }_{j = 1}^{n} {\sum }_{i} {α}_{j}^{i} ( \frac{1}{{N}_{Cls}} {L}_{Cls} ( {p}_{j}^{i} , {c}_{j}^{* i} ) + \frac{λ}{{N}_{Loc}} {L}_{Loc} ( {t}_{j}^{i} , {t}_{j}^{* i} ) ) .$$

where the masks αⱼⁱ are chosen depending on the strategy: Late Fusion I or Late Fusion II.

The results of these experiments can be found in Table-VII.

### General Remarks

### Pruning the Overall Set of Candidate Objects

In addition to keeping the candidate object with the least loss, candidate objects that are also matched with the same ground truth and that come from the same exposure j are kept since several candidate objects from the same exposure can be matched with the same ground truth. In other words, for a given ground truth object GT, if among the candidate objects that are matched with GT, the one with least “loss” comes from exposure j, then all the candidate objects that come from other exposures than j and are also matched with GT are discarded.

### Underlying Principle

The principle that underpins the proposed losses is that a model with high diversity in predictions between different exposure streams should be rewarded and at the same time the loss should avoid penalizing the model if objects are missed that are recovered by other exposure streams. By pruning the less relevant loss components with these masks, the resulting loss better relates to well-exposed regions in the image, for a given exposure pipeline, while at the same time avoiding false negatives in sub-optimal exposures.

Systems and apparatus of the embodiments of the disclosure may be implemented as any of a variety of suitable circuitry, such as one or more of microprocessors, digital signal processors (DSPs), application-specific integrated circuits (ASICs), field programmable gate arrays (FPGAs), discrete logic, software, hardware, firmware or any combinations thereof. When modules of the systems of the embodiments of the disclosure are implemented partially or entirely in software, the modules contain respective memory devices for storing software instructions in a suitable, non-transitory computer-readable storage medium, and software instructions are executed in hardware using one or more processors to perform the techniques of the present disclosure.

The methods and systems of the embodiments of the disclosure and data sets described above are not, in any sense, abstract or intangible. Instead, the data is necessarily presented in a digital form and stored in a physical data-storage computer-readable medium, such as an electronic memory, mass-storage device, or other physical, tangible, data-storage device and medium. It should also be noted that the currently described data-processing and data-storage methods cannot be carried out manually by a human analyst, because of the complexity and vast numbers of intermediate results generated for processing and analysis of even quite modest amounts of data. Instead, the methods described herein are necessarily carried out by electronic computing systems having processors on electronically or magnetically stored data, with the results of the data processing and data analysis digitally stored in one or more tangible, physical, data-storage devices and media.

Although specific embodiments of the disclosure have been described in detail, it should be understood that the described embodiments are intended to be illustrative and not restrictive. Various changes and modifications of the embodiments illustrated in the drawings and described in the specification may be made within the scope of the following claims without departing from the scope of the disclosure in its broader aspect.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or a electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary embodiment” are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

### LIST OF PUBLICATIONS

A list of publications partly referenced in the detailed description is enclosed herewith as shown below.
1. ARM Mali C71 (2020 (accessed Nov. 11, 2020)), https://www.arm.com/products/silicon-ip-multimedia/image-signal-processor/mali-c7lae.
2. An, V. G., Lee, C.: Single-shot high dynamic range imaging via deep convolutional neural network. In: APSIPA ASC. pp. 1768-1772. IEEE (2017).
3. Battiato, S., Bruna, A. R., Messina, G., Puglisi, G.: Image processing for embedded devices. Bentham Science Publishers (2010).
4. Chen, Y., Jiang, G., Yu, M., Yang, Y., Ho, Y. S.: Learning stereo high dynamic range imaging from a pair of cameras with different exposure parameters. IEEE TCI 6, 1044-1058 (2020).
5. Dai, J., Li, Y., He, K., Sun, J.: R-fen: Object detection via region-based fully convolutional networks. Advances in neural information processing systems 29 (2016).
6. Debevec, P. E., Malik, J.: Recovering high dynamic range radiance maps from photographs. In: SIGGRAPH '08 (1997).
7. Ding, Z., Chen, X., Jiang, Z., Tan, C.: Adaptive exposure control for image-based visual-servo systems using local gradient information. JOSA A 37(1), 56-62 (2020).
8. Eilertsen, G., Kronander, J., Denes, G., Mantiuk, R. K., Unger, J.: Hdr image reconstruction from a single exposure using deep cnns. ACM Transactions on Graphics (TOG) 36(6), 178 (2017).
9. Endo, Y., Kanamori, Y., Mitani, J.: Deep reverse tone mapping. ACM TOG (SIGGRAPH ASIA) 36(6) (November 2017).
10. Gallo, O., Tico, M., Manduchi, R., Gelfand, N., Pulli, K.: Metering for exposure stacks. In: Computer Graphics Forum. vol. 31, pp. 479-488. Wiley Online Library (2012).
11. Gelfand, N., Adams, A., Park, $. H., Pulli, K.: Multi-exposure imaging on mobile devices. In: Proceedings of the 18th ACM international conference on Multimedia. pp. 823-826 (2010).
12. Girshick, R.: Fast r-cnn. In: Proceedings of the IEEE international conference on computer vision. pp. 1440-1448 (2015).
13. Grossberg, M. D., Nayar, $. K.: High dynamic range from multiple images: Which exposures to combine? (2003).
14. Hasinoff, 5. W., Durand, F., Freeman, W. T.: Noise-optimal capture for high dynamic range photography. 2010 IEEE Computer Society Conference on Computer Vision and Pattern Recognition pp. 553-560 (2010).
15. Hasinoff, 5. W., Durand, F., Freeman, W. T.: Noise-optimal capture for high dynamic range photography. In: 2010 IEEE Computer Society Conference on Computer Vision and Pattern Recognition. pp. 553-560. IEEE (2010).
16. He, K., Zhang, X., Ren, $., Sun, J.: Deep residual learning for image recognition. In: Proceedings of the IKEE conference on computer vision and pattern recognition. pp. 770-778 (2016).
17. Huang, J., Rathod, V., Sun, C., Zhu, M., Korattikara, A., Fathi, A., Fischer, I., Wojna, Z., Song, Y., Guadarrama, 5., et al.: Speed/accuracy trade-offs for modern convolutional object detectors. In: Proceedings of the IEEE conference on computer vision and pattern recognition. pp. 7310-7311 (2017).
18. Huang, K. F., Chiang, J. C.: Intelligent exposure determination for high quality HDR image generation. In: 2013 IKEE International Conference on Image Processing. pp. 3201-3205. IEEE (2013).
19. Kang, 5. B., Uyttendaele, M., Winder, S. A. J., Szeliski, R.: High dynamic range video. ACM Trans. Graph. 22, 319-325 (2003).
20. Khan, Z., Khanna, M., Raman, S.: Fhdr: Hdr image reconstruction from a single Idr image using feedback network. arXiv preprint (2019).
21. Kim, J. H., Lee, S., Jo, S., Kang, S. J.: End-to-end differentiable learning to hdr image synthesis for multi-exposure images. AAAI (2020).
22. Lee, S., An, G. H., Kang, 5. J.: Deep chain hdri: Reconstructing a high dynamic range image from a single low dynamic range image. IEEE Access 6, 49913-49924 (2018).
23. Lin, H. Y., Chang, W. Z.: High dynamic range imaging for stereoscopic scene representation. In: ICIP. pp. 4305-4308. IEEE (2009).
24. Lin, T. Y., Dollar, P., Girshick, R., He, K., Hariharan, B., Belongie, S.: Feature pyramid networks for object detection. In: Proceedings of the IKEE conference on computer vision and pattern recognition. pp. 2117-2125 (2017).
25. Lin, T. Y., Goyal, P., Girshick, R., He, K., Dollar, P.: Focal loss for dense object detection. In: Proceedings of the IEEE international conference on computer vision. pp. 2980-2988 (2017).
26. Liu, W., Anguelov, D., Erhan, D., Szegedy, C., Reed, 8., Fu, C. Y., Berg, A. C.: Ssd: Single shot multibox detector. In: European conference on computer vision. pp. 21-37. Springer (2016).
27. Mann, 8., Picard, R. W.: Being ‘undigital’ with digital cameras: extending dynamic range by combining differently exposed pictures (1994).
28. Marnerides, D., Bashford-Rogers, T., Hatchett, J., Debattista, K.: Expand-net: A deep convolutional neural network for high dynamic range expansion from low dynamic range content. CoRR abs/1803.02266 (2018), http://arxiv.org/abs/1803.02266.
29. Martel, J. N. P., Muller, L. K., Carey, 5. J., Dudek, P., Wetzstein, G.: Neural sensors: Learning pixel exposures for hdr imaging and video compressive sensing with programmable sensors. IEEE Transactions on Pattern Analysis and Machine Intelligence 42(7), 1642-1653 (2020). https://doi.org/10.1109/TPAMI.2020.2986944.
30. Mertens, T., Kautz, J., Reeth, F. V.: Exposure fusion: A simple and practical alternative to high dynamic range photography. Comput. Graph. Forum 28, 161-171 (2009).
31. Metzler, C. A., Ikoma, H., Peng, Y., Wetzstein, G.: Deep optics for single-shot high-dynamic-range imaging. In: Proceedings of the IEEE/CVF Conference on Computer Vision and Pattern Recognition. pp. 1375-1385 (2020).
32. Mukherjee, R., Melo, M., Filipe, V., Chalmers, A., Bessa, M.: Backward compatible object detection using hdr image content. IEEE Access 8, 142736-142746 (2020).
33. Onzon, E., Mannan, F., Heide, F.: Neural auto-exposure for high-dynamic range object detection. In: Proceedings of the IEEE/CVF Conference on Computer Vision and Pattern Recognition. pp. 7710-7720 (2021).
34. Park, $., Kim, G., Jeon, J.: The method of auto exposure control for low-end digital camera. In: 2009 11th International Conference on Advanced Communication Technology. vol. 3, pp. 1712-1714. IEEE (2009).
30. Phillips, J. B., Eliasson, H.: Camera Image Quality Benchmarking. Wiley Publishing, 1st edn. (2018).
36. Prabhakar, K. R., Srikar, V. S., Babu, R. V.: Deepfuse: A deep unsupervised approach for exposure fusion with extreme exposure image pairs. In: Proceedings of the IEEE/CVF International Conference on Computer Vision. vol. 1, p. 3 (2017).
37. Redmon, J., Divvala, S., Girshick, R., Farhadi, A.: You only look once: Unified, real-time object detection. In: Proceedings of the IEEE conference on computer vision and pattern recognition. pp. 779-788 (2016).
38. Reinhard, E., Heidrich, W., Debevec, P., Pattanaik, $., Ward, G., Myszkowski, K.: High dynamic range imaging: acquisition, display, and image-based lighting. Morgan Kaufmann (2010).
39. Ren, S., He, K., Girshick, R., Sun, J.: Faster r-cnn: Towards real-time object detection with region proposal networks. In: Advances in neural information processing systems. pp. 91-99 (2015).
40. Ren, 8., He, K., Girshick, R., Zhang, X., Sun, J.: Object detection networks on convolutional feature maps. IKEE transactions on pattern analysis and machine intelligence 39(7), 1476-1481 (2016).
41. Schulz, S., Grimm, M., Grigat, R. R.: Using brightness histogram to perform optimum auto exposure. WSEAS Transactions on Systems and Control 2(2), 93 (2007).
42. Shim, I., Oh, T. H., Lee, J. Y., Choi, J., Choi, D. G., Kweon, I. S.: Gradient-based camera exposure control for outdoor mobile platforms. IEEE ‘Transactions on Circuits and Systems for Video Technology 29(6), 1569-1583 (2018).
43. Su, Y., Kuo, C. C. J.: Fast and robust camera's auto exposure control using convex or concave model. In: 2015 IEEE International Conference on Consumer Electronics (ICCE). pp. 138-14. IEEE (2015).
44. Su, Y., Lin, J. Y., Kuo, C. C. J.: A model-based approach to camera's auto exposure control. Journal of Visual Communication and Image Representation 36, 122-129 (2016).
45. Vuong, Q. K., Yun, $. H., Kim, $.: A new auto exposure and auto white-balance algorithm to detect high dynamic range conditions using cmos technology. In: Proceedings of the world congress on engineering and computer science. pp. 22-24. San Francisco, USA: IEEE (2008).
46. Wang, J. G., Zhou, L. B.: Traffic light recognition with high dynamic range imaging and deep learning. IEEE Transactions on Intelligent Transportation Systems 20(4), 1341-1352 (2018).
47. Wang, L., Yoon, K. J.: Deep learning for hdr imaging: State-of-the-art and future trends. IEEE Transactions on Pattern Analysis and Machine Intelligence (2021). https://doi.org/10.1109/TPAMI.2021.3123686.
48. Xu, H., Ma, J., Jiang, J., Guo, X., Ling, H.: U2fusion: A unified unsupervised image fusion network. IEEE Transactions on Pattern Analysis and Machine Intelligence 44(1), 502-518 (2022). https://doi.org/10.1109/TPAMI.2020.3012548.
49. Yahiaoui, L., Horgan, J., Yogamani, $., Hughes, C., Deegan, B.: Impact analysis and tuning strategies for camera image signal processing parameters in computer vision. In: Irish Machine Vision and Image Processing conference (IMVIP) (2011).
50. Yan, Q., Zhang, L., Liu, Y., Thu, Y., Sun, J., Shi, Q., Zhang, Y.: Deep hdr imaging via a non-local network. IEEE TIP 29, 4308-4322 (2020).
51. Cordts, M., Omran, M., Ramos, S., Rehfeld, T., Enzweiler, M., Benenson, R., Franke, U., Roth, S., Schiele, B.: The cityscapes dataset for semantic urban scene understanding. In: Proceedings of the IEEE conference on computer vision and pattern recognition. pp. 3213-3223 (2016).
52. Geiger, A., Lenz, P., Urtasun, R.: Are we ready for autonomous driving? the kitti vision benchmark suite. In: 2012 IEEE Conference on Computer Vision and Pattern Recognition. pp. 3354-3361. IEEE (2012).
53. Lin, T. Y., Maire, M., Belongie, S., Hays, J., Perona, P., Ramanan, D., Doll, P., Zitnick, C. L.: Microsoft coco: Common objects in context. In: European conference on computer vision. pp. 741-755. Springer (2014).
54. Yu, F., Chen, H., Wang, X., Xian, W., Chen, Y., Lin, F., Madhavan, V., Darrell, T.: BddlOOk: A diverse driving dataset for heterogeneous multitask learning. In: Proceedings of the IEEE/CVF conference on computer vision and pattern recognition. pp. 2636-2645 (2020).

What is claimed is:

1. A method of detecting objects from camera-produced images comprising:
generating multiple raw exposure-specific images for a scene;
performing for said multiple raw exposure-specific images respective processes of image enhancement to produce respective processed exposure-specific images;
extracting from said processed exposure-specific images respective sets of exposure-specific features collectively constituting a superset of features;
fusing constituent exposure-specific sets of features of said superset of features to form a set of fused features;
identifying a set of candidate objects from said set of fused features; and
pruning said set of candidate objects to produce a set of objects within said scene.

2. A method of detecting objects from camera-produced images comprising:
generating multiple raw exposure-specific images for a scene;
performing for said multiple raw exposure-specific images respective processes of image enhancement to produce respective processed exposure-specific images;
extracting from said processed exposure-specific images respective sets of exposure-specific features collectively constituting a superset of features;
identifying, using said respective sets of exposure-specific features, exposure-specific sets of candidate objects;
fusing said exposure-specific sets of candidate objects to form a fused set of candidate objects; and
pruning said set of candidate objects to produce a set of objects within said scene.

3. The method of claim 2 further comprising deriving for each raw exposure-specific image a respective multi-level regional illumination distribution for use in computing respective exposure settings.

4. A method of detecting objects from camera-produced images comprising:
generating multiple raw exposure-specific images for a scene;
deriving for each raw exposure-specific image a respective multi-level regional illumination distribution for use in computing respective exposure settings;
performing for said multiple raw exposure-specific images respective processes of image enhancement to produce respective processed exposure-specific images;
extracting from said processed exposure-specific images respective sets of exposure-specific features collectively constituting a superset of features;
recognizing a set of candidate objects using said superset of features; and
pruning said set of candidate objects to produce a set of objects within said scene.

5. The method of claim 4 further comprising selecting image regions, for use in said deriving, categorized in a predefined number of levels so that each region of a level, other than a last level of said predefined number of levels, encompasses an integer number of regions of each subsequent level.

6. The method of claim 4 wherein said respective processes of image enhancement are performed according to one of:
sequentially using a single image-signal-processor;
using multiple pipelined image signal processors operating cooperatively and concurrently; or
using multiple pipelined image signal processors operating independently and concurrently.

7. The method of claim 4 wherein said recognizing comprises:
fusing constituent exposure-specific sets of features of said superset of features to form a set of fused features; and
identifying a set of candidate objects from said set of fused features.

8. The method of claim 4 wherein said recognizing comprises:
identifying, using said respective sets of exposure-specific features, exposure-specific sets of candidate objects; and
fusing said exposure-specific sets of candidate objects to form a fused set of candidate objects.

9. The method of claim 8 further comprising:
determining objectness of each detected object of said fused set of candidate objects; and
pruning said fused set of candidate objects according to a non-maximum-suppression criterion.

10. The method of claim 8 further comprising:
determining objectness of each detected object of said superset of detected objects; and
pruning said fused superset of detected objects according to a keep-best-loss principle.

11. The method of claim 4 wherein said respective processes of image enhancement for each exposure-specific image comprise:
raw image contrast stretching, using lower and upper percentiles for pixel-wise affine mapping;
image demosaicing;
image resizing;
a pixel-wise power transformation; and
pixel-wise affine transformation with learned parameters.

12. The method of claim 4 further comprising:
updating parameters pertinent to said generating, deriving, performing, extracting, and recognizing to produce respective updated parameters; and
disseminating said respective updated parameters to relevant hardware processors per-forming said generating, deriving, performing, extracting, and recognizing.

13. The method of claim 12 wherein said updating comprises processes of:
establishing a loss function; and
pruning backpropagation loss components.

14. The method of claim 12 wherein said disseminating comprises employing a network of hard-ware processors coupled to a plurality of memory devices storing processor-executable instructions for performing said generating, deriving, performing, extraction, and recognizing.

15. An apparatus for detecting objects, from camera-produced images of a time-varying scene, comprising:
a hardware master processor coupled to a pool of hardware intermediate processors;
a sensing-processing device comprising:
a sensor;
a sensor-control device comprising a neural auto-exposure controller, coupled to a light-collection component, configured to:
generate a specified number of time-multiplexed exposure-specific raw SDR images; and
derive for each exposure-specific raw SDR image respective multi-level luminance histograms;
an image-processing device configured to perform predefined image-enhancing procedures for each said raw SDR image to yield multiple exposure-specific processed images;
a features-extraction device configured to extract from said multiple exposure-specific processed images respective sets of exposure-specific features collectively constituting a superset of features;
an objects-detection device configured to identify a set of candidate objects using said superset of features; and
a pruning module configured to filter said set of candidate objects to produce a set of pruned objects within said time-varying scene.

16. The apparatus of claim 15 wherein:
said hardware master-processor is communicatively coupled to each hardware intermediate processor through one of:
a dedicated path;
a shared bus; or
a switched path.

17. The apparatus of claim 16 wherein each of said sensing-processing device, image-processing device, features-extraction device, and objects-detection device is coupled to a respective hard-ware intermediate processor of said pool of hardware intermediate processors, thereby facilitating dissemination of control data through the apparatus.

18. The apparatus of claim 15 further comprising an illumination-characterization module, for deriving said respective multi-level luminance histograms, configured to select image-illumination regions for each level of a predefined number of levels, so that each region of a level, other than a last level of said predefined number of levels, encompasses an integer number of regions of each subsequent level.

19. The apparatus of claim 15 wherein said image-processing device is configured as one of:
a single image-signal-processor (ISP) sequentially performing said predefined image enhancing procedures for said specified number of time-multiplexed exposure-specific raw SDR images;
a plurality of pipelined image-processing units operating cooperatively and concurrently to execute said image-enhancing procedure; or
a plurality of image-signal-processors, operating independently and concurrently, each processing a respective raw SDR image.

20. The apparatus of claim 15 wherein said objects-detection device comprises:
a features-fusing module configured to fuse said respective sets of exposure-specific features of said superset of features to form a set of fused features; and
a detection module configured to identify a set of candidate objects from said set of fused features.

21. The apparatus of claim 15 wherein said objects-detection device comprises:
a plurality of detection modules, each configured to identify, using said respective sets of exposure-specific features, exposure-specific sets of candidate objects; and
an objects-fusing module configured to fuse said exposure-specific sets of candidate objects to form a fused set of candidate objects.

22. The apparatus of claim 15 further comprising a control module configured to cause said master processor to:
derive, based on said set of pruned objects, updated parameters pertinent to said:
sensing-processing device;
image-processing device;
features-extraction device; and
objects-detection device; and
disseminate said updated parameters through said pool of hardware processors.

23. The apparatus of claim 22 wherein said control module is configured to determine derivatives of a loss function, based on said pruned set of objects, to produce said updated device parameters.

24. The apparatus of claim 23 further comprising a module for selecting downstream control data according to one of:
a method based on keeping best loss, or
a method based on non-maximal suppression.

25. The apparatus of claim 15 further comprising a module for tracking, for determining a lower bound of a capturing time interval, processing durations within each of:
the sensing-processing device;
the image-processing device;
the features-extraction device; and
the objects-detection device.
